(19) United States
(12) Patent Application Publication
(10) Pub. No.: US 2026/0050322 A1
(43) Pub. Date: Feb. 19, 2026

(54) USER INTERFACES AND TECHNIQUES FOR PRESENTING CONTENT

(71) Applicant: Apple Inc., Cupertino, CA (US)

(72) Inventors: Agatha Y. YU, Oakland, CA (US); Jamie L. MYROLD, Chicago, IL (US); Ji Chen Jason YUAN, Cupertino, CA (US); Joshua C. WEINBERG, Monte Sereno, CA (US); Tuhin KUMAR, San Francisco, CA (US)

(21) Appl. No.: 19/370,228

(22) Filed: Oct. 27, 2025

Related U.S. Application Data
(63) Continuation of application No. PCT/US2024/048420, filed on Sep. 25, 2024.
(60) Provisional application No. 63/541,837, filed on Sep. 30, 2023.
(60) Provisional application No. 63/541,823, filed on Sep. 30, 2023.
(60) Provisional application No. 63/541,816, filed on Sep. 30, 2023.

(51) Int. Cl. G06F 3/01

(52) U.S. Cl. CPC G06F 3/011

(57) ABSTRACT

The present disclosure generally relates to user interfaces.

### CROSS-REFERENCE TO RELATED APPLICATIONS

This application is a continuing application of International Patent Application Serial No. PCT/US2024/048420, entitled “USER INTERFACES AND TECHNIQUES FOR PRESENTING CONTENT,” filed Sep. 25, 2024, which claims priority to U.S. Provisional patent application Ser. No. 63/541,837, filed Sep. 30, 2023, to U.S. Provisional patent application Ser. No. 63/541,823, filed Sep. 30, 2023, and to U.S. Provisional patent application Ser. No. 63/541,816, filed Sep. 30, 2023. The content of these application(s) is hereby incorporated by reference in their entirety.

### BACKGROUND

Computer systems often display a variety of content. Such content can be displayed in a variety of manners by the computer system to draw attention to the content by a viewer. Computer systems often capture images of users. Such images are often taken after the computer system is positioned so that a user of interest is captured in the field of view of the computer system. Computer systems often display a variety of content to viewers. Such content can be displayed in a variety of ways, so that the attention of the user is drawn to the content.

### SUMMARY

Existing techniques for displaying widgets using electronic devices are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient methods and interfaces for displaying widgets, capturing images, and providing information using the location and size of displayed content. Such methods and interfaces optionally complement and/or replace other methods for displaying widgets, capturing images, and providing information using the location and size of displayed content. Such methods and interfaces reduce the cognitive burden on a user and produce a more efficient human-machine interface. For battery-operated computing devices, such methods and interfaces conserve power and increase the time between battery charges. Such methods and interfaces may complement or replace other methods for displaying widgets.

In some embodiments, a method that is performed at a computer system that is in communication with one or more input devices and a display component is described. In some embodiments, the method comprises: detecting, via the one or more input devices, a first user in an environment; and in response to detecting the first user in the environment, displaying, via the display component, a first user interface that includes a first widget, wherein displaying the first widget includes: in accordance with a determination that the first user is within a first distance, displaying, via the display component, first content at a location in the first widget; and in accordance with a determination that the first user is within a second distance different from the first distance, displaying, via the display component, second content at the location in the first widget, wherein the second content is different from the first content.

In some embodiments, a non-transitory computer-readable storage medium storing one or more programs configured to be executed by one or more processors of a computer system that is in communication with one or more input devices and a display component is described. In some embodiments, the one or more programs includes instructions for: detecting, via the one or more input devices, a first user in an environment; and in response to detecting the first user in the environment, displaying, via the display component, a first user interface that includes a first widget, wherein displaying the first widget includes: in accordance with a determination that the first user is within a first distance, displaying, via the display component, first content at a location in the first widget; and in accordance with a determination that the first user is within a second distance different from the first distance, displaying, via the display component, second content at the location in the first widget, wherein the second content is different from the first content.

In some embodiments, a transitory computer-readable storage medium storing one or more programs configured to be executed by one or more processors of a computer system that is in communication with one or more input devices and a display component is described. In some embodiments, the one or more programs includes instructions for: detecting, via the one or more input devices, a first user in an environment; and in response to detecting the first user in the environment, displaying, via the display component, a first user interface that includes a first widget, wherein displaying the first widget includes: in accordance with a determination that the first user is within a first distance, displaying, via the display component, first content at a location in the first widget; and in accordance with a determination that the first user is within a second distance different from the first distance, displaying, via the display component, second content at the location in the first widget, wherein the second content is different from the first content.

In some embodiments, a computer system that is in communication with one or more input devices and a display component is described. In some embodiments, the computer system that is in communication with one or more input devices and a display component comprises one or more processors and memory storing one or more programs configured to be executed by the one or more processors. In some embodiments, the one or more programs includes instructions for: detecting, via the one or more input devices, a first user in an environment; and in response to detecting the first user in the environment, displaying, via the display component, a first user interface that includes a first widget, wherein displaying the first widget includes: in accordance with a determination that the first user is within a first distance, displaying, via the display component, first content at a location in the first widget; and in accordance with a determination that the first user is within a second distance different from the first distance, displaying, via the display component, second content at the location in the first widget, wherein the second content is different from the first content.

In some embodiments, a computer system that is in communication with one or more input devices and a display component is described. In some embodiments, the computer system that is in communication with one or more input devices and a display component comprises means for performing each of the following steps: detecting, via the one or more input devices, a first user in an environment; and in response to detecting the first user in the environment, displaying, via the display component, a first user interface that includes a first widget, wherein displaying the first widget includes: in accordance with a determination that the first user is within a first distance, displaying, via the display component, first content at a location in the first widget; and in accordance with a determination that the first user is within a second distance different from the first distance, displaying, via the display component, second content at the location in the first widget, wherein the second content is different from the first content.

In some embodiments, a computer program product is described. In some embodiments, the computer program product comprises one or more programs configured to be executed by one or more processors of a computer system that is in communication with one or more input devices and a display component. In some embodiments, the one or more programs include instructions for: detecting, via the one or more input devices, a first user in an environment; and in response to detecting the first user in the environment, displaying, via the display component, a first user interface that includes a first widget, wherein displaying the first widget includes: in accordance with a determination that the first user is within a first distance, displaying, via the display component, first content at a location in the first widget; and in accordance with a determination that the first user is within a second distance different from the first distance, displaying, via the display component, second content at the location in the first widget, wherein the second content is different from the first content.

In some embodiments, a method that is performed at a computer system that is in communication with one or more input devices, and a display component is described. In some embodiments, the method comprises: detecting, via the one or more input devices, a first user in a physical environment; and while detecting the first user in the physical environment: in accordance with a determination that a first set of one or more criteria is satisfied, wherein the first set of one or more criteria includes a criterion that is satisfied when a second user is not detected in a first area of the physical environment, displaying, via the display component, first content; and in accordance with a determination that a second set of one or more criteria is satisfied, wherein the second set of one or more criteria includes a criterion that is satisfied when the second user is detected in the first area of the physical environment, displaying, via the display component, second content different from the first content.

In some embodiments, a non-transitory computer-readable storage medium storing one or more programs configured to be executed by one or more processors of a computer system that is in communication with one or more input devices, and a display component is described. In some embodiments, the one or more programs includes instructions for: detecting, via the one or more input devices, a first user in a physical environment; and while detecting the first user in the physical environment: in accordance with a determination that a first set of one or more criteria is satisfied, wherein the first set of one or more criteria includes a criterion that is satisfied when a second user is not detected in a first area of the physical environment, displaying, via the display component, first content; and in accordance with a determination that a second set of one or more criteria is satisfied, wherein the second set of one or more criteria includes a criterion that is satisfied when the second user is detected in the first area of the physical environment, displaying, via the display component, second content different from the first content.

In some embodiments, a transitory computer-readable storage medium storing one or more programs configured to be executed by one or more processors of a computer system that is in communication with one or more input devices, and a display component is described. In some embodiments, the one or more programs includes instructions for: detecting, via the one or more input devices, a first user in a physical environment; and while detecting the first user in the physical environment: in accordance with a determination that a first set of one or more criteria is satisfied, wherein the first set of one or more criteria includes a criterion that is satisfied when a second user is not detected in a first area of the physical environment, displaying, via the display component, first content; and in accordance with a determination that a second set of one or more criteria is satisfied, wherein the second set of one or more criteria includes a criterion that is satisfied when the second user is detected in the first area of the physical environment, displaying, via the display component, second content different from the first content.

In some embodiments, a computer system that is in communication with one or more input devices, and a display component is described. In some embodiments, the computer system that is in communication with one or more input devices, and a display component comprises one or more processors and memory storing one or more programs configured to be executed by the one or more processors. In some embodiments, the one or more programs includes instructions for: detecting, via the one or more input devices, a first user in a physical environment; and while detecting the first user in the physical environment: in accordance with a determination that a first set of one or more criteria is satisfied, wherein the first set of one or more criteria includes a criterion that is satisfied when a second user is not detected in a first area of the physical environment, displaying, via the display component, first content; and in accordance with a determination that a second set of one or more criteria is satisfied, wherein the second set of one or more criteria includes a criterion that is satisfied when the second user is detected in the first area of the physical environment, displaying, via the display component, second content different from the first content.

In some embodiments, a computer system that is in communication with one or more input devices, and a display component is described. In some embodiments, the computer system that is in communication with one or more input devices, and a display component comprises means for performing each of the following steps: detecting, via the one or more input devices, a first user in a physical environment; and while detecting the first user in the physical environment: in accordance with a determination that a first set of one or more criteria is satisfied, wherein the first set of one or more criteria includes a criterion that is satisfied when a second user is not detected in a first area of the physical environment, displaying, via the display component, first content; and in accordance with a determination that a second set of one or more criteria is satisfied, wherein the second set of one or more criteria includes a criterion that is satisfied when the second user is detected in the first area of the physical environment, displaying, via the display component, second content different from the first content.

In some embodiments, a computer program product is described. In some embodiments, the computer program product comprises one or more programs configured to be executed by one or more processors of a computer system that is in communication with one or more input devices, and a display component. In some embodiments, the one or more programs include instructions for: detecting, via the one or more input devices, a first user in a physical environment; and while detecting the first user in the physical environment: in accordance with a determination that a first set of one or more criteria is satisfied, wherein the first set of one or more criteria includes a criterion that is satisfied when a second user is not detected in a first area of the physical environment, displaying, via the display component, first content; and in accordance with a determination that a second set of one or more criteria is satisfied, wherein the second set of one or more criteria includes a criterion that is satisfied when the second user is detected in the first area of the physical environment, displaying, via the display component, second content different from the first content.

In some embodiments, a method that is performed at a computer system that is in communication with one or more input devices and a display component is described. In some embodiments, the method comprises: detecting, via the one or more input devices, a user in an environment; and in response to detecting the user in the environment, displaying, via the display component, a first user interface that includes a first widget, wherein displaying the first widget includes: in accordance with a determination that the computer system is at a location that is associated with a first privacy level for the user, displaying, via the display component, a first type of content in the first widget; and in accordance with a determination that the computer system is at a location that is associated with a second privacy level for the user, different from the first privacy level for the user, displaying, via the display component, a second type of content in the first widget that is different from the first type of content in the first widget.

In some embodiments, a non-transitory computer-readable storage medium storing one or more programs configured to be executed by one or more processors of a computer system that is in communication with one or more input devices and a display component is described. In some embodiments, the one or more programs includes instructions for: detecting, via the one or more input devices, a user in an environment; and in response to detecting the user in the environment, displaying, via the display component, a first user interface that includes a first widget, wherein displaying the first widget includes: in accordance with a determination that the computer system is at a location that is associated with a first privacy level for the user, displaying, via the display component, a first type of content in the first widget; and in accordance with a determination that the computer system is at a location that is associated with a second privacy level for the user, different from the first privacy level for the user, displaying, via the display component, a second type of content in the first widget that is different from the first type of content in the first widget.

In some embodiments, a transitory computer-readable storage medium storing one or more programs configured to be executed by one or more processors of a computer system that is in communication with one or more input devices and a display component is described. In some embodiments, the one or more programs includes instructions for: detecting, via the one or more input devices, a user in an environment; and in response to detecting the user in the environment, displaying, via the display component, a first user interface that includes a first widget, wherein displaying the first widget includes: in accordance with a determination that the computer system is at a location that is associated with a first privacy level for the user, displaying, via the display component, a first type of content in the first widget; and in accordance with a determination that the computer system is at a location that is associated with a second privacy level for the user, different from the first privacy level for the user, displaying, via the display component, a second type of content in the first widget that is different from the first type of content in the first widget.

In some embodiments, a computer system that is in communication with one or more input devices and a display component is described. In some embodiments, the computer system that is in communication with one or more input devices and a display component comprises one or more processors and memory storing one or more programs configured to be executed by the one or more processors. In some embodiments, the one or more programs includes instructions for: detecting, via the one or more input devices, a user in an environment; and in response to detecting the user in the environment, displaying, via the display component, a first user interface that includes a first widget, wherein displaying the first widget includes: in accordance with a determination that the computer system is at a location that is associated with a first privacy level for the user, displaying, via the display component, a first type of content in the first widget; and in accordance with a determination that the computer system is at a location that is associated with a second privacy level for the user, different from the first privacy level for the user, displaying, via the display component, a second type of content in the first widget that is different from the first type of content in the first widget.

In some embodiments, a computer system that is in communication with one or more input devices and a display component is described. In some embodiments, the computer system that is in communication with one or more input devices and a display component comprises means for performing each of the following steps: detecting, via the one or more input devices, a user in an environment; and in response to detecting the user in the environment, displaying, via the display component, a first user interface that includes a first widget, wherein displaying the first widget includes: in accordance with a determination that the computer system is at a location that is associated with a first privacy level for the user, displaying, via the display component, a first type of content in the first widget; and in accordance with a determination that the computer system is at a location that is associated with a second privacy level for the user, different from the first privacy level for the user, displaying, via the display component, a second type of content in the first widget that is different from the first type of content in the first widget.

In some embodiments, a computer program product is described. In some embodiments, the computer program product comprises one or more programs configured to be executed by one or more processors of a computer system that is in communication with one or more input devices and a display component. In some embodiments, the one or more programs include instructions for: detecting, via the one or more input devices, a user in an environment; and in response to detecting the user in the environment, displaying, via the display component, a first user interface that includes a first widget, wherein displaying the first widget includes: in accordance with a determination that the computer system is at a location that is associated with a first privacy level for the user, displaying, via the display component, a first type of content in the first widget; and in accordance with a determination that the computer system is at a location that is associated with a second privacy level for the user, different from the first privacy level for the user, displaying, via the display component, a second type of content in the first widget that is different from the first type of content in the first widget.

In some embodiments, a method that is performed at a computer system that is in communication with a display component is described. In some embodiments, the method comprises: detecting a respective condition; and in response to detecting the respective condition, automatically displaying, via the display component and without user input, a set of one or more user interfaces that includes a respective user interface, wherein the respective user interface includes: in accordance with a determination that detecting the respective condition does not include detecting presence of a respective user, displaying a first widget; in accordance with a determination that detecting the respective condition includes detecting presence of a first user, concurrently displaying the first widget and a widget that includes content corresponding to the first user; and in accordance with a determination that detecting presence of the one or more users includes detecting presence of a second user different from the first user, concurrently displaying the first widget and a widget that includes content corresponding to the second user.

In some embodiments, a non-transitory computer-readable storage medium storing one or more programs configured to be executed by one or more processors of a computer system that is in communication with a display component is described. In some embodiments, the one or more programs includes instructions for: detecting a respective condition; and in response to detecting the respective condition, automatically displaying, via the display component and without user input, a set of one or more user interfaces that includes a respective user interface, wherein the respective user interface includes: in accordance with a determination that detecting the respective condition does not include detecting presence of a respective user, displaying a first widget; in accordance with a determination that detecting the respective condition includes detecting presence of a first user, concurrently displaying the first widget and a widget that includes content corresponding to the first user; and in accordance with a determination that detecting presence of the one or more users includes detecting presence of a second user different from the first user, concurrently displaying the first widget and a widget that includes content corresponding to the second user.

In some embodiments, a transitory computer-readable storage medium storing one or more programs configured to be executed by one or more processors of a computer system that is in communication with a display component is described. In some embodiments, the one or more programs includes instructions for: detecting a respective condition; and in response to detecting the respective condition, automatically displaying, via the display component and without user input, a set of one or more user interfaces that includes a respective user interface, wherein the respective user interface includes: in accordance with a determination that detecting the respective condition does not include detecting presence of a respective user, displaying a first widget; in accordance with a determination that detecting the respective condition includes detecting presence of a first user, concurrently displaying the first widget and a widget that includes content corresponding to the first user; and in accordance with a determination that detecting presence of the one or more users includes detecting presence of a second user different from the first user, concurrently displaying the first widget and a widget that includes content corresponding to the second user.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: detecting a respective condition; and in response to detecting the respective condition, automatically displaying, via the display component and without user input, a set of one or more user interfaces that includes a respective user interface, wherein the respective user interface includes: in accordance with a determination that detecting the respective condition does not include detecting presence of a respective user, displaying a first widget; in accordance with a determination that detecting the respective condition includes detecting presence of a first user, concurrently displaying the first widget and a widget that includes content corresponding to the first user; and in accordance with a determination that detecting presence of the one or more users includes detecting presence of a second user different from the first user, concurrently displaying the first widget and a widget that includes content corresponding to the second user.

In some embodiments, a computer system that is in communication with a display component is described. In some embodiments, the computer system that is in communication with a display component comprises means for performing each of the following steps: detecting a respective condition; and in response to detecting the respective condition, automatically displaying, via the display component and without user input, a set of one or more user interfaces that includes a respective user interface, wherein the respective user interface includes: in accordance with a determination that detecting the respective condition does not include detecting presence of a respective user, displaying a first widget; in accordance with a determination that detecting the respective condition includes detecting presence of a first user, concurrently displaying the first widget and a widget that includes content corresponding to the first user; and in accordance with a determination that detecting presence of the one or more users includes detecting presence of a second user different from the first user, concurrently displaying the first widget and a widget that includes content corresponding to the second user.

In some embodiments, a computer program product is described. In some embodiments, the computer program product comprises one or more programs configured to be executed by one or more processors of a computer system that is in communication with a display component. In some embodiments, the one or more programs include instructions for: detecting a respective condition; and in response to detecting the respective condition, automatically displaying, via the display component and without user input, a set of one or more user interfaces that includes a respective user interface, wherein the respective user interface includes: in accordance with a determination that detecting the respective condition does not include detecting presence of a respective user, displaying a first widget; in accordance with a determination that detecting the respective condition includes detecting presence of a first user, concurrently displaying the first widget and a widget that includes content corresponding to the first user; and in accordance with a determination that detecting presence of the one or more users includes detecting presence of a second user different from the first user, concurrently displaying the first widget and a widget that includes content corresponding to the second user.

In some embodiments, a method that is performed at a computer system that is in communication with a display component is described. In some embodiments, the method comprises: while operating with respect to a first context, displaying, via the display component, a user interface that includes a first widget, wherein displaying the user interface while operating with respect to the first context includes: in accordance with a determination that the first widget has a first amount of relevance in relation to the first context, displaying, via the display component, the first widget at a first size; and in accordance with a determination that the first widget has a second amount of relevance, different from the first amount of relevance, in relation to the first context, displaying, via the display component, the first widget at a second size different from the first size.

In some embodiments, a non-transitory computer-readable storage medium storing one or more programs configured to be executed by one or more processors of a computer system that is in communication with a display component is described. In some embodiments, the one or more programs includes instructions for: while operating with respect to a first context, displaying, via the display component, a user interface that includes a first widget, wherein displaying the user interface while operating with respect to the first context includes: in accordance with a determination that the first widget has a first amount of relevance in relation to the first context, displaying, via the display component, the first widget at a first size; and in accordance with a determination that the first widget has a second amount of relevance, different from the first amount of relevance, in relation to the first context, displaying, via the display component, the first widget at a second size different from the first size.

In some embodiments, a transitory computer-readable storage medium storing one or more programs configured to be executed by one or more processors of a computer system that is in communication with a display component is described. In some embodiments, the one or more programs includes instructions for: while operating with respect to a first context, displaying, via the display component, a user interface that includes a first widget, wherein displaying the user interface while operating with respect to the first context includes: in accordance with a determination that the first widget has a first amount of relevance in relation to the first context, displaying, via the display component, the first widget at a first size; and in accordance with a determination that the first widget has a second amount of relevance, different from the first amount of relevance, in relation to the first context, displaying, via the display component, the first widget at a second size different from the first size.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: while operating with respect to a first context, displaying, via the display component, a user interface that includes a first widget, wherein displaying the user interface while operating with respect to the first context includes: in accordance with a determination that the first widget has a first amount of relevance in relation to the first context, displaying, via the display component, the first widget at a first size; and in accordance with a determination that the first widget has a second amount of relevance, different from the first amount of relevance, in relation to the first context, displaying, via the display component, the first widget at a second size different from the first size.

In some embodiments, a computer system that is in communication with a display component is described. In some embodiments, the computer system that is in communication with a display component comprises means for performing each of the following steps: while operating with respect to a first context, displaying, via the display component, a user interface that includes a first widget, wherein displaying the user interface while operating with respect to the first context includes: in accordance with a determination that the first widget has a first amount of relevance in relation to the first context, displaying, via the display component, the first widget at a first size; and in accordance with a determination that the first widget has a second amount of relevance, different from the first amount of relevance, in relation to the first context, displaying, via the display component, the first widget at a second size different from the first size.

In some embodiments, a computer program product is described. In some embodiments, the computer program product comprises one or more programs configured to be executed by one or more processors of a computer system that is in communication with a display component. In some embodiments, the one or more programs include instructions for: while operating with respect to a first context, displaying, via the display component, a user interface that includes a first widget, wherein displaying the user interface while operating with respect to the first context includes: in accordance with a determination that the first widget has a first amount of relevance in relation to the first context, displaying, via the display component, the first widget at a first size; and in accordance with a determination that the first widget has a second amount of relevance, different from the first amount of relevance, in relation to the first context, displaying, via the display component, the first widget at a second size different from the first size.

In some embodiments, a method that is performed at a first computer system that is in communication with a camera is described. In some embodiments, the method comprises: capturing, via the camera, an image of a physical environment; and in response to capturing the image of the physical environment: in accordance with a determination that a first set of one or more criteria is satisfied, wherein the first set of one or more criteria includes a criterion that is satisfied when a second computer system is detected in the image, sending, to the second computer system, a request for content, wherein the second computer system is different from the first computer system; and in accordance with a determination that a second set of one or more criteria is satisfied, wherein the second set of one or more criteria includes a criterion that is satisfied when the second computer system is not detected in the image, forgoing sending, to the second computer system, the request for content, wherein the second set of one or more criteria is different from the first set of one or more criteria.

In some embodiments, a non-transitory computer-readable storage medium storing one or more programs configured to be executed by one or more processors of a first computer system that is in communication with a camera is described. In some embodiments, the one or more programs includes instructions for: capturing, via the camera, an image of a physical environment; and in response to capturing the image of the physical environment: in accordance with a determination that a first set of one or more criteria is satisfied, wherein the first set of one or more criteria includes a criterion that is satisfied when a second computer system is detected in the image, sending, to the second computer system, a request for content, wherein the second computer system is different from the first computer system; and in accordance with a determination that a second set of one or more criteria is satisfied, wherein the second set of one or more criteria includes a criterion that is satisfied when the second computer system is not detected in the image, forgoing sending, to the second computer system, the request for content, wherein the second set of one or more criteria is different from the first set of one or more criteria.

In some embodiments, a transitory computer-readable storage medium storing one or more programs configured to be executed by one or more processors of a first computer system that is in communication with a camera is described. In some embodiments, the one or more programs includes instructions for: capturing, via the camera, an image of a physical environment; and in response to capturing the image of the physical environment: in accordance with a determination that a first set of one or more criteria is satisfied, wherein the first set of one or more criteria includes a criterion that is satisfied when a second computer system is detected in the image, sending, to the second computer system, a request for content, wherein the second computer system is different from the first computer system; and in accordance with a determination that a second set of one or more criteria is satisfied, wherein the second set of one or more criteria includes a criterion that is satisfied when the second computer system is not detected in the image, forgoing sending, to the second computer system, the request for content, wherein the second set of one or more criteria is different from the first set of one or more criteria.

In some embodiments, a first computer system that is in communication with a camera is described. In some embodiments, the first computer system that is in communication with a camera comprises one or more processors and memory storing one or more programs configured to be executed by the one or more processors. In some embodiments, the one or more programs includes instructions for: capturing, via the camera, an image of a physical environment; and in response to capturing the image of the physical environment: in accordance with a determination that a first set of one or more criteria is satisfied, wherein the first set of one or more criteria includes a criterion that is satisfied when a second computer system is detected in the image, sending, to the second computer system, a request for content, wherein the second computer system is different from the first computer system; and in accordance with a determination that a second set of one or more criteria is satisfied, wherein the second set of one or more criteria includes a criterion that is satisfied when the second computer system is not detected in the image, forgoing sending, to the second computer system, the request for content, wherein the second set of one or more criteria is different from the first set of one or more criteria.

In some embodiments, a first computer system that is in communication with a camera is described. In some embodiments, the first computer system that is in communication with a camera comprises means for performing each of the following steps: capturing, via the camera, an image of a physical environment; and in response to capturing the image of the physical environment: in accordance with a determination that a first set of one or more criteria is satisfied, wherein the first set of one or more criteria includes a criterion that is satisfied when a second computer system is detected in the image, sending, to the second computer system, a request for content, wherein the second computer system is different from the first computer system; and in accordance with a determination that a second set of one or more criteria is satisfied, wherein the second set of one or more criteria includes a criterion that is satisfied when the second computer system is not detected in the image, forgoing sending, to the second computer system, the request for content, wherein the second set of one or more criteria is different from the first set of one or more criteria.

In some embodiments, a computer program product is described. In some embodiments, the computer program product comprises one or more programs configured to be executed by one or more processors of a first computer system that is in communication with a camera. In some embodiments, the one or more programs include instructions for: capturing, via the camera, an image of a physical environment; and in response to capturing the image of the physical environment: in accordance with a determination that a first set of one or more criteria is satisfied, wherein the first set of one or more criteria includes a criterion that is satisfied when a second computer system is detected in the image, sending, to the second computer system, a request for content, wherein the second computer system is different from the first computer system; and in accordance with a determination that a second set of one or more criteria is satisfied, wherein the second set of one or more criteria includes a criterion that is satisfied when the second computer system is not detected in the image, forgoing sending, to the second computer system, the request for content, wherein the second set of one or more criteria is different from the first set of one or more criteria.

In some embodiments, a method that is performed at a computer system that is in communication with a camera and a movement component is described. In some embodiments, the method comprises: receiving a first request to capture media; and in response to receiving the first request: performing, via the movement component, a first set of one or more movements that includes moving, via the movement component, a portion of the computer system in a first direction before moving in a direction opposite of the first direction; and initiating capture of media after performing the first set of one or more movements; and after performing the first set of one or more movements and initiating capture of media, receiving a second request to capture media; and in response to receiving the second request to capture media: performing the first set of one or more movements; and initiating capture of media after performing the first set of one or more movements.

In some embodiments, a non-transitory computer-readable storage medium storing one or more programs configured to be executed by one or more processors of a computer system that is in communication with a camera and a movement component is described. In some embodiments, the one or more programs includes instructions for: receiving a first request to capture media; and in response to receiving the first request: performing, via the movement component, a first set of one or more movements that includes moving, via the movement component, a portion of the computer system in a first direction before moving in a direction opposite of the first direction; and initiating capture of media after performing the first set of one or more movements; and after performing the first set of one or more movements and initiating capture of media, receiving a second request to capture media; and in response to receiving the second request to capture media: performing the first set of one or more movements; and initiating capture of media after performing the first set of one or more movements.

In some embodiments, a transitory computer-readable storage medium storing one or more programs configured to be executed by one or more processors of a computer system that is in communication with a camera and a movement component is described. In some embodiments, the one or more programs includes instructions for: receiving a first request to capture media; and in response to receiving the first request: performing, via the movement component, a first set of one or more movements that includes moving, via the movement component, a portion of the computer system in a first direction before moving in a direction opposite of the first direction; and initiating capture of media after performing the first set of one or more movements; and after performing the first set of one or more movements and initiating capture of media, receiving a second request to capture media; and in response to receiving the second request to capture media: performing the first set of one or more movements; and initiating capture of media after performing the first set of one or more movements.

In some embodiments, a computer system that is in communication with a camera and a movement component is described. In some embodiments, the computer system that is in communication with a camera and a movement component comprises one or more processors and memory storing one or more programs configured to be executed by the one or more processors. In some embodiments, the one or more programs includes instructions for: receiving a first request to capture media; and in response to receiving the first request: performing, via the movement component, a first set of one or more movements that includes moving, via the movement component, a portion of the computer system in a first direction before moving in a direction opposite of the first direction; and initiating capture of media after performing the first set of one or more movements; and after performing the first set of one or more movements and initiating capture of media, receiving a second request to capture media; and in response to receiving the second request to capture media: performing the first set of one or more movements; and initiating capture of media after performing the first set of one or more movements.

In some embodiments, a computer system that is in communication with a camera and a movement component is described. In some embodiments, the computer system that is in communication with a camera and a movement component comprises means for performing each of the following steps: receiving a first request to capture media; and in response to receiving the first request: performing, via the movement component, a first set of one or more movements that includes moving, via the movement component, a portion of the computer system in a first direction before moving in a direction opposite of the first direction; and initiating capture of media after performing the first set of one or more movements; and after performing the first set of one or more movements and initiating capture of media, receiving a second request to capture media; and in response to receiving the second request to capture media: performing the first set of one or more movements; and initiating capture of media after performing the first set of one or more movements.

In some embodiments, a computer program product is described. In some embodiments, the computer program product comprises one or more programs configured to be executed by one or more processors of a computer system that is in communication with a camera and a movement component. In some embodiments, the one or more programs include instructions for: receiving a first request to capture media; and in response to receiving the first request: performing, via the movement component, a first set of one or more movements that includes moving, via the movement component, a portion of the computer system in a first direction before moving in a direction opposite of the first direction; and initiating capture of media after performing the first set of one or more movements; and after performing the first set of one or more movements and initiating capture of media, receiving a second request to capture media; and in response to receiving the second request to capture media: performing the first set of one or more movements; and initiating capture of media after performing the first set of one or more movements.

In some embodiments, a method that is performed at a computer system that is in communication with a display component and one or more input devices is described. In some embodiments, the method comprises: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a non-transitory computer-readable storage medium storing one or more programs configured to be executed by one or more processors of a computer system that is in communication with a display component and one or more input devices is described. In some embodiments, the one or more programs includes instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a transitory computer-readable storage medium storing one or more programs configured to be executed by one or more processors of a computer system that is in communication with a display component and one or more input devices is described. In some embodiments, the one or more programs includes instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a computer system that is in communication with a display component and one or more input devices is described. In some embodiments, the computer system that is in communication with a display component and one or more input devices comprises means for performing each of the following steps: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a method that is performed at a computer system that is in communication with a movement component and one or more output devices is described. In some embodiments, the method comprises: in conjunction with outputting, via the one or more output devices, a first portion of content, detecting that a second portion of content corresponds to a respective location; and in conjunction with detecting that the second portion of content corresponds to the respective location: in accordance with a determination that the respective location is a first location, moving, via the movement component, a portion of the computer system in a first direction; and in accordance with a determination that the respective location is a second location different from the first location, moving, via the movement component, the portion of the computer system in a second direction different from the first direction.

In some embodiments, a non-transitory computer-readable storage medium storing one or more programs configured to be executed by one or more processors of a computer system that is in communication with a movement component and one or more output devices is described. In some embodiments, the one or more programs includes instructions for: in conjunction with outputting, via the one or more output devices, a first portion of content, detecting that a second portion of content corresponds to a respective location; and in conjunction with detecting that the second portion of content corresponds to the respective location: in accordance with a determination that the respective location is a first location, moving, via the movement component, a portion of the computer system in a first direction; and in accordance with a determination that the respective location is a second location different from the first location, moving, via the movement component, the portion of the computer system in a second direction different from the first direction.

In some embodiments, a transitory computer-readable storage medium storing one or more programs configured to be executed by one or more processors of a computer system that is in communication with a movement component and one or more output devices is described. In some embodiments, the one or more programs includes instructions for: in conjunction with outputting, via the one or more output devices, a first portion of content, detecting that a second portion of content corresponds to a respective location; and in conjunction with detecting that the second portion of content corresponds to the respective location: in accordance with a determination that the respective location is a first location, moving, via the movement component, a portion of the computer system in a first direction; and in accordance with a determination that the respective location is a second location different from the first location, moving, via the movement component, the portion of the computer system in a second direction different from the first direction.

In some embodiments, a computer system that is in communication with a movement component and one or more output devices is described. In some embodiments, the computer system that is in communication with a movement component and one or more output devices comprises one or more processors and memory storing one or more programs configured to be executed by the one or more processors. In some embodiments, the one or more programs includes instructions for: in conjunction with outputting, via the one or more output devices, a first portion of content, detecting that a second portion of content corresponds to a respective location; and in conjunction with detecting that the second portion of content corresponds to the respective location: in accordance with a determination that the respective location is a first location, moving, via the movement component, a portion of the computer system in a first direction; and in accordance with a determination that the respective location is a second location different from the first location, moving, via the movement component, the portion of the computer system in a second direction different from the first direction.

In some embodiments, a computer system that is in communication with a movement component and one or more output devices is described. In some embodiments, the computer system that is in communication with a movement component and one or more output devices comprises means for performing each of the following steps: in conjunction with outputting, via the one or more output devices, a first portion of content, detecting that a second portion of content corresponds to a respective location; and in conjunction with detecting that the second portion of content corresponds to the respective location: in accordance with a determination that the respective location is a first location, moving, via the movement component, a portion of the computer system in a first direction; and in accordance with a determination that the respective location is a second location different from the first location, moving, via the movement component, the portion of the computer system in a second direction different from the first direction.

In some embodiments, a computer program product is described. In some embodiments, the computer program product comprises one or more programs configured to be executed by one or more processors of a computer system that is in communication with a movement component and one or more output devices. In some embodiments, the one or more programs include instructions for: in conjunction with outputting, via the one or more output devices, a first portion of content, detecting that a second portion of content corresponds to a respective location; and in conjunction with detecting that the second portion of content corresponds to the respective location: in accordance with a determination that the respective location is a first location, moving, via the movement component, a portion of the computer system in a first direction; and in accordance with a determination that the respective location is a second location different from the first location, moving, via the movement component, the portion of the computer system in a second direction different from the first direction.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIGS. 2A-2C are diagrams illustrating exemplary components and user interfaces of electronic device 200 in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6J illustrate exemplary user interfaces for displaying content in a widget based on external conditions in accordance with some embodiments.

FIG. 7 is a flow diagram illustrating methods for displaying content in a widget based on a user's distance in accordance with some embodiments.

FIG. 8 is a flow diagram illustrating methods for displaying content in a widget based on location in accordance with some embodiments.

FIG. 9 is a flow diagram illustrating methods for displaying content in a widget based on presence of one or more users in an environment in accordance with some embodiments.

FIG. 10 is a flow diagram illustrating methods for displaying a widget containing content at a size based on relevance in accordance with some embodiments.

FIG. 11 is a flow diagram illustrating methods for displaying one or more widgets containing content based on presence of one or more users in an environment in accordance with some embodiments.

FIGS. 12A-12C illustrate exemplary user interfaces for detecting a second computer system and then receiving content from the second computer system in accordance with some embodiments.

FIG. 13 is a flow diagram illustrating methods for detecting a second computer system in an image and then receiving content from the second computer system in accordance with some embodiments.

FIG. 14 is a flow diagram illustrating methods for moving a computer system and then capturing media content in accordance with some embodiments.

FIGS. 15A-15C illustrate exemplary user interfaces for adjusting size of displayed content based on a computer system's level of confidence in the content in accordance with some embodiments.

FIG. 16 is a flow diagram illustrating methods for adjusting size of displayed content based on a computer system's level of confidence in the content in accordance with some embodiments.

FIGS. 17A-17E illustrate exemplary user interfaces for moving a part of a computer system in a direction based on a position of output content in accordance with some embodiments.

FIG. 18 is a flow diagram illustrating methods for moving a part of a computer system in a direction based on a position of output content in accordance with some embodiments.

### DETAILED DESCRIPTION

The description to follow sets forth exemplary methods, components, parameters, and the like. While specific examples are set out below, it should be recognized that such examples should not be understood as limiting the scope of the present disclosure to the explicit descriptions of the examples set forth herein but instead should be understood as providing illustrative examples.

Each of the identified modules and applications herein corresponds to a set of executable instructions for performing one or more functions described above and the methods described in this application (e.g., the computer-implemented methods and other information processing methods described herein). These modules (e.g., sets of instructions) optionally need not be implemented as separate software programs (such as computer programs (e.g., including instructions)), procedures, or modules, and thus various subsets of these modules are, optionally, combined or otherwise rearranged in various embodiments. For example, a video player module is, optionally, combined with a music player module into a single module. In some embodiments, memory optionally stores a subset of the modules and data structures identified above. Furthermore, memory optionally stores additional modules and data structures not described above.

One or more steps of the methods described herein can rely on (be contingent on) one or more conditions being satisfied. In some embodiments, a method is performed by iterating a process multiple times. In some embodiments, contingent steps can be satisfied on different iterations of the same process and still be within the scope of the methods described herein. For example, for a given method that includes two steps that are contingent on different conditions, one of ordinary skill in the art would understand that the given method is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompass any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device and/or user-device interfaces more efficient (e.g., by helping the user to provide proper inputs and reducing user mistakes when operating/interacting with the device) through various techniques, including by providing improved feedback (e.g., visual, haptic, acoustic, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

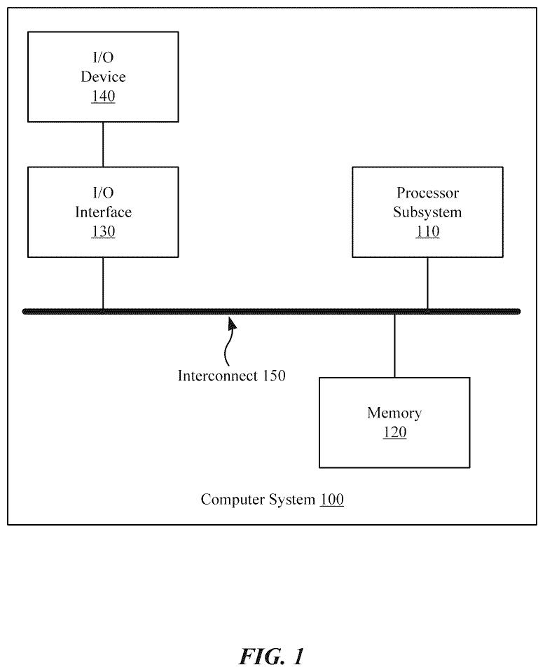

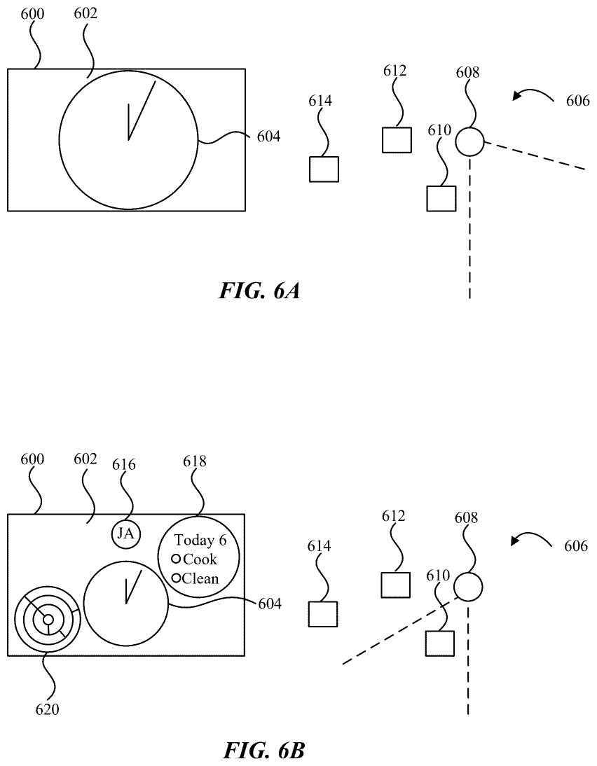

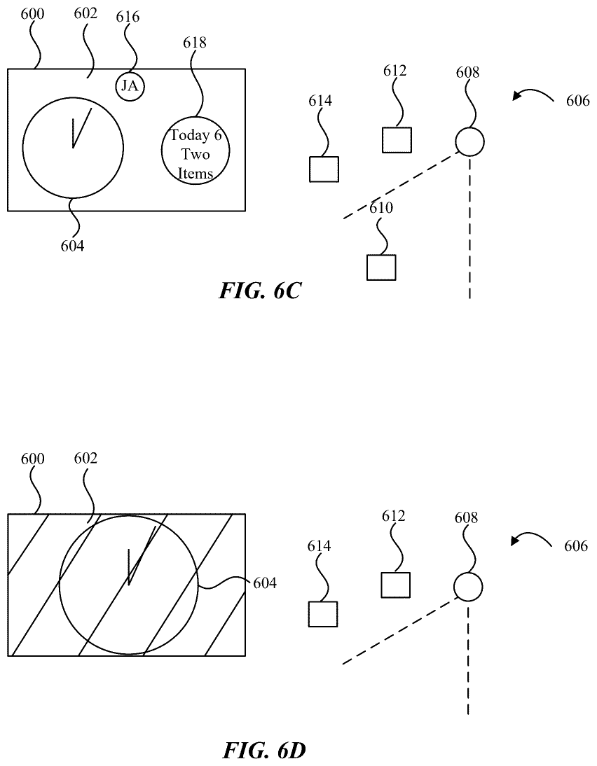

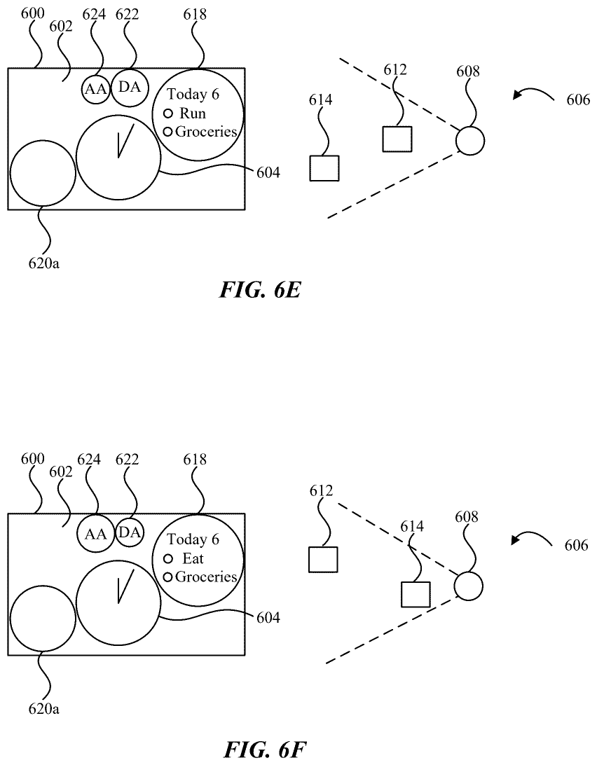

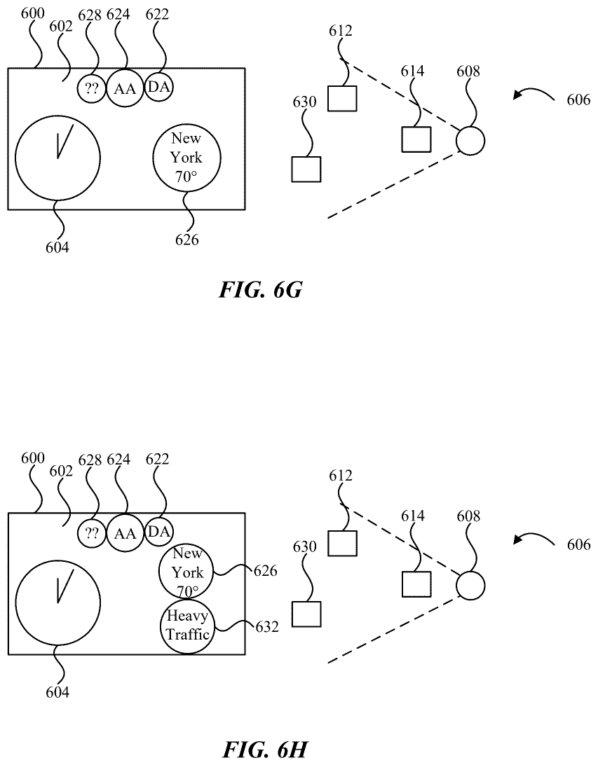

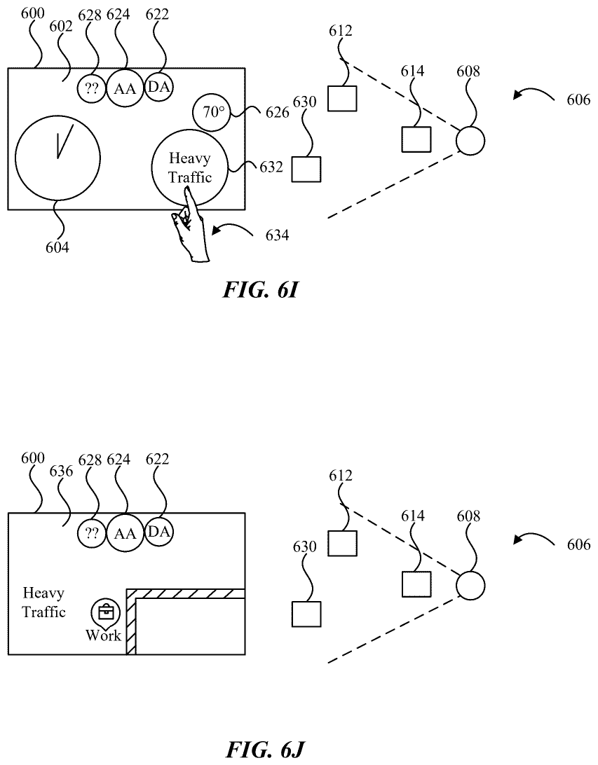

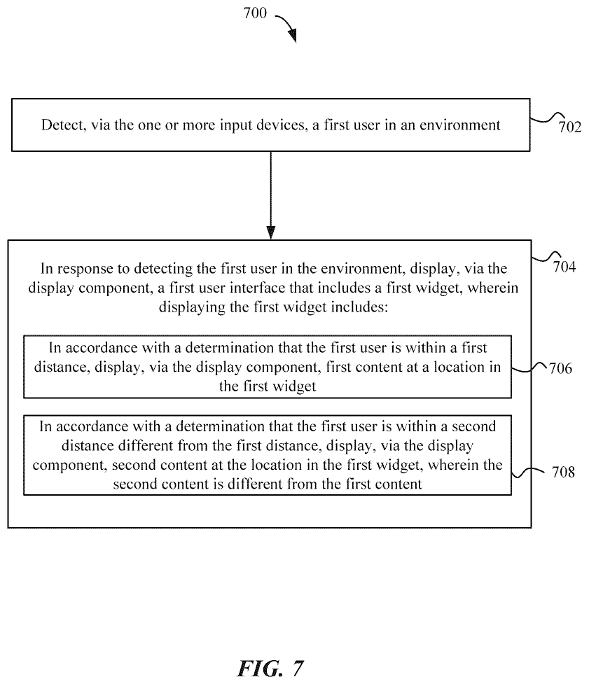

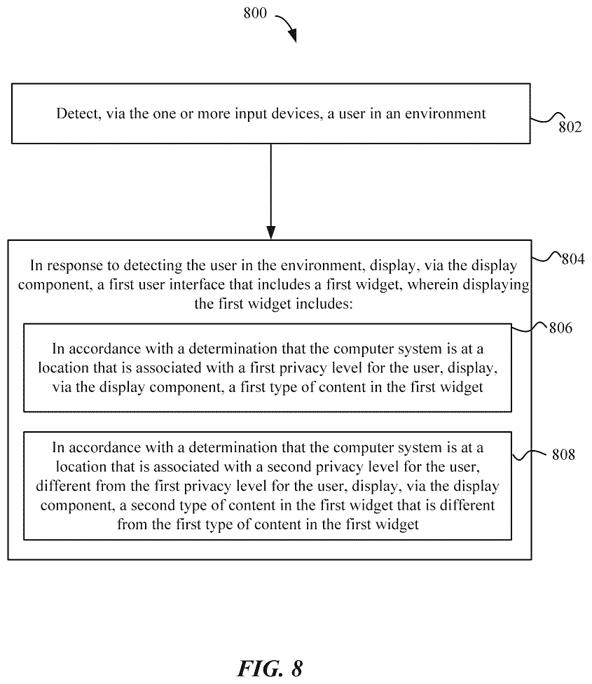

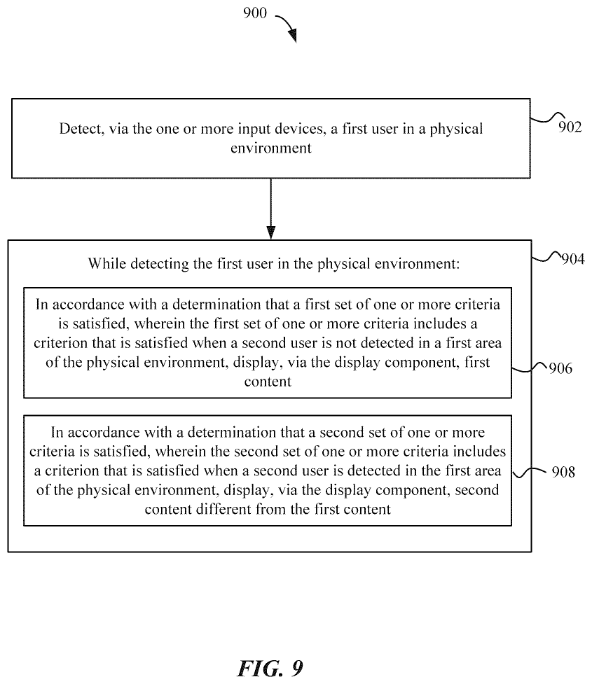

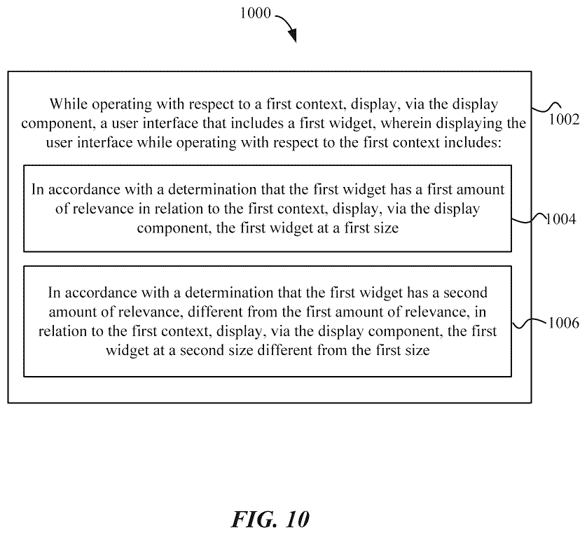

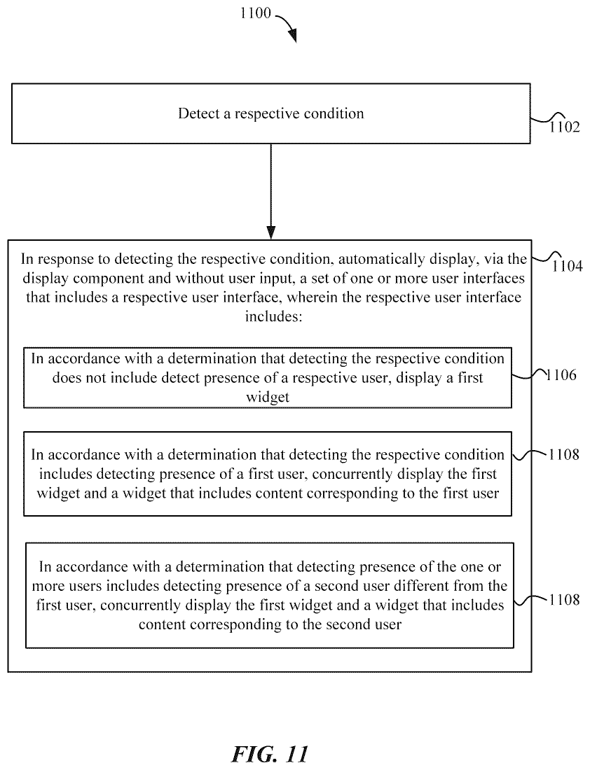

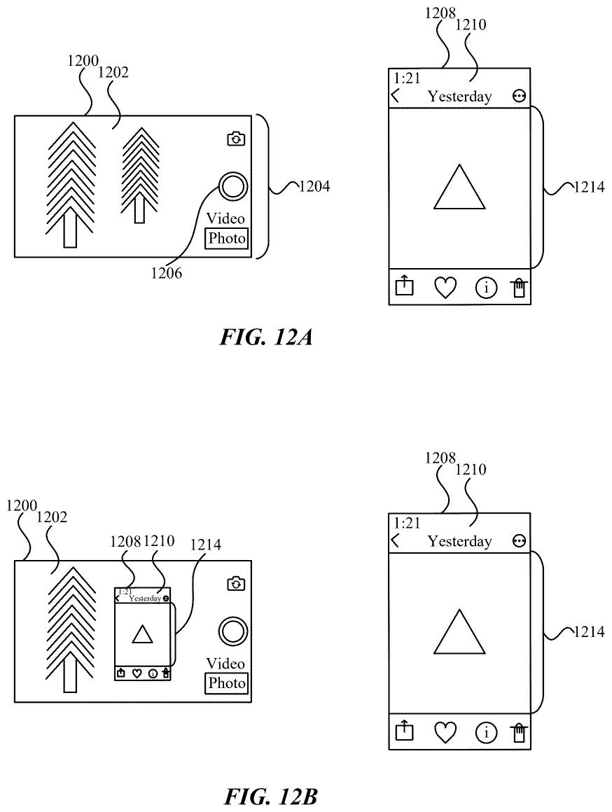

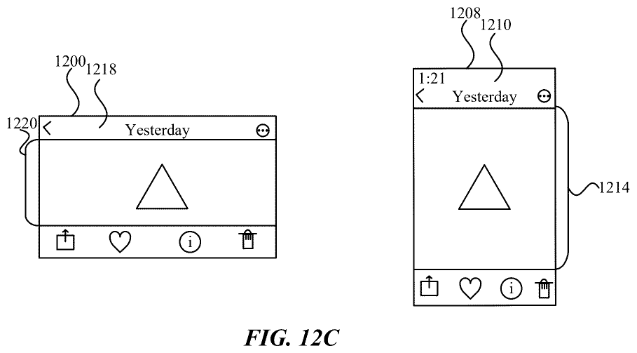

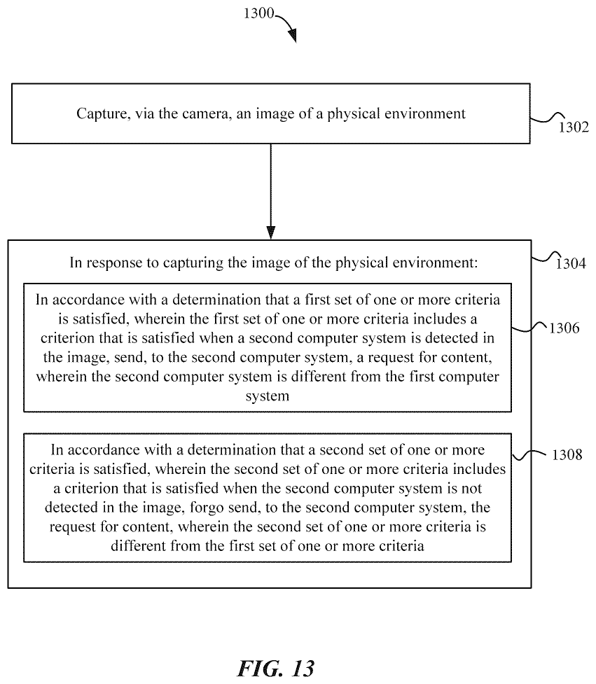

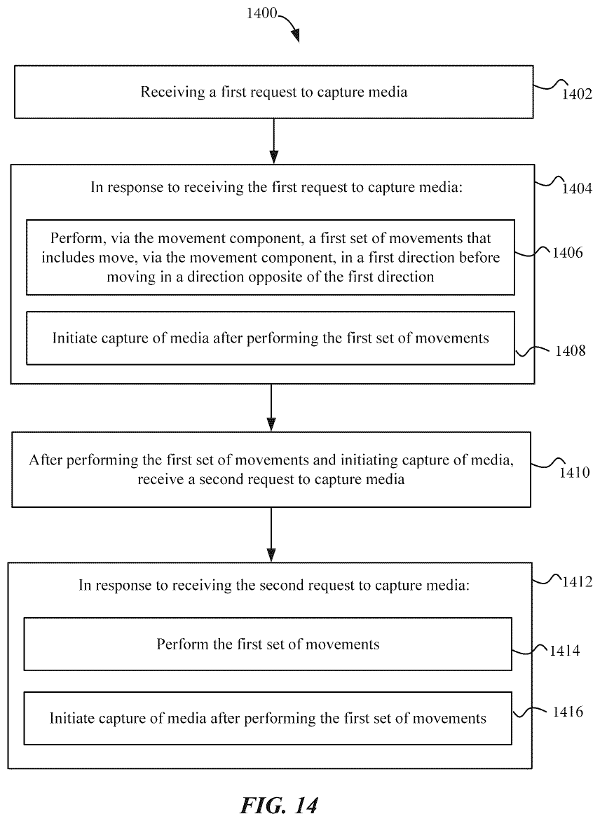

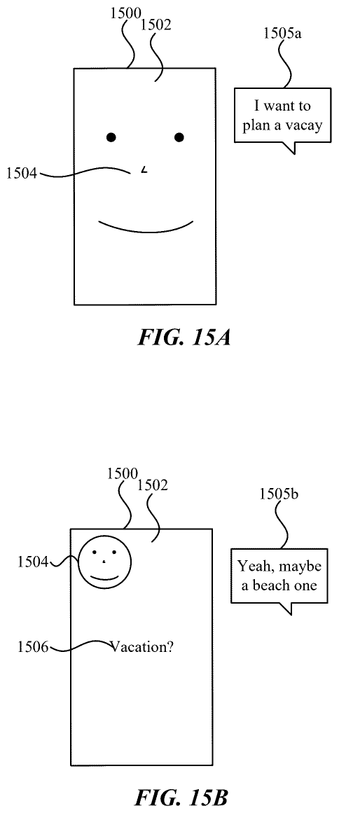

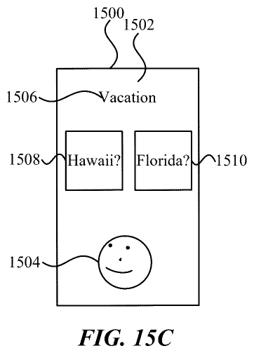

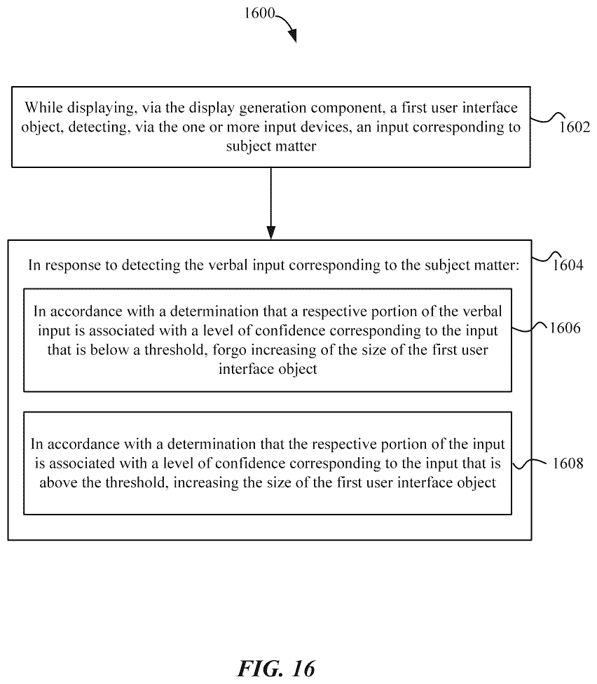

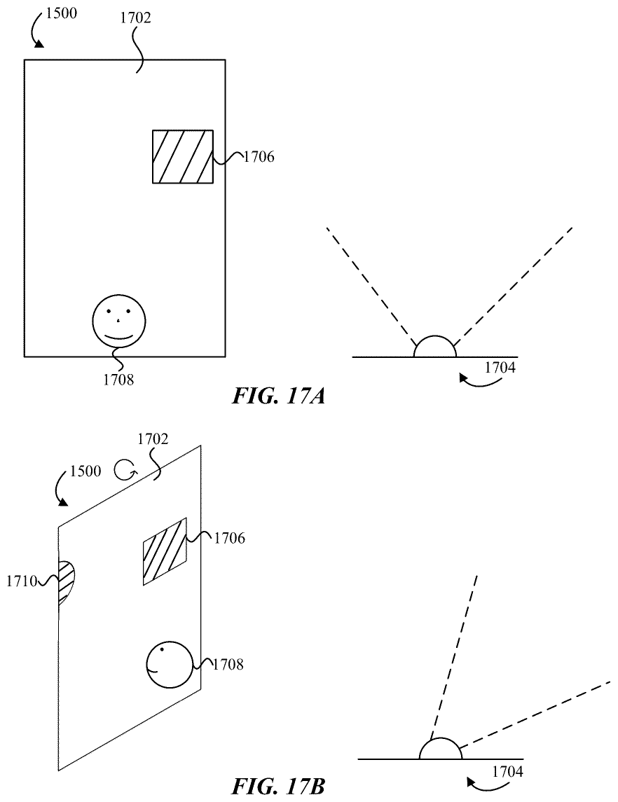

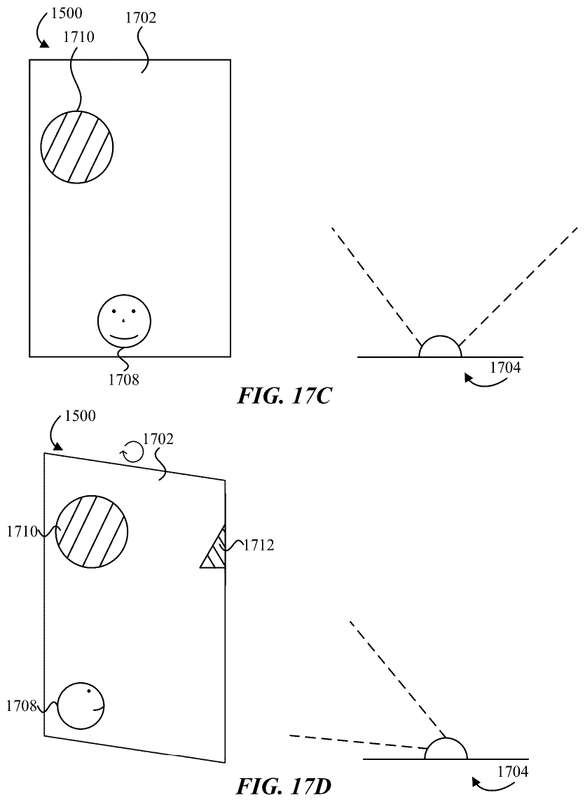

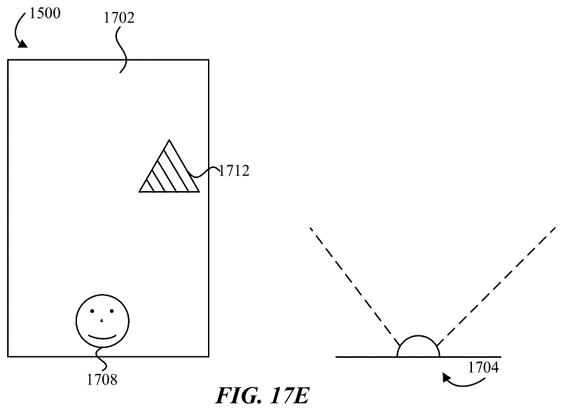

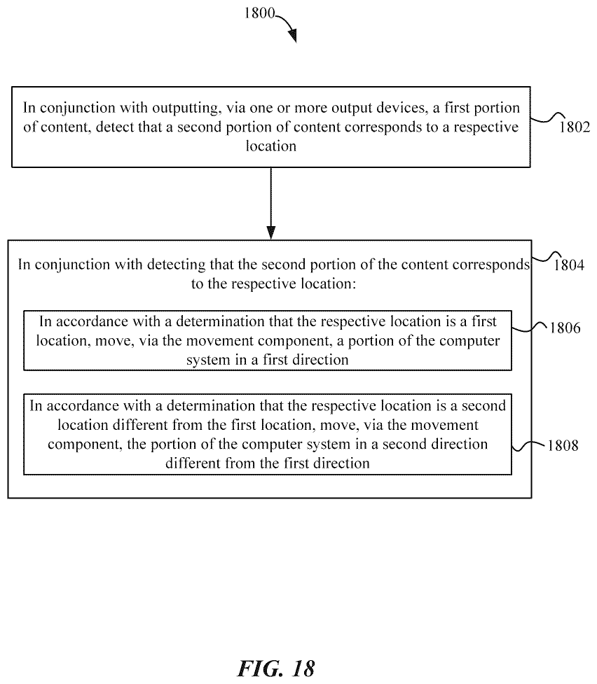

Below, FIGS. 1, 2A-2C, and 3-5 provide a description of exemplary devices for performing the techniques described herein. FIGS. 6A-6J illustrate exemplary user interfaces for displaying content in a widget based on external conditions in accordance with some embodiments. FIG. 7 is a flow diagram illustrating methods for displaying content in a widget based on a user's distance in accordance with some embodiments. FIG. 8 is a flow diagram illustrating methods for displaying content in a widget based on location in accordance with some embodiments. FIG. 9 is a flow diagram illustrating methods for displaying content in a widget based on presence of one or more users in an environment in accordance with some embodiments. FIG. 10 is a flow diagram illustrating methods for displaying a widget containing content at a size based on relevance in accordance with some embodiments. FIG. 11 is a flow diagram illustrating methods for displaying one or more widgets containing content based on presence of one or more users in an environment in accordance with some embodiments. The user interfaces in FIGS. 6A-6J are used to illustrate the processes described below, including the processes in FIGS. 7, 8, 9, 10, and 11. FIGS. 12A-12C illustrate exemplary user interfaces for detecting a second computer system and then receiving content from the second computer system in accordance with some embodiments. FIG. 13 is a flow diagram illustrating methods for detecting a second computer system in an image and then receiving content from the second computer system in accordance with some embodiments. FIG. 14 is a flow diagram illustrating methods for moving a computer system and then capturing media content in accordance with some embodiments. The user interfaces in FIGS. 12A-12C are used to illustrate the processes described below, including the processes in FIGS. 13 and/or 14. FIGS. 15A-15C illustrate exemplary user interfaces for adjusting size of displayed content based on a computer system's level of confidence in the content in accordance with some embodiments. FIG. 16 is a flow diagram illustrating methods for adjusting size of displayed content based on a computer system's level of confidence in the content in accordance with some embodiments. The user interfaces in FIGS. 15A-15C are used to illustrate the processes described below, including the processes in FIG. 16. FIGS. 17A-17E illustrate exemplary user interfaces for moving a part of a computer system in a direction based on a position of output content in accordance with some embodiments. FIG. 18 is a flow diagram illustrating methods for moving a part of a computer system in a direction based on a position of output content in accordance with some embodiments. The user interfaces in FIGS. 17A-17E are used to illustrate the processes described below, including the processes in FIG. 18.

FIG. 1 depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1 depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, television, and so forth), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR, LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystem 100s, each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments each instruction stored by memory 120 and executed by processor subsystem 110 corresponds to an operation for completing the functionality described herein. For example, memory 120 can store program instructions to implement the functionality associated with the methods described below including 700, 800, 900, 1000, and 1100 (FIGS. 7, 8, 9, 10, and 11).

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: a physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a person, an animal, another computer system different from the computer system, and/or an object) and/or an input (e.g., a tap input and/or a non-tap input (e.g., a verbal input, an acoustic request, an acoustic command, an acoustic statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, as account corresponding to a user can be connected with additional accounts and/or additional computer systems. For example, computer system 100 can detect such additional computer systems and/or detect such computer systems for detecting the user. In some embodiments, computer system 100 can detect unknown users and enable guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output component. For example, a tactile output component can be a haptic generation component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, digital art, etc.). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

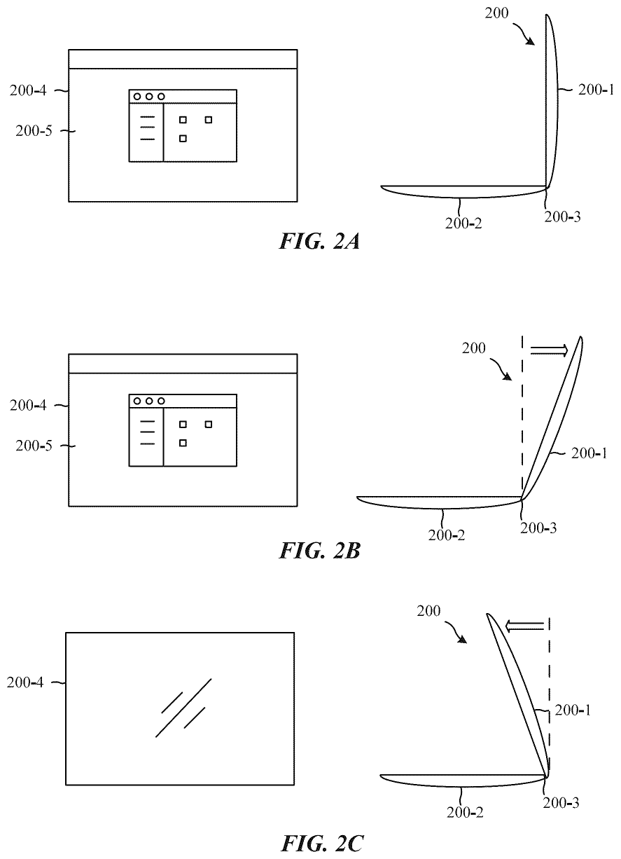

FIGS. 2-5 illustrate exemplary components and user interfaces of electronic device 200 in accordance with some embodiments. Electronic device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

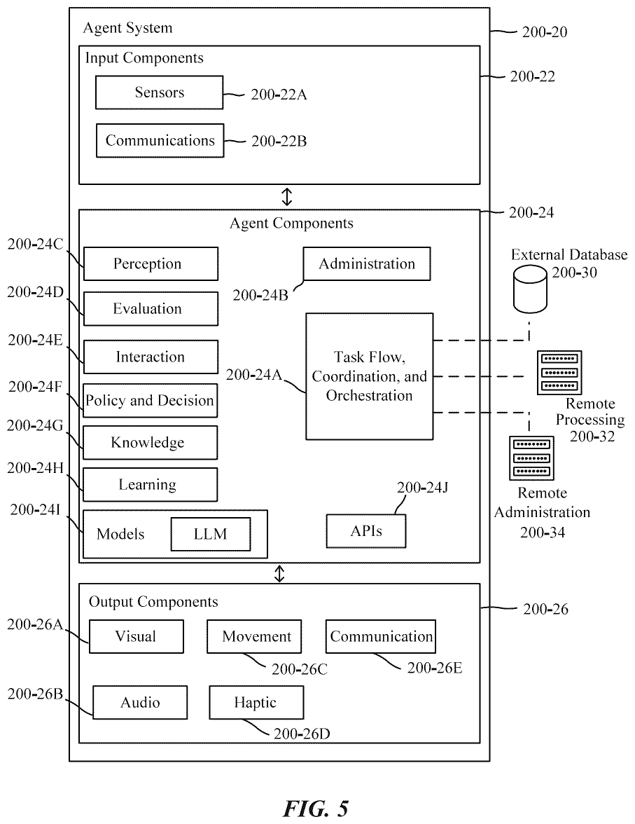

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output component that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

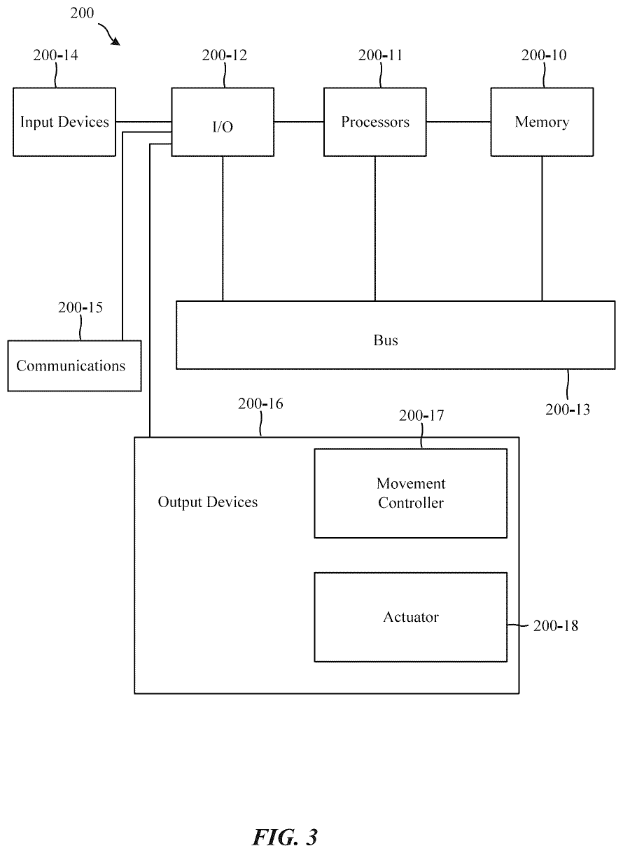

FIG. 3 illustrates exemplary block diagram of device 200. In some embodiments, device 200 includes some or all of the components described with respect to FIGS. 1A, 1B, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output components”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of personal electronic device 200 can include one or more non-transitory computer-readable storage mediums, for storing computer-executable instructions, which, when executed by one or more computer processors 200-11, for example, cause the computer processors to perform the techniques described below, including processes 700, 800, 900, 1000, 1100, 1300, 1400, 1600, and 1800 (FIGS. 7, 8, 9, 10, 11, 13, 14, 16, and 18). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Electronic device 200 is not limited to the components and configuration of FIG. 3 but can include other and/or additional components in a multitude of possible configurations, all of which are intended to be within the scope of this disclosure.

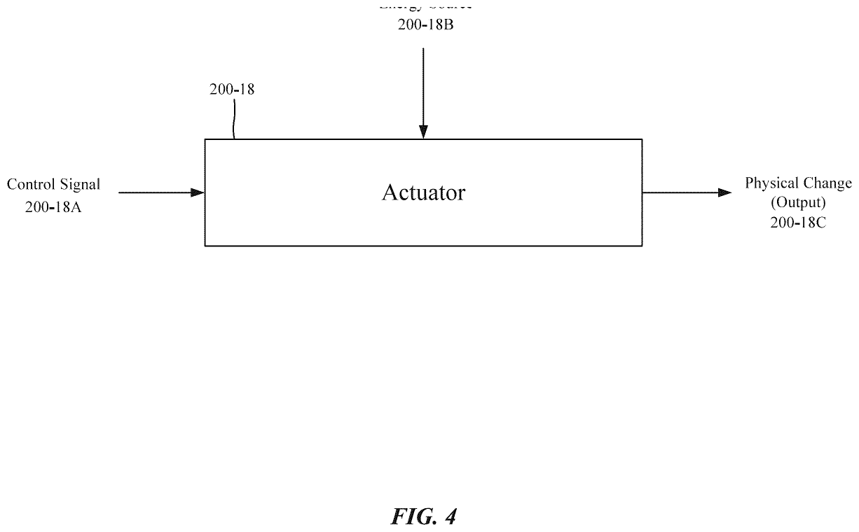

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or electronic device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “person,” “object,” and/or “animal” can be interchanged with “user” throughout this disclosure, unless explicitly indicated otherwise. For example, use the term “user” can likewise be understood to also refer to “subject,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20. As illustrated in FIG. 5, agent system 200-20 has a dotted box boundary that encloses input components 200-22, agent components 200-24, and output components 200-26. In some embodiments, agent system 200-20 includes fewer, more, and/or different components than illustrated in FIG. 5. In some embodiments, agent system 200-20 is implemented on a single device (e.g., computer system 100 and/or electronic device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input components 200-22 include components for performing sensing and/or communications functions of agent system 200-20. As illustrated in FIG. 5, input components 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input components 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input components 200-22 includes fewer, more, and/or different components than those illustrated in FIG. 5. In some embodiments, input components 200-22 is implemented in hardware and/or software.

In some embodiments, agent components 200-24 include components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-24I, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 include fewer, more, and/or different components than those illustrated in FIG. 5. In some embodiments, agent components 200-24 are implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-24I (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., user, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input components) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user. For example, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input components) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input components) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-24I performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-24I includes functionality performed by an operating system of a device implementing agent system 200-20. In some embodiments, models component 200-24I includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user's location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output components 200-26 include components for performing output functions of agent system 200-20. The exemplary output components illustrated in FIG. 5 are described briefly below. In some embodiments, output components 200-26 include fewer components, more, and/or different components than those illustrated in FIG. 5. In some embodiments, input components are implemented in hardware and/or software.

As illustrated in FIG. 5, output components 200-26 includes one or more visual output components 200-26A. One or more visual output components 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output components 200-26A can include: a display component, a projector, a head mounted display (HMD), a light-emitting diode (“LED”), and/or a component that creates visually perceptible effects (e.g., movement). This list is not intended to be exhaustive, and one or more visual output components 200-26A can include other visual output components not explicitly identified herein that detect, generate, and/or otherwise provide data that can be used (e.g., processed, stored, and/or transformed) for outputting visual output.

As illustrated in FIG. 5, output components 200-26 include one or more audio output components 200-26B. One or more audio output components 200-26B can include any component that functions to output (e.g., generate and/or create), and/or cause output of, an audio output (e.g., an output that is audibly perceptible, such as a sound, music, speech, and/or audio media content). Examples of one or more audio output components 200-26B can include: a speaker, an audio amplifier, a tone generator, and/or a component that creates audibly perceptible effects (e.g., movement such as vibrations). This list is not intended to be exhaustive, and one or more audio output components 200-26B can include other audio output components not explicitly identified herein that detect, generate, and/or otherwise provide data that can be used (e.g., processed, stored, and/or transformed) for outputting audio output.

As illustrated in FIG. 5, output components 200-26 include one or more movement output components 200-26C (also referred to herein as a “movement component”). One or more movement output components 200-26C can include any component that functions to output (e.g., generate and/or create), and/or cause output of, a movement output (e.g., an output that includes physical movement of the device and/or another device/component). Examples of one or more movement output components 200-26C can include: a movement controller, an actuator, a mechanical linkage, an electromechanical device, and/or a component that creates physical movement. This list is not intended to be exhaustive, and one or more movement output components 200-26C can include other movement output components not explicitly identified herein that detect, generate, and/or otherwise provide data that can be used (e.g., processed, stored, and/or transformed) for outputting movement output. As illustrated in FIG. 5, output components 200-26 include one or more haptic output components 200-26D. One or more haptic output components 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output components 200-26D can include: a speaker, a component that generates vibrations, a component that generates texture changes, a component that generates pressure changes, and/or a component that creates perceivable tactile effects. This list is not intended to be exhaustive, and one or more haptic output components 200-26D can include other haptic output components not explicitly identified herein that detect, generate, and/or otherwise provide data that can be used (e.g., processed, stored, and/or transformed) for outputting haptic output.

As illustrated in FIG. 5, output components 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input component and an output component).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-20 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or electronic device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output components that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, acoustic output, sound, and/or speech) (also referred to herein as a “verbal response,” an “audio response,” and/or an “acoustic response”) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depend on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or electronic device 200.

FIGS. 6A-6J illustrate exemplary user interfaces for displaying content in a widget based on external conditions in accordance with some embodiments. The user interfaces in these figures are used to illustrate the processes described below, including the processes in FIGS. 7-11.

FIGS. 6A-6J illustrate exemplary user interfaces for displaying content based on external conditions in accordance with some embodiments. The user interfaces in these figures are used to illustrate the processes described below, including the processes in FIGS. 7-11.

The left side FIGS. 6A-6J illustrate computer system 600 (e.g., a tablet) displaying different user interface objects. It should be recognized that computer system 600 can be other types of computer systems, such as a smart phone, a smart watch, a laptop, a communal device, a smart speaker, an accessory, a personal gaming system, a desktop computer, a fitness tracking device, and/or a head-mounted display (HMD) device. In some embodiments, computer system 600 includes and/or is in communication with one or more input devices and/or sensors (e.g., a camera, a LiDAR detector, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. It should be recognized that, while some embodiments described herein refer to inputs being touch inputs, other types of inputs can be used with techniques described herein, such as voice inputs via a microphone and air gestures detected via a camera. In some embodiments, computer system 600 includes and/or is in communication with one or more output devices (e.g., a display screen, a projector, a touch-sensitive display, speaker, and/or a movement component). Such output devices can be used to present information and/or cause different visual changes of computer system 600. In some embodiments, computer system 600 includes and/or is in communication with one or more movement components (e.g., an actuator, a moveable base, a rotatable component, and/or a rotatable base). Such movement components, as discussed above, can be used to change a position (e.g., location and/or orientation) of computer system 600 and/or a portion (e.g., including one or more sensors, input components, and/or output components) of computer system 600. In some embodiments, computer system 600 includes one or more components and/or features described above in relation to computer system 100 and/or electronic device 200. In some embodiments, computer system 600 includes one or more agents and/or functions of an agent as described above with respect to FIG. 5. In some embodiments, computer system 600 is, includes, implements, and/or is in communication with one or more agent systems, as described above with respect to FIG. 5, for performing (and/or causing performance of) one or more operations of an agent.

The right side of FIGS. 6A-6J include diagram 606. Diagram 606 is a visual aid representing a physical space and/or environment that includes computer system 600, a first user, a second user, and a third user. Diagram 606 includes computer system representation 608 for computer system 600, first user representation 610 for the first user, second user representation 612 for the second user, and third user representation 614 for the third user. The positioning of computer system representation 608, first user representation 610, second user representation 612, and third user representation 614 within diagram 606 is representative of the real-world positioning of computer system 600 with respect to the first user, the second user, and the third user. Diagram 606 includes dotted lines which represent a field of detection and/or a field of view (sometimes collectively referred to as the field of detection) of computer system representation 608. The field of detection of computer system representation 608 corresponds to the field of detection for one or more front facing sensors of computer system 600 in the real-world. In some embodiments, one or more other sensors of computer system 600 include a different field of detection than the field of detection (e.g., overlapping but smaller or bigger and/or not overlapping). In this example, there are three users. In some embodiments, there are more or less than three users.

FIGS. 6A-6I illustrate a process where computer system 600 displays one or more widgets and/or one or more user indications in response to detecting one or more users within the field of detection. In some embodiments, if a user within the field of detection is recognized by computer system 600 (e.g., registered with computer system 600), computer system 600 displays an indication that the user is recognized and/or displays one or more widgets (e.g., user interface elements that, in some embodiments, are predefined and/or preconfigured by the user) corresponding to the user. In some embodiments, if a user within the field of detection is not recognized by computer system 600 (e.g., not registered with computer system 600), computer system 600 displays an indication that the user is not recognized and/or does not display widgets corresponding to the unknown user. In some embodiments, the location and/or size that computer system 600 displays the one or more widgets is dependent on the location of one or more users within the field of detection, as further discussed below. In some embodiments, the location and/or size that computer system 600 displays the one or more user indications is dependent on the location of the user within the field of detection, as further discussed below. While FIGS. 6A-6I illustrate computer system 600 displaying particular widgets and/or content within the particular widgets, it should be recognized that such widgets and/or content are merely for explanatory purposes and that such widgets can be in different locations, at different sizes, include different content and/or that more, fewer, and/or different widgets can be used in accordance with techniques described herein. In some embodiments, a widget is a user interface element (e.g., a control and/or an indication) displayed by computer system 600 that includes a condensed amount of dynamic content that corresponds to an individual application.

As illustrated in FIG. 6A, computer system 600 displays user interface 602 including clock widget 604, which displays the current real-world time at a central location of user interface 602. In this example, user interface 602 is a home screen user interface which can include one or more indications and/or controls. In some embodiments, user interface 602 is a smart home system user interface that displays indications and/or controls for a building's systems (e.g., lighting, shades, locks, sound, and/or environmental controls). For example, user interface 602 can be displaying the lock status of all the doors of the building as well as the average room temperature. In some embodiments, user interface 602 is an office check in system user interface, which will be describe in more detail below. In some embodiments, user interface 602 includes an avatar (e.g., an anthropomorphic visual representation) for a virtual assistant and/or other artificial intelligence application. In some embodiments, user interface 602 does not include clock widget 604. It should be recognized that such content of user interface 602 as described herein is used for discussion purposes and that other and/or different content can be included in user interface 602.

As illustrated in diagram 606 of FIG. 6A, no users are within the field of detection of computer system 600 (e.g., as indicated in diagram 606 by no user representation (e.g., first user representation 610, second user representation 612, and/or third user representation 614) being located within the field of detection of computer system representation 608). At FIG. 6A, computer system 600 detects one or more users within the environment. In some embodiments, computer system 600 is in communication with additional input devices and detects the users through an input device other than the field of view of one or more cameras. For example, by communicating with a microphone, proximity seniors, and/or additional devices (e.g., connecting to a device held and/or worn by a user). In some embodiments, a user is a living thing (e.g., a person, a user, and/or an animal). In some embodiments, a user is an electronic device (e.g., smart phone, a smart watch, a laptop, a communal device, a smart speaker, an accessory, a personal gaming system, a desktop computer, a fitness tracking device, a head-mounted display (HMD) device, a drone, and/or a robot). At FIG. 6A, computer system 600 does not detect any users (e.g., the first user, the second user, and/or the third user) within the field of detection. As illustrated in FIG. 6A, in response to not detecting a user within the field of detection, computer system 600 does not display additional content (e.g., content and/or one or more other common widgets) other than clock widget 604. In this example, clock widget 604 is a common widget. In some embodiments, a common widget is a widget that does not correspond to a particular user (e.g., does not correspond to an application that that a user has an account and/or profile with). In some embodiments, a common widget is a widget that contains generalized content that does not correspond to any particular user. For example, content such as weather, current time, battery percentage, and/or connectivity. In some embodiments, a common widget is a widget that computer system 600 displays irrespective of displaying, no longer displaying, and/or changing one or more other widgets in user interface 602.

In this example, computer system 600 displays clock widget 604 in an analog format. In some embodiments, computer system 600 displays clock widget 604 in a different format, such as analog, digital, and/or a hybrid format. In some embodiments, computer system 600 displays content and/or widgets in user interface 602 according to certain visual goals. For example, a visual goal such as maximizing the size of content for easier viewing by a user, hiding and/or generalizing personal information in a lower privacy area, and/or displaying content according to its relevance to a user and/or context of the environment. In this example, computer system 600 displays clock widget 604 occupying the majority of user interface 602 due to the lack of one or more other widgets and/or to maximize a user's ability to view clock widget 604. At FIG. 6A, in some embodiments, computer system 600 displays user interface 602 as a welcome user interface. In some embodiments, a welcome user interface includes an identified user's preferred widgets and/or common widgets to be displayed whether an identified user and/or unidentified user is present or not. In some embodiments, user interface 602 only including clock widget 604 is a welcome user interface.

After FIG. 6A, in response to detecting one or more users within the environment, computer system 600 rotates a portion of computer system 600 until the first user is within the field of detection of computer system 600. In some embodiments, in response to detecting one or more users, computer system 600 transitions from an inactive state (e.g., power saving state and/or waiting to detect an event (e.g., detect a user, detect input from a user, and/or output an indication)) to an active state. In some embodiments, computer system 600 being in an inactive state includes reduced screen brightness, reduced displayed content (e.g., a clock, battery percentage, and/or device name), and/or lack of any displayed content. In some embodiments, computer system 600 transitioning from an inactive state to an active state includes increasing screen brightness, displaying additional content (e.g., content and/or additional system content), and/or enabling additional functionality (e.g., touch input, ability to receive voice input, and/or user recognition).

As illustrated in diagram 606 of FIG. 6B, first user 610 is within the field of detection of computer system representation 608 while other users (e.g., second user representation 612 and/or third user representation 614) are not within the field of detection of computer system representation 608, indicating that the first user is within the field of detection of computer system 600 while the second user and the third user are not within the field of detection of computer system 600. At FIG. 6B, computer system 600 detects the first user within the new field of detection of computer system 600.

As illustrated in FIG. 6B, in response to detecting the first user within the field of detection of computer system 600, computer system 600 displays user interface 602 including additional user interface elements that correspond to the first user. In this example, the first user (e.g., Julie Allen) is known to computer system 600. In some embodiments, a user that is known to computer system 600 is registered with computer system 600 (e.g., the user has an account, the user's biometrics are catalogued, and/or the user has a login). In some embodiments, a user that is known to computer system 600 is a user that computer system 600 contains and/or obtains from an external device an identification and/or authentication record for the user. At FIG. 6B, computer system 600 recognizes the first user. As illustrated in FIG. 6B, in response to recognizing the first user and detecting the first user within the field of detection, computer system 600 displays first user indication 616 as one of the additional user interface elements that correspond to the first user. In this example, first user identification includes the initials of the first user (e.g., J. A. for Julie Allen). In some embodiments, user indications (e.g., first user indication 616) include alternative content. For example, user indications can include a picture (e.g., a profile picture and/or representative picture of the user) and/or avatar (e.g., a humanoid and/or non-humanoid representation of the user, a symbol, and/or abstract representation of the user). In some embodiments, computer system 600 includes content within first user indication 616 obtained from another computer system. For example, computer system 600 can display Julie's profile picture from her one or more other computer systems (e.g., handheld devices, wearable devices, and/or personal computer systems) within first user indication 616. As illustrated earlier in FIG. 6A, in some embodiments computer system 600 does not detect a user within the field of detection, causing computer system 600 to not display a user indication.

As illustrated in FIG. 6B, in response to recognizing the first user and detecting the first user, computer system 600 displays (1) fitness widget 620 which includes fitness information corresponding to the first user and (2) to-do list widget 618 which includes a to-do list that corresponds to the first user. In this example, identified users and/or unidentified users outside of the field of detection of computer system 600 do not affect the content displayed by computer system 600. In some embodiments, as illustrated in FIG. 6B, in response to detecting a user within the field of detection, computer system 600 displays new user interface elements (e.g., widgets) surrounding existing user interface element(s) (e.g., common widgets) (e.g., clock widget 604) and displays the new user interface elements at a reduced size in relation to the existing element(s). Also in some embodiments, as illustrated in FIG. 6B, in response to displaying new user interface elements, computer system 600 displays existing element(s) (e.g., clock widget 604) in the same location, even though computer system 600 reduces the size of the existing element(s) to accommodate the new user interface elements (e.g., fitness widget 620 and/or to-do list widget 618). In some embodiments, computer system 600 enables a user to customize a set of one or more preferred widgets to correspond to the user. For example, a user setting a clock widget and/or weather widget as preferred widgets to be displayed when the user is detected.

In some embodiments, computer system 600 repositions and/or resizes the common widget to accommodate one or more additional widgets. In some embodiments, computer system 600 repositions and/or resizes one or more widgets within user interface 602 based on the one or more widgets relevance to the context of the environment. For example, computer system 600 displaying traffic information early in the morning and/or displaying weather information as a storm approaches. In some embodiments, computer system 600 replaces clock widget 604 with a different widget based at its location in user interface 602. For example, displaying a calendar as the common widget when computer system 600 is in a different location within the user's home.

In some embodiments, as discussed further below, content and/or widgets correspond to a particular user include information about and/or obtain information for the user. For example, computer system 600 accesses content linked to user 610 in order to populate to-do list widget 618. In some embodiments, a widget corresponds to a particular user due to the widget containing content and/or information obtained by computer system 600 as part of identifying the user. For example, computer system 600 obtaining identification and/or authentication records for a particular user and displaying content that is connected to the identification and/or authentication. As well, for example, a calendar widget corresponds to a particular user due to the calendar widget containing that user's data, such as meetings and/or events.

At FIG. 6B, in some embodiments, computer system 600 displays fitness widget 620, to-do list widget 618, and/or user indication 616 through an animation. For example, transition from FIG. 6A to FIG. 6B, an animation includes shrinking clock widget 604 and displaying and/or growing to-do list widget 618 and/or fitness widget 620. For example, computer system 600 displays a growing animation by initially displaying a widget at a reduced size, and then over a predetermined amount of time, displays the widget at a maximum and/or final size. In some embodiments, computer system 600 displays additional widgets (e.g., to-do list widget 618 and/or fitness widget 620) through a pop on and/or bounce type animation. For example, computer system 600 displays a pop on and/or bounce animation by displaying a widget at a larger than final size, and then over a predetermined amount of time, displaying the widget at a smaller and/or final size within user interface 602.

As illustrated in FIG. 6B, to-do list widget 618 and fitness widget 620 include detailed and/or personal information. In some embodiments, computer system 600 displays additional detailed and/or personal information because computer system 600 detects movement to a more private location. In some embodiments, personal information includes financial, health, computer system usage, dating, and/or organization affiliation information. For example, the field of detection of computer system 600 in FIG. 6A (e.g., a low privacy location) changing to the field of detection of computer system 600 in FIG. 6B (e.g., a higher privacy location). In some embodiments, computer system 600 only displays detailed and/or personal information when the environment in which computer system 600 is located is of a certain privacy level and/or a user (e.g., user 610) is sufficiently close to (e.g., within a predetermined distance of) computer system 600. For example, only displaying personal information when computer system 600 is located within the user's home. As well, in some embodiments a change in privacy level is due to computer system 600 moving from a personal location to a public location. For example, in response to detecting a user moving computer system 600 from the user's home to the user's friends' home, the user's work, a public park, and/or to school computer system 600 can decrease the amount of private information displayed within user interface 602. In some embodiments, a change in privacy level is due to computer system 600 being moved from a known location to an unknown location. For example, a user moving computer system 600 from their home to a hotel room. In some embodiments, in response to detecting a change in location from an environment of low privacy to an environment of high privacy, computer system 600 increases the amount of private information displayed within user interface 602.

As illustrated in FIG. 6B, diagram 606 illustrates first user representation 610 within close proximity to computer system representation 608 (e.g., computer system 600). At FIG. 6B, computer system 600 detects user 610 in close proximity and displays more personal and/or additional information for user 610. Also illustrated in FIG. 6B, computer system 600 displays each item within to-do list widget 618 with a control because user 610 is in close proximity to computer system 600. For example, user 610 is sufficiently close to computer system 600 to interact with the content and/or widgets displayed on user interface 602 by computer system 600. In some embodiments, computer system 600 displays the control within to-do list widget 618 to allow user 610 to select the control within to-do list widget 618 to complete the to-do list item. For example, a user can select a control by touching on a display component that accepts touch input, gesturing to computer system 600 a predefined gesture (e.g., making a up and/or downwards movement within close proximity to computer system 600 to scroll up and/or down), and/or initiating a voice command that matches a predefined voice control (e.g., a user talking to computer system 600 and telling computer system 600 to check off a to-do list item).

After FIG. 6B, while within computer system 600's field of detection, the first user moves away from computer system 600, as illustrated in FIG. 6C. As illustrated in diagram 606 of the right portion of FIG. 6C, first user representation 610 is now further away from computer system representation 608 but remains within the field of detection of computer system representation 608. At FIG. 6C, computer system 600 detects the first user (e.g., user 610) move away from computer system 600.

At FIG. 6C, in response to detecting the first user moving away from computer system 600, computer system 600 stops displaying the personal and/or detailed information corresponding to the first user. In some embodiments, computer system 600 detects the first user's movement through the one or more cameras, as discussed above. For example, computer system 600 detects the first user at a first distance in relation to computer system 600, detects the first user at a second distance in relation to computer system 600, and compares the first and the second distance. In some embodiments, computer system 600 detects movement of the first user through the connectivity of one or more devices held and/or worn by the first user. For example, computer system 600 detecting a change in connection strength between computer system 600 and a device corresponding to the first user. Also, in response to the first user remaining within the field of detection of computer system 600, computer system 600 continues to display one or more widgets containing generalized content corresponding to the first user.

At FIG. 6C, computer system 600 no longer displays interactive and/or personalized content due to the first user lack of proximity. In this example, the control corresponding to each item within to-do list widget 618 because the first user is no longer in close proximity to computer system 600. For example, the first user is not close enough to computer system 600 to check off an item within the to-do list. As illustrated in FIG. 6C, also in response to detecting the first user moving away, computer system 600 stops displaying fitness widget 620. In this example, computer system 600 no longer displays fitness widget 620 because fitness widget 620 includes personal and/or detailed information corresponding to the first user. In some embodiments, computer system 600 continues to display fitness widget 620 but displays only general information within fitness widget 620. For example, computer system 600 displays that fitness widget 620 includes content such as step count and/or heart rate but does not display the step count and/or heart rate that corresponds to the first user. In some embodiments, computer system 600 ceases displaying fitness widget 620 and displays to-do list widget 618 with less information, even if computer system 600 does not detect the first user moving away from computer system 600 (e.g., the first user remains within a close proximity to computer system 600), as a result of computer system 600 detecting another user within the field of detection.

At FIG. 6C, in some embodiments, computer system 600 detecting the first user moving away from computer system 600 is part of one or more criteria that computer system 600 determines based on the context of the environment. For example, computer system 600 considers its location, identified user and/or unidentified user present, device capabilities, device settings, and/or environment conditions (e.g., brightness of the environment, noise level, and/or connectivity). In some embodiments, computer system 600 stops displaying certain content because the first user moves from a private location to a location of a lower level of privacy. For example, moving from close to the device (e.g., location of user 610 at FIG. 6B) to a more distant and less private location (e.g., location of user 610 at FIG. 6C). In some embodiments, the second area is an area of greater privacy, and computer system 600 continues to display the one or more widgets that correspond to the first user and/or displays additional content corresponding to the first user. In some embodiments, computer system 600 is moved from a private location to a location of a lower level of privacy, and computer system 600 no longer display personal and/or detailed information. For example, a user moving computer system 600 from the user's home to a public place (e.g., a hotel room, a workplace, and/or a school room). In some embodiments, privacy level is determined by the device through the context of the environment. In some embodiments, a user sets the privacy level and/or the content to be displayed depending on the location.

As illustrated in FIG. 6C, user interface 602 includes clock widget 604, to-do list widget 618, and first user indication 616. In some embodiments, first user indication 616 increases or decreases in size based on the proximity of the first user to computer system 600 (e.g., close and/or non-close proximity of first user representation 610 to computer system representation 608). In some embodiments, computer system 600 continues to display first user indication 616 at a fixed position in relation to user interface 602 irrespective of computer system 600 repositioning and/or resizing the one or more other widgets in user interface 602. As illustrated in FIG. 6C, computer system 600 repositions and/or resizes to-do list widget 618 and clock widget 604 to take up the space previously occupied by fitness widget 620 as illustrated in FIG. 6B. Also illustrated in FIG. 6C, in response to detecting the first user moving away from computer system 600, computer system 600 displays to-do list widget 618 only including general information that the list has “two items” rather than the detailed information of “cook” and “clean” as illustrated in FIG. 6B. At FIG. 6C, computer system resizes clock widget 604 user interface 602, but does not return clock widget 604 to its original size (e.g., as illustrated in FIG. 6A) as computer system 600 still detects user 610 within its field of detection. Also illustrated in FIG. 6C, computer system 600 continues to display clock widget 604 as in FIG. 6B even though computer system 600 has altered other widgets (e.g., to-do list widget 618 and/or fitness widget 620).

After FIG. 6C, the first user moves away (e.g., too far away for computer system 600's one or more cameras to detect) and/or out of the field of detection of computer system 600. After FIG. 6C, computer system 600 no longer detects the first user. As well, as illustrated in diagram 606 in FIG. 6D, second user representation 612 and/or third user representation 614 are not within computer system representation 608's field of detection. As a result, the first user and/or any user (e.g., the second user and/or the third user) is no longer detected by computer system 600 within the field of detection of computer system 600. At FIG. 6D, computer system 600 does not detect any users within the field of detection for a predetermined period of time.

At FIG. 6D, in response to not detecting the first user and/or any user (e.g., the second user and/or the third user) within the field of detection for a predetermined period of time, computer system 600 changes to an inactive state. In this example, changing to an inactive state is illustrated by visual changes to user interface 602. In this example, these visual changes include computer system 600 resizing clock widget 604 to its original maximized size and returning clock widget 604 to its original location as illustrated in FIG. 6A; computer system 600 no longer displaying widget(s) that correspond to the first user (e.g., to-do list widget 618 and/or fitness widget 620) and no longer displaying first user indication 616; and computer system 600 dimming user interface 602. In some embodiments, computer system 600 replaces existing widgets with common widgets in response to no longer detecting a user. For example, replacing to-do list widget 618 with a weather widget but continuing to display the widget at the same location. In some embodiments, computer system 600 delays changing to an inactive state for a predefined amount of time. For example, waiting 10 seconds after no longer detecting a user. In some embodiments, becoming inactive dims user interface 602 completely instead of partial dimming as illustrated in FIG. 6D. In some embodiments, computer system 600 returns to previous brightness levels upon detecting a user while in an inactive state. In some embodiments, computer system 600 restores displayed content upon detecting a user. For example, redisplaying content that corresponded to the most recently detected user when that user is detected.

After FIG. 6D, computer system 600 detects one or more users within the environment. After FIG. 6D, in response to detecting one or more users within the environment, computer system 600 changes from an inactive state to an active state. After FIG. 6D, in response to detecting one or more users within the environment, computer system 600 rotates a portion of computer system 600 until at least one user is detected within the field of detection. As illustrated in diagram 606 in the right portion of FIG. 6E, computer system representation 608's field of detection now contains multiple users (second user representation 612 and/or third user representation 614). As a result, computer system 600 detects two users (e.g., the second user and/or the third user) within its field of detection.

FIGS. 6E-6H illustrate exemplary user interfaces for displaying content based on the presence of multiple users within an environment in accordance with some embodiments.

At FIG. 6E, in response to detecting multiple users (e.g., the second user and/or the third user) within the field of detection, computer system 600 determines the content to display on user interface 602 depending on the context surrounding the multiple users. In this example, diagram 606 of FIG. 6E illustrates the context of the multiple users. As illustrated in FIG. 6E, diagram 606 includes second user representation 612 and third user representation 614 within the field of detection of computer system representation 608 and second user representation 612 in closer proximity to computer system representation 608 than third user representation 614.

At FIG. 6E, computer system 600 detects that the second user and the third user are within the field of detection of computer system 600 and are at different proximities to computer system 600 (e.g., represented by computer system representation 608 within diagram 606). In response to detecting the users are at different proximities to computer system 600, FIG. 6E illustrates second user indication 622 and third user indication 624 at different sizes. In this example, the second user and the third user are known to computer system 600. As illustrated in FIG. 6E, second user indication 622 corresponds to David Allen (e.g., the second user) and includes text “DA” corresponding to David Allen. As illustrated in FIG. 6E, computer system 600 displays second user indication 622 as larger than third user indication 624 because the second user is in closer proximity to computer system 600 than the third user. As illustrated in FIG. 6E, third user indication 624 corresponds to Annette Allen (e.g., the third user) and includes text “AA.” As illustrated in FIG. 6E, computer system 600 displays third user indication 624 as smaller than second user indication 622 because the third user is farther away from computer system 600 than the second user. In some embodiments, the text within second user indication 622 and/or third user indication 624 is replaced by a photo, symbol, and/or representation corresponding to the user that the user indication represents. In some embodiments, the included text and/or representation is automatically populated by computer system 600 through connecting with a user's personal device (e.g., a device held and/or worn by the user that contains the user's personal information and/or preferences). For example, computer system 600 connecting to a device held by David and retrieving the text “DA” from the device and populating the text into second user indication 622. In some embodiments, computer system 600 displays one or more user indications at a predefined area and maintains displaying the user identifications in the predefined area. For example, continually displaying the one or more user identifications at the top and/or middle of user interface 602 to allow a user to quickly identify that the device detects them.

At FIG. 6E, in this example, to-do list widget 618 corresponds to the second user due to David's (e.g., second user representation 612) proximity to computer system 600. In this example, computer system 600 automatically displays the content corresponding to David without requiring input. In some embodiments, computer system 600 automatically displays content based on the detected context within diagram 606. For example, in response to computer system 600 detecting that it is located in the kitchen and that the current time is in the evening, computer system 600 can display David and/or Annette's dinner recipe content (e.g., displaying content that is routinely viewed and/or accessed in the kitchen). At FIG. 6E, David is in close proximity to computer system 600 and computer system 600 displays detailed information in the widget(s) that correspond to the second user. As illustrated in FIG. 6E, the to-do list widget includes content “run” and “groceries” for David. Also, at FIG. 6E, widget 620, as illustrated in FIG. 6E as a blank widget, is a widget that corresponds to David (e.g., second user representation 612) and/or Annette (e.g., third user representation 614). In some embodiments, widget 620a displays content for both David and Annette because they are within the same group of users. For example, David and Annette are within the same family group and/or partner group. In some embodiments, widget 620a is similar to to-do list widget 618 and corresponds to the closer of the multiple users. In some embodiments, widget 620a corresponds to Annette and represents a different application than to-do list widget 618. For example, computer system 600 displaying navigational content within widget 620a for Annette's commute to work.

Also, at FIG. 6E, in response to detecting multiple users within the field of detection of computer system 600 within the environment, computer system 600 displays content corresponding to the multiple users depending on the relationship between the users. For example, identified users connecting their accounts together for being a part of the same family and/or friend group. For example, Annette (e.g., third user representation 614 and/or third user indication 624) and David (e.g., second user representation 612 and/or second user indication 622) are married and belong to the same group due to sharing account information with each other (e.g., enabling sharing and/or adding each other to a group). In some embodiments, the multiple users are identified users but have separate relationships (e.g., don't share content with each other) and user interface 602 includes general and/or non-personalized content for the multiple users. For example, Julie (e.g., the first user) is David and Annette's daughter but does not see her parent's content as her parents do not share content with Julie. In this example, the multiple users (e.g., the second user and/or the third user) are identified users and are within the same group of users, enabling computer system 600 to include additional detailed and/or personalized content for a user and/or the multiple users within user interface 602. For example, as discussed below in FIG. 6E-6F both David (e.g., the second user) and Annette (e.g., the third user) can view each other's corresponding to-do list widget 618.

As illustrated in FIG. 6E, in response to detection of the multiple users within the field of detection of computer system 600 within the environment, computer system 600 displays content corresponding to both users. In this example, FIG. 6E illustrates clock widget 604, to-do list widget 618 that corresponds to David (e.g., second user representation 612), widget 620a that corresponds to David (e.g., second user representation 612) and/or Annette (e.g., third user representation 614), and user indications 622 and 624. At FIG. 6E, computer system 600 displays clock widget 604 centrally on user interface 602 but at a reduced size, as compared to FIG. 6D, to accommodate to-do list widget 618, widget 620a, and/or user indications 622 and 624. In some embodiments, computer system 600 displays the widgets (e.g., to-do list widget 618 and/or widget 620a) at different sizes corresponding to their relevance. In some embodiments, content and/or widget relevance can correspond to different users, different locations, and/or device conditions. For example, computer system 600 displaying navigational content within widget 620a in the morning to show increased traffic to a detected user. At FIG. 6E, the second user moves away from computer system 600 but remains within computer system 600's field of detection, and the third user moves towards computer system 600 and remains within computer system 600's field of detection. As a result, computer system 600 continues to detect the multiple users (e.g., the second user and/or the third user) but detects that the third user is now in closer proximity to computer system 600 than second user.

As illustrated in diagram 606 of FIG. 6F, third user representation 614 is in close proximity to computer system representation 608 and second user representation 612 is not in close proximity to computer system representation 608 (e.g., further away from computer system representation 608 than user 614). As illustrated in FIG. 6F, in response to detecting the second user moving away from computer system 600 and the third user within moving towards computer system 600 within the field of detection, computer system 600 displays content corresponding to the context of the users' positions in relation to computer system 600. Also illustrated in FIG. 6F, in response to detecting the second user no longer being in close proximity to computer system 600 and the third user being in close proximity to computer system 600, computer system 600 displays content corresponding to the context of the user's proximity in relation to computer system 600.

At FIG. 6F, computer system 600 alters the content on user interface 602 to correspond to the multiple users' positions. As illustrated in FIG. 6F, computer system 600 displays third user indication 624 larger in relation to its size in FIG. 6E and computer system 600 displays second user indication 622 smaller in relation to its size in FIG. 6E. Computer system 600 alters user indications 624 and/or 622 because of the change in Annette and David's relative position to computer system 600. In some embodiments, computer system 600 continuously displays user indication 624 and/or 622 at relative sizes. For example, as David moves away from computer system 600, computer system 600 reduces the size of second user indication 622 proportional to David's distance to computer system 600. In some embodiments, user indication 622 and/or 624 are displayed at predetermined relative sizes. For example, computer system 600 displays third user indication 624 greater than second user indication 622 due to Annette's proximity to computer system 600, rather than representing Annette's relative position to computer system 600.

At FIG. 6F, to-do list widget 618 corresponds to Annette (e.g., third user representation 614) because Annette is closer proximity to computer system 600 than David (e.g., second user representation 612). At FIG. 6F, to-do list widget 618 includes personal and/or detailed information corresponding to Annette due to Annette's close proximity to computer system 600. As discussed above, widget 620a, as illustrated in FIG. 6F as a blank widget, corresponds to the second user and/or the third user. In some embodiments, computer system 600 does not alter how widget 620a is displayed as the proximities of Annette and David to computer system 600 change. As illustrated in FIG. 6F, to-do list widget 618 includes content “eat” and “groceries” because to-do list widget 618 contains detailed content that corresponds to Annette. As illustrated in FIG. 6F, clock widget 604 remains centrally located and at a reduced size to continue to accommodate to-do list widget 618 and widget 620a.

After FIG. 6F, while computer system 600 displays content corresponding to the second user and/or the third user, an unknown user (e.g., the fourth user) (e.g., fourth user representation 630) moves within computer system 600's field of detection. As illustrated in diagram 606 of FIG. 6G, the field of detection of computer system representation 608 now contains two known users (e.g., second user representation 612 and third user representation 614) and an unknown user (e.g., fourth user representation 630). As a result, computer system 600 detects the unknown user in its field of detection, as illustrated in FIG. 6G. In some embodiments, an unknown user is a user that is in the field of detection of computer system 600 but lacks a record as a user. For example, the user does not have a local and/or remote user record, which would prevent computer system 600 from displaying content corresponding to the user. In some embodiments, an unknown user is a user that is not registered with computer system 600 (e.g., the user does not have an account, the user's biometrics are not catalogued, and/or the user does not have a login).

FIGS. 6G-6H illustrate exemplary user interfaces for displaying content based on the relationship of multiple users in accordance with some embodiments.

As illustrated in FIG. 6G, in response to detecting the unknown user in the field of detection of computer system 600, computer system 600 no longer displays content corresponding to a user and/or multiple users and displays common widgets within user interface 602. In this example, weather widget 626 and clock widget 604 correspond to common widgets.

As illustrated in FIG. 6G, user indications 624 and 622 are unchanged in size as compared to FIG. 6F but, in response to detecting the unknown user within the field of detection, computer system 600 displays unknown user indication 628 alongside user indications 624 and 622. At FIG. 6G, unknown user indication 628 contains the text “??” because computer system 600 cannot identify the unknown user. In some embodiments, text “??” is replaced with a generic symbol and/or representation of an unknown user. For example, a representation of a figure without personalized features and/or abstracted silhouette within unknown user indication 628. In this example, due to the unknown user's relative position to computer system 600, unknown user indication 628 is displayed by computer system 600 at the same size as second user indication 622. In some embodiments, unknown user indication 628 is displayed by computer system 600 at a reduced size due to the unknown user's relative position to other users within the field of detection. For example, computer system 600 displaying the user indications (e.g., user indication 622, 624, and/or 628) at different sizes based on the users' relative position (e.g., Annette is closer than David and/or unknown user 630) rather than distance and/or proximity to computer system 600.

As illustrated in FIG. 6G, computer system 600 displays user interface 602 including clock widget 604, weather widget 626, and user indications 628, 624, and 622. In comparison to FIG. 6F, computer system 600 no longer displays to-do list widget 618 and widget 620a in user interface 602 because of the presence of the unknown user. In this example, to-do list widget 618 and widget 620a include detailed and/or personalized information that computer system 600 only displays when the correct user context is met. For example, a lone user is detected and/or a group of users are detected, and the content corresponds to the user and/or the group of users respectively. As illustrated in FIG. 6G, computer system 600 repositions clock widget 604 due to no longer displaying widget 620a. Also illustrated in FIG. 6G, computer system 600 displays weather widget 626 alongside clock widget 604 due to the lack of other widgets. In some embodiments, widgets are positioned and/or sized to maximize the widgets size on user interface 602. In some embodiments, widgets are fixed in position and/or size on user interface 602. In some embodiments, even if computer system 600 is located within a private location, detecting the presence of an unknown user causes computer system 600 to no longer display detailed and/or personal information. In some embodiments, the unknown user leaves, and in response to no longer detecting the unknown user within the field of detection, computer system 600 displays user interface 602 as it was before the unknown user was detected (e.g., as illustrated in FIG. 6F).

At FIG. 6H, computer system 600 detects heavy traffic on the second user's (e.g., Annette) daily work commute. As a result, computer system 600 automatically displays navigation widget 632 that corresponds to the second user, as illustrated in the left portion of FIG. 6H. As illustrated in FIG. 6H, in response to displaying navigation widget 632, computer system 600 resizes weather widget 626 to accommodate navigation widget 632 within user interface 602. In some embodiments, computer system 600 automatically displays a widget based on an exterior criterion being met. At FIG. 6H, computer system 600 displays navigation widget 632 due to a criterion being met in relation to Annette (e.g., the second user). In this example, navigation widget 632 corresponds to Annette due to the second user's proximity to computer system 600, as illustrated in diagram 606 of FIG. 6H, as second user representation 614's position relative to computer system representation 608. In some embodiments, computer system 600 displays navigation widget 632 and weather widget 626 at respective sizes due to an amount of relevance to the second user. For example, in FIG. 6G computer system 600 displays weather widget 626 at a relatively large size, but in FIG. 6H weather widget 626 is less relevant and computer system 600 displays it at a reduced size. Also in some embodiments, computer system 600 displays widgets irrespective to the current relevance and/or context of the environment. For example, clock widget 604 remains a constant size, while computer system 600 displays weather widget 626 and/or navigation widget 632 at different sizes based on relevance, context of the environment, and/or user presence. In some embodiments, computer system 600 alters the size of the displayed widgets due to identified users and/or unidentified users being detected. For example, reducing the size of a calendar widget when an unidentified user and/or identified user is detected. As illustrated in FIG. 6H, navigation widget 632 includes “Heavy Traffic” corresponding to high level of traffic to Annette's work. In addition, navigation widget 632 is not sensitive content corresponding to Annette and can be displayed with David (e.g., the second user) and the unknown user within the field of detection. In some embodiments, the displayed widget corresponds to a group of users. For example, a navigation widget that displays information about the group of users' carpool commute. In some embodiments, the displayed widget does not correspond to any user but is automatically displayed due to the context of the environment. For example, a severe weather warning for the area. At FIG. 6H, computer system 600 displays navigation widget 632 and is in communication with one or more input devices (e.g., touch sensitive display component, depth and/or proximity sensors, and/or voice communication component).

FIGS. 6I-6J illustrate exemplary user interfaces for displaying content based on a user interacting with a computer system in accordance with some embodiments.

As illustrated in FIG. 6I, the third user's hand is (1) in close proximity to the display component of computer system 600 and (2) directed at navigation widget 632. As a result, computer system 600 detects a potential input (e.g., the third user's hand (e.g., represented by hand and extended finger 634)). At FIG. 6I, computer system 600 detects the third user's hand within a first predetermined distance and outside a second predetermined distance. At FIG. 6I, in response to detecting a potential input from a user and detecting the third user's hand within the first predetermined distance, computer system 600 increases the size of the widget within user interface 602 that is at the location corresponding to the detected potential input. As illustrated in FIG. 6I, in response to detecting a potential input from a user and detecting the third user's hand within the first predetermined distance, computer system 600 displays navigation widget 632 at an increased size in relation to its previous size in FIG. 6H. In some embodiments, computer system 600 displays a widget at an increased size due to receiving an input rather than detecting a potential input. In some embodiments, in response to detecting an input and/or potential input directed to a widget, computer system 600 alters the content displayed within the widget. For example, displaying more detailed and/or personal information for a user upon detecting an input and/or potential input directed to a widget that corresponds to the particular user. As illustrated in FIG. 6I, computer system 600 decreases the size of weather widget 626 in relation to its previous size in FIG. 6H to accommodate for the increased size of navigation widget 632. Also illustrated in FIG. 6I, computer system 600 reduces the content within weather widget 626 to match the decreased size, changing from “New York 70” to “70.” In some embodiments, a widget that is reduced in size displays generalized content rather than a subset of the original content. For example, a to-do list widget displaying the number of items rather than a reduced size version of the to-do list. In some embodiments, in response to detecting a potential input from a user and detecting the third user's hand within the first predetermined distance, computer system 600 moves a portion of computer system 600 to make it easier and/or more comfortable for the user to interact with computer system 600. For example, computer system 600 can tilt the display generation back to a particular angle as the third user's hand gets closer to the display component. At FIG. 6I, while displaying navigation widget 632 at the increased size, computer system 600 detects an input through one or more input devices from the third user's hand (e.g., represented by hand and extended finger 634) that is directed to a location corresponding to navigation widget 632.

As illustrated in FIG. 6J, in response to detecting an input directed to a location corresponding to navigation widget 632, computer system 600 no longer displays user interface 602 and displays navigation user interface 636. In this example, navigation user interface 636 is an application user interface for a navigation application that corresponds to navigation widget 632. As illustrated in FIG. 6J, navigation user interface 636 displays navigational content. In this example, the navigational content within navigation user interface 636 corresponds to Annette (e.g., the third user) because Annette is a known user and is in close proximity to computer system 600, as illustrated in diagram 606 as third user representation 614 is in close proximity to computer system representation 608. In some embodiments, the navigational content within navigation user interface 636 corresponds to Annette because navigation widget 632 corresponds (e.g., in FIG. 6I) to Annette. In some embodiments, the navigation content within navigation user interface 636 corresponds to a user (e.g., user 612, user 614, and/or user 630) based on relevance to the user, rather than based on relative position. For example, navigation content within navigation user interface 636 corresponding to David (e.g., user 612) due to anticipated heavy traffic on David's commute to work. As part of the content for Annette, FIG. 6J illustrates a user interface object corresponding to Annette's work location. In this example, at FIG. 6J, the user interface object corresponding to Annette's work location allows Annette to select a route to work without inputting an address.

At FIG. 6J, user representations 612, 614, and 630 remain in the relative positions as illustrated in FIGS. 6F-6I. As illustrated in FIG. 6J, user indications 622, 624, and 628 remain displayed on top of the one or more user interfaces (e.g., user interface 636 and/or user interface 602) displayed on computer system 600. Also, as illustrated in FIG. 6J, computer system 600 displays user indications 622, 624, and 628 with the same visual characteristics (e.g., size and/or position) as discussed above in FIGS. 6G-6I. In some embodiments, computer system 600 no longer displays user indications 622, 624, and/or 628 while displaying an application user interface. In some embodiments, computer system 600 displaying the user indication (e.g., user indication 624) that corresponds to the application user interface and/or the user (e.g., user 614) that corresponds to the input detected by computer system 600. For example, only displaying user indication 624 because it represents Annette, and the navigation content corresponds to Annette.

FIG. 7 is a flow diagram illustrating a method for displaying content in a widget based on a user's distance using a computer system in accordance with some embodiments. Process 700 is performed at a computer system (e.g., 100, 200, and/or 600). Some operations in process 700 are, optionally, combined, the orders of some operations are, optionally, changed, and some operations are, optionally, omitted.

As described below, process 700 provides an intuitive way for displaying content in a widget based on a user's distance. The method reduces the cognitive burden on a user for displaying content in a widget based on a user's distance, thereby creating a more efficient human-machine interface. For battery operated computing devices, enabling a user to display content in a widget based on a user's distance faster and more efficiently conserves power and increases the time between battery charges.

In some embodiments, process 700 is performed at a computer system (e.g., 600) that is in communication with one or more input devices (e.g., a touch-sensitive surface, an input mechanism (e.g., a physical input mechanism, such as a button and/or a rotational input mechanism), a camera, a depth sensor, and/or a microphone) and a display component (e.g., left portion of FIGS. 6A-6J) (e.g., a display screen and/or a touch-sensitive display). In some embodiments, the computer system is a watch, a phone, a tablet, a processor, a head-mounted display (HMD) device, a communal device, a media device, a speaker, a television, and/or a personal computing device.

The computer system detects (702), via the one or more input devices, a first user (e.g., 610, 612, and/or 614) (e.g., a first person, a first animal, and/or a first object) (e.g., a location of the first user) in an environment (e.g., 606 at FIGS. 6A-6J) (e.g., a physical, virtual, and/or mixed-reality environment) (and/or in a first area in the environment) (e.g., in a field of view of the one or more input devices). In some embodiments, detecting the first user includes detecting a location and/or an identity of the first user. In some embodiments, the first user is detected via a communication and/or message (e.g., indicating presence of the first user) received from another computer system (e.g., different from the computer system) corresponding to the first user.

In response to detecting the first user in the environment, the computer system displays (704), via the display component, a first user interface (e.g., 602) that includes a first widget (e.g., 604, 618, and/or 620), wherein displaying the first widget (e.g., in response to detecting the first user in the environment) includes: (706) in accordance with a determination that the first user is within a first distance (e.g., location of 610 at FIG. 6B) (e.g., of the computer system, of an object, of another user, and/or of an input device of the one or more input devices) (e.g., a predefined distance) (e.g., 0-5 feet), displaying, via the display component, first content (e.g., 604, 618, and/or 620 at FIG. 6B) at a location in the first widget (e.g., location of 604, 618, and/or 620 at FIG. 6B); and in accordance with (708) a determination that the first user is within a second distance (e.g., location of 610 at FIG. 6C) (e.g., of the computer system, of an object, of another user, and/or of an input device of the one or more input devices) (and/or not within the first distance) (and/or also within the second distance) (e.g., a predefined distance) (e.g., 5-10 feet) different from the first distance, displaying, via the display component, second content (e.g., 604, 618, and/or 620 at FIG. 6C) at the location in the first widget (e.g., without displaying the first content and/or without displaying the first content at the location in the first widget), wherein the second content is different from the first content (e.g., as discussed above at FIGS. 6B-6C). In some embodiments, the first content corresponds to the first user. In some embodiments, the first user interface is a system user interface of the computer system that includes display of a plurality of different widgets corresponding to different applications. In some embodiments, the first user interface corresponds to an application. In some embodiments, the application corresponds to the first widget. In some embodiments, the second content corresponds to the first user. In some embodiments, the second content does not correspond to the first user. In some embodiments, the second content includes a portion of the first content, where the first content includes another portion different from the portion of the first content. In some embodiments, the first content includes a portion (e.g., a representation of media being output by the computer system) of the second content, where the second content includes another portion different from the portion of the second content. In some embodiments, the first content includes a portion of content (e.g., a pause button) that is not included in the second content. In some embodiments, the second content includes a portion of content (e.g., an indication that the first user should get closer to interact with the computer system) that is not included in the first content. In some embodiments, the first content is displayed at the location in the first widget without displaying the second content (e.g., at the location in the first widget). Displaying different content when a user is detected within different distances from a computer system allows the computer system to automatically transition between different types of content based on the distance of the user, thereby performing an operation when a set of conditions has been met without requiring further input and increasing privacy.

In some embodiments, the second distance (e.g., location of 610 at FIG. 6C) is greater than the first distance (e.g., location of 610 at FIG. 6B). In some embodiments, the first content includes a control (e.g., small circles within 618 at FIG. 6B) (e.g., user-interface control, content control user interface object, user interface object, and/or content control) (e.g., displaying the first content includes displaying the control). In some embodiments, the second content does not include the control (e.g., lack of small circles within 618 at FIG. 6B). In some embodiments, the control is not displayed in accordance with a determination that the first user is greater than a third distance (e.g., the same or different from the first distance and/or the second distance) (e.g., from the computer system and/or an input device of the one or more input devices) (e.g., a predefined distance) (e.g., 5-10 feet, greater than 5 feet, and/or greater than 10 feet). In some embodiments, the control corresponds to the first widget. In some embodiments, while displaying the control, the computer system detects that the first user is not greater than the third distance (e.g., from the computer system and/or an input device of the one or more input devices). In some embodiments, in response to detecting that the first user is not greater than the third distance, the computer system ceases displaying the control. In some embodiments, the computer system performs a set of one or more operations (e.g., perform one or more operations on a file, perform one or more operations on displayed and/or not displayed information, and/or perform one or more operations to communicate with another computer system) in response to detecting an input directed to the control. Displaying a control and content when a user is within a first distance to a computer system but not displaying the control when the user is outside of the first distance provides the user with the ability to automatically transition between different types of content based on the distance of the user, thereby performing an operation when a set of conditions has been met without requiring further input and providing increased privacy.

In some embodiments, the second distance (e.g., location of 610 at FIG. 6C) is greater than the first distance (e.g., location of 610 at FIG. 6B). In some embodiments, the first content (e.g., 604, 618, and/or 620 at FIG. 6B) includes third content that has a heightened privacy level (e.g., as described above at FIGS. 6B-6E) (e.g., higher privacy level and/or increased privacy level) and corresponds to (e.g., related to, associated with, relates to, and/or connected to) the first user. In some embodiments, the second content (e.g., 604, 618, and/or 620 at FIG. 6C) does not include the third content that has the heightened privacy level (e.g., as described above at FIGS. 6B-6E). In some embodiments, the third content that has the higher level of privacy controls is personal and/or private content for the first user (e.g., health information, financial information, and/or detailed calendar information). In some embodiments, the third content is (e.g., the entirety of) the first content. In some embodiments, the third content is different from the first content. In some embodiments, the third content includes the first content. In some embodiments, the first content includes the third content. In some embodiments, the third content is additional content displayed alongside (e.g., with and/or near) the first content. In some embodiments, the third content is additional user specific content from the first content. In some embodiments, the third content is unrelated to the first content. In some embodiments, after (and/or while) displaying the third content, the computer system detects that the first user is no longer (and/or detecting the absence of the first user) (and/or no longer detecting the first user) within the first distance (and/or in the environment) (and/or a predefined distance) and ceases displaying the third content. In some embodiments, the computer system detects the first user is no longer within the first distance (and/or the second distance) (and/or the environment) by ceasing detecting the one or more inputs that detected the first user. Displaying content with a higher level of privacy controls when a user is within a predefined distance to a computer system and forgoing displaying the content with the higher level of privacy controls when outside of the predefined distance to the computer system allows the computer system to automatically transition between content of varying privacy levels based on the distance of the user, thereby performing an operation when a set of conditions has been met without requiring further input and increasing privacy.

In some embodiments, while displaying the first content (e.g., 604, 618, and/or 620 at FIG. 6B) (e.g., at the location in the first widget) (and/or while determining that the first user is within the first distance) (and/or while determining that the first user is within the second distance), the computer system detects, via the one or more input devices, a second user (e.g., 612, 614, and/or 630), different from the first user (e.g., 610, 612, and/or 614), in the environment (e.g., 606 at FIGS. 6A-6J) (e.g., in a field of view of the one or more input devices) (e.g., within the first distance and/or within the second distance). In some embodiments, detecting the second user includes detecting a location and/or an identity of the second user. In some embodiments, the second user is detected via a communication and/or a message (e.g., indicating presence of the second user) received from another computer system (e.g., different from the computer system) corresponding to the second user. In some embodiments, in response to detecting the second user in the environment (and/or while continuing to detect the first user in the environment) (and/or in accordance with a determination that the first user is within the first distance), the computer system ceases displaying, via the display component, the first content (e.g., 604 and/or 626 at FIG. 6G) (e.g., at the location in the first widget). In some embodiments, in response to detecting the second user in the environment (and/or while continuing to detect the first user in the environment) (and/or in accordance with a determination that the first user is within the first distance), the computer system ceases displaying the second content. In some embodiments, in response to detecting the second user in the environment (and/or while continuing to detect the first user in the environment) (and/or in accordance with a determination that the first user is within the first distance), the computer system displays, via the display component, generic content. In some embodiments, in response to detecting the second user in the environment (and/or while continuing to detect the first user in the environment) (and/or in accordance with a determination that the first user is within the first distance), the computer system displays the second content at the location in the first widget. In some embodiments, in response to detecting the second user in the environment (and/or while continuing to detect the first user in the environment) (and/or in accordance with a determination that the first user is within the first distance), the computer system displays content different from the first content and/or the second content. Ceasing displaying content in response to detecting an additional user within an environment allows a computer system to automatically transition between private and non-private content based on the detection of the additional users within the environment, thereby performing an operation when a set of conditions has been met without requiring further input and increasing privacy.

In some embodiments, after (and/or while) detecting the second user (e.g., 612, 614, and/or 630) in the environment (e.g., 606 at FIGS. 6A-6J), the computer system detects that the first user (e.g., 610, 612, and/or 614) is no longer (e.g., detects the absence of the first user and/or no longer detects the first user) in the environment (and/or in the first area in the environment). In some embodiments, in response to detecting that the first user is no longer in the environment (e.g., lack of 610 at FIG. 6D) and while detecting the second user in the environment (e.g., 612 and/or 614 at FIG. 6D), the computer system displays, via the display component, fourth content (e.g., 604, 618, 620, and/or 626) (e.g., personal, specific, and/or private content) corresponding to the second user (e.g., and not corresponding to the first user). In some embodiments, the fourth content corresponding to the second user is different from content corresponding to the first user. In some embodiments, the fourth content is displayed at the location in the first widget. In some embodiments, the fourth content is the second content. In some embodiments, the fourth content is different than the second content and/or the first content. In some embodiments, after detecting the second user in the environment (and/or while displaying the fourth content) (and/or the first user is no longer in the environment), the computer system detects, via the one or more input devices, that the second user is no longer in the environment. In some embodiments, in response to detecting that the second user is no longer in the environment (e.g., after and/or while detecting that the first user is no longer in the environment), the computer system displays, via the display component, the second content (e.g., 604, 618, and/or 620 at FIG. 6C) at the location in the first widget. In some embodiments, the second content corresponds to the first user. In some embodiments, the second content does not correspond to the first user. In some embodiments, the second content includes a portion of the first content. In some embodiments, the second content corresponds to the second user. In some embodiments, the second content does not correspond to the second user. In some embodiments, the second content includes a portion of the fourth content. In some embodiments, after detecting the second user in the environment, the computer system ceases to display the fourth content corresponding to the user. Displaying different content based on detection of different users in an environment allows a computer system to display respective private and/or non-private content for different users without requiring the user's input and allows the computer system to transition between the content for the users and other content based on no longer detecting a user in the environment, thereby performing an operation when a set of conditions has been met without requiring further input and increasing privacy.

In some embodiments, displaying the first widget (e.g., 604, 618, and/or 620) includes: in accordance with a determination that the first user is within the first distance, displaying fifth content (e.g., 604, 618, and/or 620 at FIG. 6B); and in accordance with a determination that the first user is within the second distance, displaying the fifth content (e.g., 604 and/or 618 at FIG. 6C). In some embodiments, the computer system displays the fifth content while displaying the first content and/or the second content. In some embodiments, the computer system displays the fifth content in response to detecting the first user within the first distance and/or the second distance. In some embodiments, the location in the first widget is a first location. In some embodiments, the fifth content is displayed at a second location in the first widget. In some embodiments, the second location is different from the first location. In some embodiments, the fifth content is displayed alongside and/or concurrently with the first content and/or the second content. Displaying content irrespective of a user's distance from a computer system allows the computer system to continuously display relevant content to the user and provides the user with feedback about the state of the device regardless on the user's distance to the computer system, thereby reducing the number of inputs needed to perform an operation and providing improved visual feedback to the user.

In some embodiments, the first widget corresponds to a first application (e.g., as discussed above at FIGS. 6A-6C). In some embodiments, displaying the first user interface (e.g., 602) that includes the first widget (e.g., 604, 618, and/or 620) includes displaying, via the display component, a second widget (e.g., 604, 618, and/or 620) corresponding to a second application (e.g., as discussed above at FIGS. 6A-6C) different from the first application. In some embodiments, the first application and the second application are different types of applications. In some embodiments, the first application and/or the second application are a system application. In some embodiments, one application (e.g., the first application or the second application) is a system-based application and one application (e.g., the first application or the second application) is a third-party application. Displaying content from an application and a widget corresponding to another application provides a user additional control within the user interface without losing the ability to view the content from the application, thereby reducing the number of inputs needed to perform an operation and providing additional control operations without cluttering the user interface with additional displayed controls.

In some embodiments, displaying the second widget (e.g., 604, 618, and/or 620) includes: in accordance with a determination that the first user is within the first distance (e.g., location of 610 at FIG. 6B) (e.g., of the computer system, of an object, of another user, and/or of an input device of the one or more input devices) (e.g., a predefined distance) (e.g., 0-5 feet), displaying sixth content (e.g., 604, 618, and/or 620) at a location in the second widget (e.g., location of 604, 618, and/or 620 at FIG. 6B); and in accordance with a determination that the first user is within the second distance (e.g., location of 610 at FIG. 6C) (e.g., of the computer system, of an object, of another user, and/or of an input device of the one or more input devices) (and/or not within the first distance) (and/or also within the second distance) (e.g., a predefined distance) (e.g., 5-10 feet), displaying the sixth content at the location in the second widget. In some embodiments, displaying the second widget includes displaying the sixth content at the location in the second widget. Displaying a widget irrespective of a user's distance from a computer system allows the computer system to continuously display the relevant widget to the user and provides the user with feedback about the state of the device regardless on the user's distance to the computer system, thereby reducing the number of inputs needed to perform an operation and providing improved visual feedback to the user.

In some embodiments, the computer system detects, via the one or more input devices, a first absence of the first user (e.g., lack of 610 at FIGS. 6A and/or 6C) (and/or no longer detecting the presence of the first user) in the environment (e.g., 606 at FIGS. 6A-6J) (and/or in the first area and/or the second area of the environment) (and/or that the first user is no longer in the environment). In some embodiments, in response to detecting the first absence of the first user in the environment, the computer system displays, via the display component, the first user interface that includes the first widget including seventh content (e.g., 610, 612, and/or 614) at a location in the first widget (e.g., location of 604, 618, and/or 620), wherein the seventh content is different from the first content (e.g., 604, 618, and/or 620) and the second content (e.g., 604, 618, and/or 620). In some embodiments, the seventh content is displayed at the location in the first widget. In some embodiments, the seventh content is displayed alongside and/or concurrently displayed with the first content and/or second content. In some embodiments, the seventh content is displayed irrespective of detecting a user (e.g., displayed continuously regardless of detected user). Displaying content while not detecting a user allows the computer system to automatically display generalized content for a perspective user without performing a determination on the perspective user, thereby performing an operation when a set of conditions has been met without requiring further input.

In some embodiments, the computer system detects, via the one or more input devices, a second absence of the first user (e.g., lack of 610 at FIGS. 6A and/or 6C) (and/or no longer detecting the presence of the first user) in the environment (e.g., 606 at FIGS. 6A-6J) (and/or in the first area and/or the second area of the environment). In some embodiments, in response to detecting the second absence of the first user in the environment, the computer system displays, via the display component, the first user interface (e.g., 602) that includes the first widget including the second content (e.g., 604, 618, and/or 620) (e.g., at the location in the first widget or at another location in the first widget different from the location). In some embodiments, the second content is displayed regardless of detecting and/or not detecting a user. Displaying content based on detecting the absence of a user within an environment allows a computer system to automatically transition to generalized content without an input from a user and allows the computer system to display relevant content to users that will potentially use the computer system, thereby performing an operation when a set of conditions has been met without requiring further input.

In some embodiments, while detecting the first user (e.g., 610, 612, 614, and/or 630) (and/or while determining that the first user is within the first distance) (and/or while determining that the first user is within the second distance), the computer system detects, via the one or more input devices, a third user (e.g., 610, 612, 614, and/or 630), different from the first user, in the environment (e.g., 606 at FIGS. 6A-6J) (e.g., in a field of view of the one or more input devices) (e.g., within the first distance and/or within the second distance). In some embodiments, in response to detecting the third user within the environment, the computer system displays, via the display component, the first user interface (e.g., 602) that includes the first widget (e.g., 604, 618, and/or 620), wherein displaying the first widget includes displaying eighth content (e.g., different from the first content and/or the second content) at a location in the first widget (e.g., location of 604, 618, and/or 620). In some embodiments, the eighth content corresponds to one and/or both of the users. In some embodiments, the eighth content is displayed when, while, after, and/or in response to more than one user being detected. Displaying different content based on detecting multiple users allows a computer system to display relevant content to the multiple users without detecting an input from one or more of the multiple users, thereby performing an operation without requiring further input.

In some embodiments, the computer system displays, via the display component, the first content (e.g., 604, 618, and/or 620) (and/or the second content (e.g., at the location in the first widget)) detecting, via the one or more input devices, a third absence of the first user in the environment (e.g., lack of 610 at FIGS. FIG. 6A and/or 6C) (e.g., within the first distance and/or within the second distance) for a predetermined amount of time (e.g., as discussed above at FIGS. 6A-6C) (e.g., 0.1-120 minutes). In some embodiments, in response to detecting the third absence of the first user within the environment, the computer system ceases displaying, via the display component, the first content (and/or the second content). In some embodiments, in accordance with a determination that a user has not been detected in the environment for a predefined (e.g., predetermined and/or preset) amount of time (e.g., time frame set within settings and/or a default time frame), the computer system ceases displaying, via the display component, the first content (and/or the second content) (e.g., at the location in the first widget). In some embodiments, ceasing displaying the respective content includes ceasing displaying the first widget. In some embodiments, ceasing displaying the respective content includes ceasing displaying any and/or most content (e.g., no longer displaying content). Ceasing displaying content after a predetermined amount of time of not detecting a user allows a computer system to automatically transition between displaying content and no longer displaying content without input from the user, thereby performing an operation without requiring additional user input and allowing the computer system to avoid burn-in of the display component.

In some embodiments, in response to detecting the first user (e.g., 610, 612, and/or 614) in the environment (e.g., 602), the computer system transitions from the inactive state (e.g., 602 at FIG. 6D) (e.g., a lower processing state, an idle state, and/or a lower power state) (e.g., when (e.g., while, before, after, and/or at the time of) detecting the first user in the environment) to an active state (e.g., 602 at FIGS. 6A-6C) (e.g., a higher processing state than the inactive state, a non-idle state, a higher power state than the inactive state, and/or a full power state) different from the inactive state. In some embodiments, the computer system does not display content when in the idle state. In some embodiments, the computer system displays content when in the active state. In some embodiments, the computer system displays content at a lower brightness when in the idle state than when in the active state. Transition between an inactive state and an active state upon detecting a user allows the computer system to automatically display relevant content without requiring input from the user and allows the user to view content without providing input to the inactive computer system, thereby performing an operation without requiring additional user input and providing feedback.

In some embodiments, while (or after) displaying the second content (e.g., 604, 618, and/or 620) (e.g., at the location in the first widget), the computer system detects, via the one or more input devices, the first user (e.g., 610, 612, and/or 614) within the first distance (e.g., location of 610 at FIG. 6B) (e.g., the first user moving from the second distance to the first distance (e.g., 5-10 feet to 0-5 feet)). In some embodiments, in response to detecting the first user within the first distance (e.g., the first user moving from the second distance to the first distance (e.g., 5-10 feet to 0-5 feet)), the computer system displays, via the display component, the first content (e.g., 604, 618, and/or 620) (e.g., at the location in the first widget). In some embodiments, in response to detecting that the first user is within the first distance, the computer system ceases displaying the second content (e.g., at the location in the first widget). Displaying content upon a user moving within a predetermined distance of a computer system allows the computer system to automatically transition between non-private and private content based on the context surrounding a user, thereby performing an operation without requiring additional user input.

In some embodiments, while (or after) displaying the first content (e.g., 604, 618, and/or 620) (e.g., at the location in the first widget), the computer system detects, via the one or more input devices, the first user within the second distance (e.g., location of 610 at FIG. 6C) (e.g., the first user moving from the first distance to the second distance (e.g., 0-5 feet to 5-10 feet)). In some embodiments, in response to detecting the first user within the second distance (e.g., the first user moving from the first distance to the second distance (e.g., 0-5 feet to 5-10 feet)), the computer system displays, via the display component, the second content (e.g., 604, 618, and/or 620) (e.g., at the location in the first widget). In some embodiments, in response to detecting that the first user is within the second distance, the computer system ceases displaying the first content (e.g., at the location in the first widget). Displaying content upon a user moving outside a predetermined distance of a computer system allows the computer system to automatically transition between private and non-private content based on the context surrounding a user, thereby performing an operation without requiring additional user input.

Note that details of the processes described above with respect to process 700 (e.g., FIG. 7) are also applicable in an analogous manner to the methods described below/above. For example, process 800 optionally includes one or more of the characteristics of the various methods described above with reference to process 700. For example, the computer system can display content in a widget based on a user's distance using the techniques described in relation to process 700 and display content in a widget based on location using the techniques described in relation to process 800. For brevity, these details are not repeated below.

FIG. 8 is a flow diagram illustrating a method for displaying content in a widget based on location using a computer system in accordance with some embodiments. Process 800 is performed at a computer system (e.g., 100, 200, and/or 600). Some operations in process 800 are, optionally, combined, the orders of some operations are, optionally, changed, and some operations are, optionally, omitted.

As described below, process 800 provides an intuitive way for displaying content in a widget based on location. The method reduces the cognitive burden on a user for displaying content in a widget based on location, thereby creating a more efficient human-machine interface. For battery operated computing devices, enabling a user to display content in a widget based on location faster and more efficiently conserves power and increases the time between battery charges.

In some embodiments, process 800 is performed at a computer system (e.g., 600) that is in communication with one or more input devices (e.g., a camera, a depth sensor, and/or a microphone), and a display component (e.g., left portion of FIGS. 6A-6J) (e.g., a display screen and/or a touch-sensitive display). In some embodiments, the computer system is a watch, a phone, a tablet, a processor, a head-mounted display (HMD) device, a communal device, a media device, a speaker, a television, and/or a personal computing device.

The computer system detects (802), via the one or more input devices, a first user (e.g., 610, 612, 614, and/or 630) (e.g., user, person, animal, and/or object) in a physical environment (e.g., 606 at FIGS. 6A-6J).

While (804) detecting the first user in the physical environment, in accordance with a determination that a first set of one or more criteria is satisfied (e.g., as discussed above at FIGS. 6D-6H), wherein the first set of one or more criteria includes a criterion that is satisfied when (e.g., a determination is made that) a second user (e.g., 610, 612, 614, and/or 630) (e.g., different from the first user) is not detected in a first area (e.g., left portion of 606 at FIG. 6E-6H) (e.g., a region and/or a section) of the physical environment (and/or a region, section, and/or area of the field-of-view of one or more cameras), the computer system displays (806), via the display component, first content (e.g., 604, 618, 620, 626, and/or 632) (e.g., for a respective widget and/or in a respective widget). In some embodiments, another user is detected in a second area different from the first area of the physical environment while the computer system is displaying the first content; in other embodiments, the other user is not detected in the second area of the physical environment while the computer system is displaying the first content.

While (804) detecting the first user in the physical environment, in accordance with a determination that a second set of one or more criteria is satisfied (e.g., as discussed above at FIGS. 6D-6H), wherein the second set of one or more criteria includes a criterion that is satisfied when the second user is detected in the first area of the physical environment, the computer system displays (808), via the display component, second content (e.g., 604, 618, 620, 626, and/or 632) different from the first content (e.g., for a widget and/or in a respective widget) (e.g., without displaying the first content). In some embodiments, the first content has been deemed to be more sensitive content and/or content that requires a higher level of privacy to be viewed and/or interacted with than the second content. Displaying content based on the detection of an additional user allows a computer system to automatically transition between private content for a user and non-private content for either user, thereby performing an operation when a set of conditions has been met without requiring additional user input and increasing security.

In some embodiments, the second user (e.g., 610, 612, 614, and/or 630) is an unidentified user (e.g., as discussed above at FIGS. 6G-6H). In some embodiments, the computer system determines that the first set of one or more criteria is satisfied. In some embodiments, the first set of one or more criteria includes a criterion that is satisfied when the first user in the first area of the physical environment is an identified user (e.g., the user has a record locally and/or remotely) (e.g., a feature of the user corresponds to a known record of an identified user (e.g., a fingerprint reading, a vocal signature, and/or a facial record) (e.g., a criterion that is satisfied when a profile is obtained for the user (e.g., requesting a process to identify a user via through internal records and/or querying a remote computer system (e.g., server and/or cloud process))). In some embodiments, the first content is personalized content for the identified user. In some embodiments, the first content is sensitive content for the identified user (e.g., banking information, personal calendar information, and/or health information). In some embodiments, the computer system determines that the first set of one or more criteria is satisfied. In some embodiments, the first set of one or more criteria includes a criterion that is satisfied when the first user in the first area of the physical environment is an unidentified user (e.g., the user lacks a record locally and/or remotely) (e.g., a criterion that is satisfied when a user corresponding to (e.g., performed with respect to) the first user does not match a user known to the computer system), displaying the second content. In some embodiments, the second content is generalized content to be displayed to any user. In some embodiments, the second content is set by the user as public content to be displayed to any user. In some embodiments, the second content is system defined content to be displayed to any user (e.g., clock, weather, and/or date). In some embodiments, the second content is system defined content that is a subset of the content previously display (e.g., a general calendar without specific user's meetings and/or events.) Displaying different content based on the detection of an unidentified user allows a computer system to automatically transition between content for identified users and unidentified users, thereby performing an operation when a set of conditions has been met without requiring further input and increasing security.

In some embodiments, while detecting the first user (e.g., 610, 612, 614, and/or 630) in the physical environment (e.g., 606 at FIG. 6A). In some embodiments, in accordance with a determination that a third set of one or more criteria is satisfied (e.g., as discussed above at FIGS. 6D-6H), wherein the third set of one or more criteria includes a criterion that is satisfied when a third user (e.g., 610, 612, 614, and/or 630), different from the first user and the second user, is detected in the first area of the physical environment (e.g., left portion of 606 at FIG. 6E-6H), the computer system displays, via the display component, third content (e.g., 604, 618, 620, 626, and/or 632) different from the first content and the second content (e.g., 604, 618, 620, 626, and/or 632). In some embodiments, the computer system determines that the first set of one or more criteria is satisfied, wherein the first set of one or more criteria includes a criterion that is satisfied when the first user is a first identified user. In some embodiments, the third content corresponds to the first identified user. In some embodiments, the computer system determines that the first set of one or more criteria is satisfied, wherein the first set of one or more criteria includes a criterion that is satisfied when the first user is a second identified user, different from the first identified user. In some embodiments, the third content corresponds to the second identified user. In some embodiments, the first content and/or second content corresponds to an identified user by being content that only that user can view (e.g., financial information, health information, and/or schedule information). In some embodiments, the first content and/or second content corresponds to an identified user is generalized content that is tailored by the computer system for the specific user (e.g., name and/or basic information). In some embodiments, the first content and/or the second content corresponding to the first identified user is a first version of particular content and the first content and/or the second content corresponding to the second identified user is a different version of the particular content (e.g., a calendar app displaying different meetings for different identified users). Displaying different content based on the identification of a user allows a computer system to automatically transition between relevant content for different identified users, thereby performing an operation when a set of conditions has been met without requiring further input.

In some embodiments, while detecting the first user (e.g., 610, 612, 614, and/or 630) in the physical environment (e.g., 606 at FIG. 6A). In some embodiments, in accordance with the determination that the first set of one or more criteria is satisfied (e.g., as discussed above at FIGS. 6D-6H), wherein the first set of one or more criteria includes a criterion that is satisfied when the first user is detected to belong to a first group (e.g., as discussed above at FIGS. 6D-6F) (e.g., a household and/or family of users), the first content is fifth content (e.g., 604, 618, 620, 626, and/or 632) (and/or corresponding to the first group) (e.g., content that is only viewable by the first group (e.g., a household and/or family calendar)). In some embodiments, the fifth content is personalized and/or sensitive content for the first user. In some embodiments, the fifth content includes additional personalized and/or sensitive content for the first group. In some embodiments, in accordance with the determination that the first set of one or more criteria is satisfied (e.g., as discussed above at FIGS. 6D-6F), wherein the first set of one or more criteria includes a criterion that is satisfied when the first user is detected to not belong to the first group, that the first content does not include the fifth content (e.g., 604, 618, 620, 626, and/or 632). In some embodiments, a group of users is a user defined group (e.g., all users of a particular family and/or household). In some embodiments, a group of users is populated based on external determinations (e.g., a group of users sharing a cloud account). In some embodiments, a group of users is a general group of every user that has used the device. In some embodiments, a group of users is all the identified users of the device. In some embodiments, the sixth content is user specific content to the first user but doesn't include the content corresponding to the group. In some embodiments, the sixth content is generalized content displayed to anyone who isn't in the group. In some embodiments, the sixth content is personalized and/or sensitive content for the first user. Displaying different content based on detection of a user that is a member of a group allows a computer system to automatically transition between content for a particular user and relevant content for a group of users based on the user's membership of the group, thereby performing an operation when a set of conditions has been met without requiring further input.

In some embodiments, while detecting the first user (e.g., 610, 612, 614, and/or 630) in the physical environment (e.g., 606 at FIG. 6A). In some embodiments, in accordance with a determination that a fourth set of one or more criteria is satisfied (e.g., as discussed above at FIGS. 6D-6H), wherein the fourth set of one or more criteria includes a criterion that is satisfied when (e.g., a determination is made that) a fourth user (e.g., 610, 612, 614, and/or 630) (e.g., different from the first user) is not detected in a first area (e.g., left portion of 606 at FIG. 6E-6H) (e.g., a region and/or a section) of the physical environment and a criterion that is satisfied when the first user is detected in a second area of the physical environment (e.g., 606 at FIG. 6E-6H) (and/or a region, section, and/or area of the field-of-view of one or more cameras), displaying, via the display component, sixth content (e.g., 604, 618, 620, 626, and/or 632) (e.g., for a respective widget and/or in a respective widget). In some embodiments, the sixth content is the first content and/or the second content. In some embodiments, the sixth content is different from the first content and/or the second content. In some embodiments, in accordance with a determination that a fifth set of one or more criteria is satisfied (e.g., as discussed above at FIGS. 6D-6H), wherein the fifth set of one or more criteria includes a criterion that is satisfied when the fourth user is detected in the first area of the physical environment and a criterion that is satisfied when the first user is detected in the second area of the physical environment, displaying, via the display component, seventh content (e.g., 604, 618, 620, 626, and/or 632) different from the sixth content. In some embodiments, the seventh content is the first content and/or the second content. In some embodiments, the seventh content is different from the first content and/or the second content. In some embodiments, the first area and the second area of the physical environment correspond to separate sections of a room. In some embodiments, the first area and the second area of the physical environment are separate areas (e.g., two different rooms). In some embodiments, the first area and the second area of the physical environment at least partially overlap. In some embodiments, the first area and the second area of the physical environment are virtual bounds. In some embodiments, the first area and the second area of the physical environment are established based on configuration settings (e.g., system default settings). In some embodiments, the first area and the second area are configured by the user. In some embodiments, the first area and the second area of the physical environment are designated by the computer system (e.g., automatically detecting the physical layout of the environment, establishing bounds based on use of the computer system, and/or establishing bounds based on the type of computer system). Displaying different content based on detection of a user in different areas within an environment allows a computer system to automatically transition between relevant content for an area and relevant content for another area and provides the user with relevant content based on the user's location within the environment, thereby performing an operation when a set of conditions has been met without requiring further input.

In some embodiments, the first content (e.g., 604, 618, 620, 626, and/or 632) includes a first widget (e.g., as discussed above at FIGS. 6D-6H) (e.g., one or more widgets that includes the first widget) (e.g., a media widget (e.g., podcast, music, and/or audio book), information widget (e.g., weather, system information, and/or clock), and/or communication widget (e.g., text message, call history, and/or third party communication)) (e.g., a control that displays real-time information and/or information and/or data that corresponds to one or more metrics that has been calculated within a predetermined amount of time and/or calculated and/or displayed at certain time intervals and/or a control that, when selected, causes a user interface to be displayed that includes one or more portions of real-time information (e.g., real-time information that was included in the display of the control)). In some embodiments, the first content includes the first widget and one or more other user interface elements. In some embodiments, the first widget includes additional content that corresponds to the first content (e.g., a calendar widget and the content of the next calendar event (e.g., user, time, and/or body content)). In some embodiments, the first widget includes additional content that is unrelated to the first content (e.g., a clock widget and currently playing music content). In some embodiments, the computer system populates the first widget in connection to the first content. In some embodiments, the user customizes the first content to include the first widget. Displaying a widget with content provides a user with an additional method for interacting with the content, thereby providing additional control options without cluttering the user interface with additional displayed controls.

In some embodiments, the second content (e.g., 604, 618, 620, 626, and/or 632) includes a second widget (e.g., as discussed above at FIGS. 6D-6H). (e.g., one or more widgets that includes the second widget) (e.g., a media widget (e.g., podcast, music, and/or audio book), an information widget (e.g., weather, system information, and/or clock), and/or a communication widget (e.g., text message, call history, and/or third-party communication)). In some embodiments, the second content includes the second widget and one or more other user interface elements. In some embodiments, the second widget is the second content. In some embodiments, the second widget includes additional content that corresponds to the second content (e.g., a calendar widget and the content of the next calendar event (e.g., user, time, and/or body content)), and the first widget does not include the additional content. In some embodiments, the second widget includes additional content that is unrelated to the second content (e.g., a clock widget and currently playing music content), and the first widget does not include the additional content. In some embodiments, the computer system populates the second widget in connection to the second content. In some embodiments, the user customizes the second content to include the second widget. Displaying a widget with content provides a user with an additional method for interacting with the content, thereby providing additional control options without cluttering the user interface with additional displayed controls.

In some embodiments, the second widget (e.g., 604, 618, 620, 626, and/or 632) is the same as the first widget (e.g., 604, 618, 620, 626, and/or 632). In some embodiments, the second widget is displayed when the first content is displayed and when the second content is displayed. In some embodiments, the second widget contains the same information, visual appearance, and/or functionality as the first widget. Displaying a widget of the same type within different content provides a user with a consistent view and control of different content within a user interface, thereby providing additional control options without cluttering the user interface with additional displayed controls and improved visual feedback to the user.

In some embodiments, the second widget (e.g., 604, 618, 620, 626, and/or 632) is a different type of widget than the first widget (e.g., 604, 618, 620, 626, and/or 632). In some embodiments, the second widget and the first widget are the same type of widget but contain different information depending on whether the first content and/or the second content is displayed. In some embodiments, the first widget and/or second widget correspond to the first content and the second content, respectively. Displaying a widget of a different type withing different content provides a user with a distinctive view and control of different content within a user interface, thereby providing additional control options without cluttering the user interface with additional displayed controls and improved visual feedback to the user.

In some embodiments, the second content (e.g., 604, 618, 620, 626, and/or 632) includes a third widget (e.g., 604, 618, 620, 626, and/or 632) (e.g., a control that displays real-time information and/or information and/or data that corresponds to one or more metrics that has been calculated within a predetermined amount of time and/or calculated and/or displayed at certain time intervals and/or a control that, when selected, causes a user interface to be displayed that includes one or more portions of real-time information (e.g., real-time information that was included in the display of the control)). In some embodiments, the third widget is different from the first widget and/or the second widget. In some embodiments, the third widget is the same as the first widget and/or the second widget. In some embodiments, the widget corresponds to the second content. In some embodiments, the widget is displayed regardless of the second content.

In some embodiments, the widget is a system defined widget. In some embodiments, the widget displays system information. In some embodiments, the widget is a user defined widget. Displaying a widget with content provides a user with an additional method for interacting with the content, thereby providing additional control options without cluttering the user interface with additional displayed controls.

In some embodiments, the first content (e.g., 604, 618, 620, 626, and/or 632) includes content that corresponds to (e.g., relates to, is directed to, is for, and/or is associated with) the first user (e.g., as discussed above at FIGS. 6E-6H) (e.g., first identified user). In some embodiments, content that corresponds to a user is personalized content. In some embodiments, content corresponding to a user is sensitive and/or personal content not displayed to another user. In some embodiments, content corresponding to a user is additional content for the user. In some embodiments, content that corresponds to a user is a subset of content for the user that is included in broader generalized content (e.g., a general calendar that includes a particular user's meetings and/or events). In some embodiments, detecting the first user in the physical environment includes detecting that the first user is a first identified user. Displaying content corresponding to a particular user allows a computer system to automatically display content based on the identification of a user without the user selecting particular content to be displayed, thereby performing an operation when a set of conditions has been met without requiring further input from the user.

In some embodiments, the second content (e.g., 604, 618, 620, 626, and/or 632) includes content that does not correspond to (e.g., does not relate to, is not directed to, and/or is not associated with) the first user (e.g., as discussed above at FIGS. 6E-6H) (e.g., first identified user). In some embodiments, the content not corresponding to the first user is generalized content displayed to any user. In some embodiments, the content not corresponding to the first user is set by a user to be content displayed to anyone. In some embodiments, the content not corresponding to the first user is system defined content. In some embodiments, detecting the first user in the physical environment includes detecting that the first user is a first identified user. Displaying generalized content or content that does not correspond to a user alongside content corresponding to a user allows a computer system to display content relevant to any user while displaying personalized content for an identified user without requiring the identified user to select the generalized content and provides a user with information about the state of the device alongside content relevant to the user, thereby reducing the number of inputs needed to perform an operation and providing improved feedback to the user.

In some embodiments, the first content (e.g., 604, 618, 620, 626, and/or 632) includes eighth content (e.g., 604, 618, 620, 626, and/or 632). In some embodiments, the second content (e.g., 604, 618, 620, 626, and/or 632) includes the eighth content (e.g., 604, 618, 620, 626, and/or 632). In some embodiments, the eighth content corresponds to generalized information that is always displayed no matter what other content is displayed. In some embodiments, the eighth content is constant by user selection. In some embodiments, the eighth content corresponds to system content. In some embodiments, the eighth content corresponds to items found within the first and/or second content that remain constant. Displaying content irrespective of detection of an additional user allows the computer system to continuously display the relevant content to a user and provides the user with feedback about the state of the device regardless of detection of the additional user, thereby reducing the number of inputs needed to perform an operation and providing improved visual feedback to the user.

Note that details of the processes described above with respect to process 800 (e.g., FIG. 8) are also applicable in an analogous manner to the methods described below/above. For example, process 900 optionally includes one or more of the characteristics of the various methods described above with reference to process 800. For example, the computer system can display content in a widget based on location using the techniques described in relation to process 800 and display content in a widget based on presence of one or more users in an environment using the techniques described in relation to process 900. For brevity, these details are not repeated below.

FIG. 9 is a flow diagram illustrating a method for displaying content in a widget based on presence of one or more users in an environment using a computer system in accordance with some embodiments. Process 900 is performed at a computer system (e.g., 100, 200, and/or 600). Some operations in process 900 are, optionally, combined, the orders of some operations are, optionally, changed, and some operations are, optionally, omitted.

As described below, process 900 provides an intuitive way for displaying content in a widget based on the presence of one or more users in an environment. The method reduces the cognitive burden on a user for displaying content in a widget based on presence of one or more users in an environment, thereby creating a more efficient human-machine interface. For battery operated computing devices, enabling a user to display content in a widget based on presence of one or more users in an environment faster and more efficiently conserves power and increases the time between battery charges.

In some embodiments, process 900 is performed at a computer system (e.g., 600) that is in communication with one or more input devices (e.g., a camera, a depth sensor, and/or a microphone) and a display component (e.g., left portion of FIGS. 6A-6J) (e.g., a display screen and/or a touch-sensitive display). In some embodiments, the computer system is a watch, a phone, a tablet, a processor, a head-mounted display (HMD) device, a communal device, a media device, a speaker, a television, and/or a personal computing device.

The computer system detects (902), via the one or more input devices, a user (e.g., 610, 612, 614, and/or 630) (e.g., a person, an animal, and/or an object) (e.g., a location of the first user) in an environment (e.g., 606 at FIGS. 6A-6J) (e.g., a physical environment). In some embodiments, detecting the first user includes detecting a location and/or an identity of the first user. In some embodiments, the first user is detected via a microphone, a camera, a depth sensor, and/or a communication (e.g., indicating presence of the first user) received from a computer system corresponding to the first user.

In response to detecting the user in the environment, the computer system displays (904), via the display component, a first user interface (e.g., 602) that includes a first widget (e.g., 604, 618, 620, 626, and/or 632), wherein displaying the first widget includes: (906) in accordance with a determination that the computer system is at a location that is associated with a first privacy level for the user (e.g., as discussed above at FIGS. 6A-6C), displaying, via the display component, a first type of content in the first widget (e.g., as discussed above at FIGS. 6A-6C); and in accordance with (908) a determination that the computer system is at a location that is associated with a second privacy level for the user (e.g., as discussed above at FIGS. 6A-6C), different from the first privacy level for the user, displaying, via the display component, a second type of content in the first widget (e.g., as discussed above at FIGS. 6A-6C) that is different from the first type of content in the first widget. In some embodiments, the first content corresponds to the first user. In some embodiments, the first user interface is a system user interface of the computer system that includes display of a plurality of different widgets corresponding to different applications. In some embodiments, in accordance with a determination that computer system is at a location that is associated with the second privacy level for the user, the computer system does not display the first type of content in the widget. In some embodiments, in accordance with a determination that the computer system is at a location associated the first privacy level for the user, the computer system does not display the second type of content. Displaying different content based on a privacy level corresponding to a location of a computer system allows the computer system to automatically transition between content of a higher privacy level and content of a lower privacy level based on the location of the computer system, thereby performing an operation when a set of conditions has been met without requiring further input and increasing privacy.

In some embodiments, the second privacy level for the user is greater (e.g., more private) (e.g., less observation and/or disturbance by other users and/or people) (e.g., a bedroom has a greater privacy level than a living room) (and/or a living room has a greater privacy level than outside of and/or away from the house) than the first privacy level for the user (e.g., as discussed above at FIGS. 6A-6C). Detecting different levels of privacy at different locations allows a computer system to automatically display content corresponding to the level of privacy at a location, thereby performing an operation when a set of conditions has been met without requiring further input.

In some embodiments, the first type of content includes a first amount of content (e.g., content within 618 at FIG. 6C) (e.g., representations of applications, information from applications (e.g., a set of one or more characters), application icons, and/or widgets) (and/or a combination of application-based information and/or widget based information) (e.g., corresponding to the first privacy level). In some embodiments, the second type of content includes a second amount of content (e.g., content within 618 at FIG. 6B) (e.g., corresponding to the second privacy level). In some embodiments, the second amount of content is greater than the first amount of content (e.g., as discussed above at FIGS. 6A-6C). In some embodiments, the amount of content corresponds to screen space taken up by content, number of widgets, amount of text, amount of user interface objects; amount of generalized information, amount of system information, and/or the amount of personalized and/or user specific information. In some embodiments, the second amount of content corresponds to additional content not found in the first type of content. In some embodiments, the second amount of content is additional content of the same type of the first type of content. In some embodiments, the increased amount of content corresponds to displaying personal information (e.g., private information (e.g., health information, financial information, and/or private calendar content) only displayed when in a private location). Displaying a greater amount of content based on detecting a higher level of privacy allows a computer system to display additional private content upon detecting the higher level of privacy, thereby performing an operation when a set of conditions has been met without requiring further input.

In some embodiments, the first type of content includes a first amount of information corresponding to (e.g., associated with and/or concerning) the user (e.g., content within 618 at FIG. 6C). In some embodiments, the second type of content includes a second amount of information corresponding to (e.g., associated with and/or concerning) the user (e.g., content within 618 at FIG. 6B). In some embodiments, the second amount of information is greater than (e.g., more of the same type of content and/or more user interface elements of the same type of content) the first amount of information (e.g., as discussed above at FIGS. 6A-6C) (e.g., additional health information, financial information, and/or calendar information) (e.g., more private information to only be displayed when the user is detected in a private location). In some embodiments, the additional information is additional private information of the first type of content to be displayed with the second type of content. In some embodiments, the additional information does not correspond to the first type of content. Displaying a greater amount of information based on detecting a higher level of privacy allows a computer system to display additional private information upon detecting the higher level of privacy, thereby performing an operation when a set of conditions has been met without requiring further input.

In some embodiments, the first type of content includes a first amount of financial information corresponding to (e.g., associated with and/or for) the user (e.g., as discussed above at FIGS. 6A-6C). In some embodiments, the second type of content includes a first amount of financial information corresponding to (e.g., associated with and/or for) the user (e.g., as discussed above at FIGS. 6A-6C). In some embodiments, the second amount of financial information is greater than the first amount of financial information (e.g., as discussed above at FIGS. 6A-6C). In some embodiments, the financial information is obtained through local and/or remote based financial applications. In some embodiments, the additional financial information corresponds to private information corresponding to the user. In some embodiments, the additional financial information is additional private information of the first type of content to be displayed with the second type of content. In some embodiments, the additional financial information does not correspond to the first type of content. Displaying a greater amount of financial information based on detecting a higher level of privacy allows a computer system to display additional private financial information upon detecting the higher level of privacy, thereby performing an operation when a set of conditions has been met without requiring further input.

In some embodiments, the first type of content includes a first amount of health information corresponding to (e.g., associated with and/or for) the user (e.g., as discussed above at FIGS. 6A-6C). In some embodiments, the second type of content includes a first amount of health information corresponding to (e.g., associated with and/or for) the user (e.g., as discussed above at FIGS. 6A-6C). In some embodiments, the second amount of health information is greater than the first amount of health information (e.g., as discussed above at FIGS. 6A-6C). In some embodiments, the health information is obtained through other connected devices and/or through third party health applications. In some embodiments, the additional health information is more private information that corresponds to the user. Displaying a greater amount of health information based on detecting a higher level of privacy allows a computer system to display additional private health information upon detecting the higher level of privacy, thereby performing an operation when a set of conditions has been met without requiring further input.

In some embodiments, the first type of content includes a first amount of usage (e.g., statistics on the user's usage of the computer system and/or remotely connected computer systems) (e.g., how much the particular user uses the computer system and/or particular applications on the computer system) information corresponding to (e.g., associated with and/or for) the user (e.g., as discussed above at FIGS. 6A-6C). In some embodiments, the second type of content includes a second amount of usage information corresponding to (e.g., associated with and/or for) the user (e.g., as discussed above at FIGS. 6A-6C). In some embodiments, the second amount of usage information is greater than the first amount of usage information (e.g., as discussed above at FIGS. 6A-6C). In some embodiments, the usage information corresponds to the devices displaying the content and/or other devices connected to the device displaying the content. In some embodiments, the additional usage information is more private information corresponding to the user. Displaying a greater amount of usage information based on detecting a higher level of privacy allows a computer system to display additional private usage information upon detecting the higher level of privacy, thereby performing an operation when a set of conditions has been met without requiring further input.

In some embodiments, the first privacy level (e.g., as discussed above at FIGS. 6A-6C) of the user corresponds to a first personal location (e.g., as discussed above at FIGS. 6A-6C). In some embodiments, the second privacy level (e.g., as discussed above at FIGS. 6A-6C) of the user corresponds to a second personal location (e.g., as discussed above at FIGS. 6A-6C) different from the first personal location. In some embodiments, the first personal location and the second personal location correspond to locations associated with a user (e.g., locations within the user's household). In some embodiments, the second personal information is more private than the first personal location (e.g., a user's home is more private than a user's work office) (e.g., a bathroom is more private than a bedroom and/or bedroom is more private than a living room). In some embodiments, a personal location does not correspond to privacy level and depicts a connection to a user (e.g., a user's household rather than public places (e.g., restaurants, bus stops, and/or parks)). Determining privacy level of an environment within one or more personal locations of a user allows a computer system to determine an appropriate type of content to output within the privacy level of the environment, thereby performing an operation based on a set of conditions without further input.

In some embodiments, the first user interface (e.g., 602) includes a second widget (e.g., 604, 618, 620, 626, and/or 632). In some embodiments, the second widget includes a third type of content (e.g., as discussed above at FIGS. 6A-6C) (e.g., that is displayed regardless of privacy level) (e.g., that is displayed at the first privacy level and/or the second privacy level). In some embodiments, displaying the first widget includes concurrently displaying the second widget (e.g., as discussed above at FIGS. 6A-6C). In some embodiments, the third type of content is generalized content. In some embodiments, the third type of content is system information. In some embodiments, the third type of content is set by the user and/or the computer system to be displayed no matter location. Continuously displaying additional content irrespective of privacy level of a location allows a computer system to display a set of content consistently without detecting the privacy level of the location and allows the computer system to display a set of content consistently for ease of viewing by a user, thereby increasing performance and providing improved visual feedback to the user.

In some embodiments, while displaying the second type of content (e.g., as discussed above at FIGS. 6A-6C) in the first widget (e.g., 604, 618, 620, 626, and/or 632) and determining that the computer system is at the location that is associated with the second privacy level (e.g., as discussed above at FIGS. 6A-6C) (and/or for the user), the computer system detects movement of the computer system from the location that is associated with the second privacy level to the location that is associated with the first privacy level (e.g., as discussed above at FIGS. 6A-6C) (and/or for the user). In some embodiments, in response to detecting the movement of the computer system from the location that is associated with the second privacy level to the location that is associated with the first privacy level (and/or for the user), the computer system ceases displaying the second type of content in the first widget. In some embodiments, in response to detecting the movement of the computer system from the location that is associated with the second privacy level to the location that is associated with the first privacy level, the computer system displays, via the display component, the first type of content (e.g., as discussed above at FIGS. 6A-6C) in the first widget. In some embodiments, the computer system replaces the second type of content in the first widget with the first type of content. Replacing displayed content upon detecting movement of a computer system to an area of lower privacy allows the computer system to automatically transition from displaying private content to displaying more generalized content, thereby performing an operation when a set of conditions has been met without requiring further input.

In some embodiments, ceasing displaying the second type of content (e.g., as discussed above at FIGS. 6A-6C) includes reducing the opacity level of the second type of content to a predetermined level (e.g., as discussed above at FIGS. 6A-6D) (e.g., reducing from 100% to 0%, reducing by a majority (e.g., greater than 50%), and/or slightly reducing (e.g., 100% to 90%)). In some embodiments, the ceasing displaying of the second type of content is through a fading out animation. In some embodiments, a fading out animation includes reducing from 100% to 0%, reducing by a majority (e.g., greater than 50%), and/or slightly reducing (e.g., 100% to 90%). Fading out displaying content provides a user with a visual indication that the privacy level has changed and gives feedback to the state of the computer system, thereby providing improved visual feedback to the user.

In some embodiments, while displaying the first type of content (e.g., as discussed above at FIGS. 6A-6C) in the first widget (e.g., 604, 618, 620, 626, and/or 632) and determining that the computer system is at the location that is associated with the first privacy level (e.g., as discussed above at FIGS. 6A-6C) (and/or for the user), the computer system detects movement of the computer system from the location that is associated with the first privacy level to the location that is associated with the second privacy level (e.g., as discussed above at FIGS. 6A-6C) (and/or for the user). In some embodiments, in response to detecting the movement of the computer system from the location that is associated with the first privacy level to the location that is associated with the second privacy level (and/or for the user), the computer system ceases displaying the first type of content in the first widget. In some embodiments, in response to detecting the movement of the computer system from the location that is associated with the first privacy level to the location that is associated with the second privacy level, the computer system displays, via the display component, the second type of content (e.g., as discussed above at FIGS. 6A-6C) in the first widget. In some embodiments, the computer system replaces the first type of content in the first widget with the second type of content. Replacing displayed content upon detecting movement of a computer system to an area of higher privacy allows the computer system to automatically transition from displaying generalized content to displaying private content, thereby performing an operation when a set of conditions has been met without requiring further input.

In some embodiments, ceasing displaying the first type of content (e.g., as discussed above at FIGS. 6A-6C) includes reducing the opacity level of the first type of content (e.g., reducing from 100% to 0%, reducing by a majority (e.g., greater than 50%), and/or slightly reducing (e.g., 100% to 90%)). In some embodiments, the ceasing displaying of the second type of content is through a fading out animation. In some embodiments, a fading out animation includes reducing from 100% to 0%, reducing by a majority (e.g., greater than 50%), and/or slightly reducing (e.g., 100% to 90%). Fading out displaying content provides a user with a visual indication that the privacy level has changed and gives feedback to the state of the computer system, thereby providing improved visual feedback to the user.

In some embodiments, while detecting the user in the environment and displaying the first type of content (e.g., as discussed above at FIGS. 6A-6C) in the first widget (e.g., 604, 618, 620, 626, and/or 632), the computer system detects, via the one or more input devices, a second user (e.g., 610, 612, 614, and/or 630) (and/or the presence of a second user), different from the user, in the environment. In some embodiments, in response to detecting the second user (and/or the presence of the second user) in the environment, the computer system ceases displaying the first type of content in the first widget. In some embodiments, in response to detecting the second user in the environment, the computer system displays, via the display component, the second type of content (e.g., as discussed above at FIGS. 6A-6C) in the first widget. In some embodiments, the second type of content corresponds to the second user. In some embodiments, the computer system replaces the first type of content in the first widget with the second type of content. Replacing content upon detection of another user within the environment allows a computer system to automatically transition from displaying generalized content to displaying private content, thereby performing an operation when a set of conditions has been met without requiring further input.

In some embodiments, while detecting the user (e.g., 610, 612, 614, and/or 630) in the environment (e.g., 606 at FIGS. 6A-6J) and displaying the second type of content (e.g., as discussed above at FIGS. 6A-6C) in the first widget (e.g., 604, 618, 620, 626, and/or 632), the computer system detects, via the one or more input devices, a third user (e.g., 610, 612, 614, and/or 630) (and/or the presence of a second user), different from the user, in the environment. In some embodiments, in response to detecting the third user (and/or the presence of the second user) in the environment, the computer system ceases displaying the second type of content in the first widget. In some embodiments, in response to detecting the third user in the environment, the computer system displays, via the display component, the first type of content (e.g., as discussed above at FIGS. 6A-6C) in the first widget. In some embodiments, the second type of content corresponds to the first user. In some embodiments, the second type of content is personal information corresponds to the first user. In some embodiments, the computer system replaces the second type of content in the first widget with the first type of content. Replacing content upon detection of another user within the environment allows a computer system to automatically transition from displaying private content to displaying generalized content, thereby performing an operation when a set of conditions has been met without requiring further input.

In some embodiments, while detecting the user (e.g., 610, 612, 614, and/or 630) in the environment (e.g., 606 at FIGS. 6A-6J) and displaying the first type of content (e.g., as discussed above at FIGS. 6A-6C) in the first widget (e.g., 604, 618, 620, 626, and/or 632), the computer system detects that the user is no longer in the environment. In some embodiments, in response to detecting that the user is no longer in the environment, the computer system ceases displaying the first type of content in the first widget. In some embodiments, in response to detecting that the user is no longer in the environment, the computer system displays, via the display component, the second type of content (e.g., as discussed above at FIGS. 6A-6C) in the first widget. In some embodiments, the computer system replaces the first type of content in the first widget with the second type of content. In some embodiments, in response to detecting that the user is no longer in the environment: ceasing displaying the second type of content in the first widget; and displaying the first type of content in the first widget. In some embodiments, the computer system replaces the second type of content in the first widget with the first type of content. Replacing content when a computer system no longer detects another user within the environment allows a computer system to automatically transition from displaying generalized content to displaying private content, thereby performing an operation when a set of conditions has been met without requiring further input.

In some embodiments, while displaying the first type of content (e.g., as discussed above at FIGS. 6A-6C) in the first widget (e.g., 604, 618, 620, 626, and/or 632) (and/or while displaying the second type of content in the first widget), the computer system detects, via the one or more input devices, a first input (e.g., as discussed above at FIGS. 6A-6C) (e.g., a verbal input (e.g., a verbal utterance, a sound, an acoustic request, an acoustic command, and/or an acoustic statement) and/or a non-verbal input (e.g., a swipe input, a hold-and-drag input, a gaze input, an air gesture, and/or a mouse click)). In some embodiments, in response to detecting the first input, the computer system displays, via the display component, the second type of content (e.g., as discussed above at FIGS. 6A-6C) in the first widget (and/or displaying the first type of content in the first widget). In some embodiments, in response to detecting the first input, the computer system replaces the first type of content in the first widget with the second type of content. In some embodiments, replacing the content includes ceasing displaying the first type of content. Displaying additional content upon detection of an input directed to the currently displayed content allows a computer system to transition between content without displaying additional controls or user interface objects, thereby providing additional control options without cluttering the user interface with additional displayed controls.

In some embodiments, while displaying the second type of content (e.g., as discussed above at FIGS. 6A-6C) in the first widget (e.g., 604, 618, 620, 626, and/or 632) (and/or displaying the first type of content in the first widget) (and after detecting the first input), the computer system detects a second input (e.g., as discussed above at FIGS. 6A-6C) (e.g., a verbal input (e.g., a verbal utterance, a sound, an acoustic request, an acoustic command, and/or an acoustic statement) and/or a non-verbal input (e.g., a swipe input, a hold-and-drag input, a gaze input, an air gesture, and/or a mouse click)). In some embodiments, in response to detecting the second input, the computer system ceases displaying the first type of content (e.g., as discussed above at FIGS. 6A-6C) in the first widget (and/or the second type of content in the first widget). Replacing content upon detection of an input directed to the currently displayed content allows a computer system to transition between content without displaying additional controls or user interface objects, thereby providing additional control options without cluttering the user interface with additional displayed controls.

In some embodiments, after detecting the second input (e.g., as discussed above at FIGS. 6A-6C) and before ceasing displaying the first type of content (e.g., as discussed above at FIGS. 6A-6C) in the first widget (and/or the second type of content in the first widget), the computer system displays, via the display component, a control (e.g., as discussed above at FIGS. 6A-6C) corresponding to the first type of content (and/or the second type of content). In some embodiments, while displaying the control, the computer system detects a third input (e.g., as discussed above at FIGS. 6A-6C) (e.g., a verbal input (e.g., a verbal utterance, a sound, an acoustic request, an acoustic command, and/or an acoustic statement) and/or a non-verbal input (e.g., a swipe input, a hold-and-drag input, a gaze input, an air gesture, and/or a mouse click)) directed to the control corresponding to the first type of content (and/or the second type of content). In some embodiments, in response to detecting the third input directed to the control corresponding to the first type of content (and/or the second type of content), the computer system ceases displaying the first type of content in the first widget (and/or the second type of content in the first widget). Displaying a confirmation user interface prior to ceasing displaying content allows a computer system to reduce the number of user interface objects displayed by only displaying controls for ceasing displaying content on the confirmation user interface upon detection of an input, thereby providing additional control options without cluttering the user interface with additional displayed controls.

In some embodiments, the computer system detects, via the one or more input devices, a fourth user (e.g., 610, 612, 614, and/or 630) in the environment (e.g., 606 at FIGS. 6A-6J) (e.g., while detecting the user in the environment). In some embodiments, in response to detecting the fourth user in the environment, the computer system displays, via the display component, the first user interface (e.g., 602) that includes a second widget (e.g., 604, 618, 620, 626, and/or 632), wherein displaying the second widget includes: in accordance with a determination that the computer system is at a location that is associated with the second privacy level for the fourth user (e.g., as discussed above at FIGS. 6A-6C), displaying, via the display component, a first type of content in the second widget (e.g., as discussed above at FIGS. 6A-6C). In some embodiments, in accordance with a determination that the computer system is at a location that is associated with the first privacy level for the fourth user, displaying, a second type of content in the second widget that is different from the first type of content in the second widget. In some embodiments, the first content corresponds to the fourth user. In some embodiments, the second content corresponds to the fourth user. In some embodiments, the first content in the second widget corresponds to the first content in the first widget. In some embodiments, the first content in the second widget is the first content of the first widget but corresponding to the fourth user rather than the first user. In some embodiments, the second content is additional content of the first type of content. In some embodiments, the second content is more personal information corresponding the fourth user. Displaying content of differing privacy levels for different users within an environment allows a computer system to display relevant content for different users based on predetermined factors without requiring selection of the content to be displayed, thereby performing an operation when a set of conditions has been met without requiring further input.

In some embodiments, the first widget (e.g., 604, 618, 620, 626, and/or 632) is concurrently displayed with the second widget (e.g., 604, 618, 620, 626, and/or 632) (and/or while displaying the second widget, displaying the first widget). Concurrently displaying multiple widgets corresponding to different users allows a computer system to display relevant content for multiple users at the same time based on predetermined factors, thereby performing an operation when a set of conditions has been met without requiring further input.

In some embodiments, the first user interface (e.g., 602) that includes the first widget (e.g., 604, 618, 620, 626, and/or 632) includes a third widget (e.g., 604, 618, 620, 626, and/or 632) (and/or corresponding to common content that concerns any user using of the computer system). In some embodiments, the third widget is displayed alongside the first widget including the first type of content (e.g., as discussed above at FIGS. 6A-6C) (and/or the second type of content). In some embodiments, the third widget is a common widget. In some embodiments, a common widget is a widget that is displayed continuously and/or alongside additional widgets and/or content that is displayed and/or not displayed (e.g., computer system displaying a clock widget, weather widget, and/or colander widget regardless of additional content and/or widgets displayed on the user interface). Displaying a widget as a common widget allows a computer system to consistently display predefined content and the controls for the content alongside additional content and provides a user with consistently displayed information about the state of the computer system, thereby providing additional control options without cluttering the user interface with additional displayed controls and providing improved visual feedback to the user.

In some embodiments, the first widget (e.g., 604, 618, 620, 626, and/or 632) corresponds to the user (e.g., 610, 612, 614, and/or 630). In some embodiments, the first user interface (e.g., 602) includes a fourth widget (e.g., 604, 618, 620, 626, and/or 632) corresponding to a fifth user (e.g., 610, 612, 614, and/or 630) different from the user. In some embodiments, the fourth widget is the same type of widget as the first widget. In some embodiments, the fourth widget is a different type of widget than the first widget. In some embodiments, the fourth widget includes a first type of content and/or a second type of content. In some embodiments, the fourth widget includes generalized content corresponding to the other user. Displaying multiple widgets alongside each other corresponding to different users within an environment allows a computer system to display relevant content to different users based on predetermined factors without requiring selection of the content to be displayed, thereby performing an operation when a set of conditions has been met without requiring further input.

Note that details of the processes described above with respect to process 900 (e.g., FIG. 9) are also applicable in an analogous manner to the methods described below/above. For example, process 1000 optionally includes one or more of the characteristics of the various methods described above with reference to process 900. For example, the computer system can display content in a widget based on presence of one or more users in an environment using the techniques described in relation to process 900 and display a widget containing content at a size based on relevance using the techniques described in relation to process 1000. For brevity, these details are not repeated below.

FIG. 10 is a flow diagram illustrating a method for displaying a widget containing content at a size based on relevance using a computer system in accordance with some embodiments. Process 1000 is performed at a computer system (e.g., 100, 200, and/or 600). Some operations in process 1000 are, optionally, combined, the orders of some operations are, optionally, changed, and some operations are, optionally, omitted.

As described below, process 1000 provides an intuitive way for displaying a widget containing content at a size based on relevance. The method reduces the cognitive burden on a user for displaying a widget containing content at a size based on relevance, thereby creating a more efficient human-machine interface. For battery operated computing devices, enabling a user to display a widget containing content at a size based on relevance faster and more efficiently conserves power and increases the time between battery charges.

In some embodiments, process 1000 is performed at a computer system (e.g., 600) that is in communication with a display component (e.g., left portion of FIGS. 6A-6J) (e.g., a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1002) a respective condition (e.g., as discussed above at FIGS. 6A-6E) (e.g., a wakeup condition, a condition that includes detecting presence of user, and/or a request for the computer system to perform an operation (e.g., detected via one or more condition, such as detecting a particular time of day (e.g., 8 AM-7:59 AM), a particular weather pattern (e.g., sunset and/or sunrise), and/or a particular event has occurred or will occur (e.g., an incoming phone call, an upcoming meeting, and/or an upcoming event)).

In response to detecting the respective condition, the computer system automatically displays (1004) via the display component and without user input, a set of one or more user interfaces that includes a respective user interface (e.g., 602), wherein the respective user interface includes: (1006) in accordance with a determination that detecting the respective condition does not include detecting presence of a respective user (e.g., 610, 612, 614, and/or 630) (e.g., an identified user and/or a known user), displaying a first widget (e.g., 604, 618, 620, 626, and/or 632) (e.g., an application user interface and/or a component of a user interface that enables a user to perform one or more functions and/or access a service); in accordance with (1008) a determination that detecting the respective condition includes detecting presence of a first user (e.g., 610, 612, 614, and/or 630) (e.g., a first identified user, a first known user, a first unidentified user, and/or a first unknown user), concurrently displaying the first widget and a widget that includes content corresponding to the first user (e.g., 604, 618, 620, 626, and/or 632); and in accordance with (1010) a determination that detecting presence of the one or more users includes detecting presence of a second user (e.g., 610, 612, 614, and/or 630) (e.g., a second identified user, a second known user, a second unidentified user, and/or a second unknown user) different from the first user (and, in some embodiments, without detecting presence of the first user), concurrently displaying the first widget and a widget that includes content corresponding to the second user (e.g., 604, 618, 620, 626, and/or 632) (e.g., without displaying the widget that includes content corresponding to the first user). In some embodiments, the set of one or more user interfaces includes a greeting user interface (e.g., a user interface that displays a greeting, such as “Hello” and/or “Welcome”). In some embodiments, the greeting user interface is displayed before the respective user interface is displayed. In some embodiments, in accordance with a determination that detecting the respective condition includes detecting presence of the first user, the computer system does not concurrently display the first widget and the widget that includes content corresponding to the second user. In some embodiments, in accordance with a determination that detecting the respective condition includes detecting presence of the second user, the computer system does not concurrently display the first widget and the widget that includes content corresponding to the first user. Displaying additional content corresponding to a particular user alongside already displayed content upon detecting the particular user allows a computer system to automatically transition from generalized content to specific content corresponding to the particular user that was detected, thereby performing an operation when a set of conditions has been met without requiring further input and reducing the number of inputs needed to perform an operation.

In some embodiments, detecting the presence (and/or lack of presence) of the respective user (e.g., the first user and/or the second user) includes capturing the respective user in a field of view of one or more cameras (e.g., dotted lines casting away from 608 in 606 at FIGS. 6A-6J) (and/or in communication with the computer system) (e.g., one or more telephoto, wide-angle, and/or ultra-wide-angle cameras). Detecting a user through a field of view of one or more cameras allows a computer system to automatically detect a user within a physical environment without the user interacting with the computer system, thereby performing an operation when a set of conditions has been met without requiring further input.

In some embodiments, detecting the presence of the respective user includes detecting that the respective user has an activity level (e.g., as discussed above at FIGS. 6A-6E) (e.g., activity level determined by how much the respective user is talking, moving, gesturing, providing input, and/or gazing) that is above a threshold amount (e.g., as discussed above at FIGS. 6A-6E) (e.g., 0-100% and/or 0-100) (e.g., in the field of view of the one or more cameras and/or in a field-of-detection of a device, such as microphone and/or another type of sensor (e.g., radar sensor and/or LiDAR sensor)). Detecting a user based on the user performing an action within the field of view of one or more cameras allows the computer system to automatically detecting the user within a physical environment without the user interacting with the computer system and provides the user additional methods of providing input to the computer system, thereby performing an operation when a set of conditions has been met without requiring further input and providing additional control operations without cluttering the user interface with additional displayed controls.

In some embodiments, detecting a change in the activity level (e.g., as discussed above at FIGS. 6A-6E) includes detecting that the respective user is talking (e.g., as discussed above at FIG. 6A-6E) (or not talking) (e.g., speaking a key phrase (e.g., a wake phrase corresponding to activation of the computer system) and/or speaking generally). In some embodiments, the detected activity level increases when the respective user is talking and decreases when the respective user is not talking. In some embodiments, the increase in the activity level is directly proportional to the increase in the respective user talking. In some embodiments, the decrease in the activity level is directly proportional to the decrease in the respective user talking. Detecting a user based on a user speaking within the field of view of one or more cameras allows the computer system to automatically detecting the user within a physical environment without the user interacting with the computer system and provides the user additional methods of providing input to the computer system, thereby performing an operation when a set of conditions has been met without requiring further input and providing additional control operations without cluttering the user interface with additional displayed controls.

In some embodiments, detecting a change in the activity level (e.g., as discussed above at FIGS. 6A-6E) includes detecting movement of the respective user (e.g., 610, 612, 614, and/or 630) (or not detecting movement of the respective user) (e.g., moving from a first location to a second location, different from the first location, within the field of view). In some embodiments, the movement of the respective user is a body part moving within the field of view (e.g., waving an arm). In some embodiments, the movement is the respective user moving from one place to another within the field of view. In some embodiments, the movement is the respective user moving from outside of the field of view to into the field of view of the camera. In some embodiments, the detected activity level increases when the respective user is moving and decreases when the respective user is not moving. In some embodiments, the increase in the activity level is directly proportional to the increase in movement of the respective user. In some embodiments, the decrease in the activity level is directly proportional to the decrease in movement of the respective user. Detecting a user based on a user moving within the field of view of one or more cameras allows the computer system to automatically detecting the user within a physical environment without the user interacting with the computer system and provides the user additional methods of providing input to the computer system, thereby performing an operation when a set of conditions has been met without requiring further input and providing additional control operations without cluttering the user interface with additional displayed controls.

In some embodiments, in response to detecting the respective condition (e.g., as discussed above at FIGS. 6A-6E) and in accordance with the determination that detecting the respective condition does not include detecting presence of a user (e.g., 610, 612, 614, and/or 630) (and/or the first user) (and/or the second user), the computer system forgoes displaying the content corresponding to the first user (e.g., as discussed above at FIGS. 6A-6E). In some embodiments, in response to detecting the respective condition and in accordance with the determination that detecting the respective condition does not include detecting presence of the user, the computer system forgoes displaying the content corresponding to the second user (e.g., as discussed above at FIGS. 6A-6E). In some embodiments, a widget that would include the content corresponding to the first user and/or the content corresponding to the first user is displayed with generalized content, such as the time and/or a date, and is not displayed with personalized content. Forgoing displaying content based on not detecting presence of a user allows a computer system to automatically transition between displaying content and no longer displaying content without input from a user, thereby performing an operation when a set of conditions has been met without requiring further input.

In some embodiments, the first widget is displayed at with a first brightness value (e.g., 602 at FIGS. 6A-6C) (e.g., full brightness, normal viewing brightness, and/or active brightness). In some embodiments, in response to detecting the respective condition, in accordance with the determination that detecting the respective condition (e.g., as discussed above at FIGS. 6A-6E) does not include detecting presence of the respective user (e.g., 610, 612, 614, and/or 630) (e.g., an identified user and/or a known user), the computer system reduces, via the display component, the brightness value of the first widget (e.g., 604, 618, 620, 626, and/or 632) to a first predetermined brightness value (e.g., 602 at FIG. 6D) (e.g., reduced brightness, lowered brightness, and/or inactive brightness). In some embodiments, the predetermined value is a slight change from the original brightness value (e.g., resulting in a slight dimming of the display). In some embodiments, the first predetermined value is much lower than the original brightness value (e.g., resulting in a majority dimming of the display). In some embodiments, the first predetermined value is defined by the computer system (e.g., default settings, based on environment, and/or based on a characteristic (e.g., screen type, battery life, and/or content displayed)). In some embodiments, the first predetermined value is set by the respective user (e.g., temporarily modified and/or set within the respective user's settings). In some embodiments, in response to detecting the respective condition, in accordance with the determination that detecting the respective condition includes detecting presence of the first user (e.g., a first identified user, a first known user, a first unidentified user, and/or a first unknown user), the computer system increases the brightness value of the first widget to a second predetermined brightness value (e.g., 602 at FIGS. 6E-6F) (e.g., active brightness and/or viewing brightness) that is greater than the first predetermined value. In some embodiments, the second predetermined value is the original brightness level. In some embodiments, the second predetermined value is different (e.g., greater and/or lower) than the original brightness level. In some embodiments, the second predetermined value is defined by the computer system (e.g., default settings, based on an environment, and/or based on a characteristic (e.g., screen type, battery life, and/or content displayed)). In some embodiments, the second predetermined value is set by the respective user (e.g., temporarily modified and/or set within the respective user's settings). In some embodiments, the computer system alters an opacity value of the first widget. In some embodiments, in response to detecting the respective condition: in accordance with the determination that detecting the respective condition does not include detecting presence of the respective user, reducing the opacity value of the first widget to a first predetermined opacity value; and in accordance with the determination that detecting the respective condition includes detecting presence of the first user, increasing the opacity value of the first widget to a second predetermined opacity value that is greater than the first predetermined value. Dimming displayed content based on not detecting the presence of a user and undimming displayed content upon detecting the presence of a user allows a computer system to automatically transition between actively displayed content and reduced content (e.g., reduced in amount of content and/or reduced in visibility of content), thereby performing an operation when a set of conditions has been met without requiring further input and reducing power usage by the computer system.

In some embodiments, in response to (and/or while) detecting the respective condition (e.g., as discussed above at FIG. 6A. In some embodiments, in accordance with the determination that detecting the respective condition does not include detecting presence of the respective user (e.g., 610, 612, 614, and/or 630), the first widget (e.g., 604, 618, 620, 626, and/or 632) is displayed at a first size (e.g., size of 604 at FIG. 6A). In some embodiments, in accordance with the determination that detecting the respective condition does include detecting presence of the first user, the first widget is displayed at a second size (e.g., size of 604 at FIG. 6B) that is smaller than the first size. In some embodiments, the size of the first widget is defined by the bounds of the respective user interface. In some embodiments, the size of the first widget is proportional to the size of the device. In some embodiments, the size of the first widget is set by the computer system (e.g., based on lighting, based on other content, based on display type, and/or based on disability settings). Displaying a widget at different sizes based on detecting the presence of a user allows a computer system to automatically alter the visual prominence of displayed content, thereby performing an operation when a set of conditions has been met without requiring further input and providing feedback to the user.

In some embodiments, displaying the first widget (e.g., 604, 618, 620, 626, and/or 632) includes displaying, via the display component, an indication of a current time (e.g., analog time reading in 604 at FIGS. 6A-6I). In some embodiments, the indication of the current time is an analog clock and/or digital clock. In some embodiments, the indication is a user interface object that corresponds to the current time (e.g., a shape and/or symbol that shows the respective user the time). Displaying the current time within a widget allows a computer system to continuously display relevant information to a user and provides the user with a consistent method for obtaining the information without requiring an input, thereby reducing the number of inputs needed to perform an operation.

In some embodiments, displaying the first widget (e.g., 604, 618, 620, 626, and/or 632) includes displaying, via the display component, content corresponding to the computer system (e.g., as discussed above at FIGS. 6A-6E) (and/or not corresponding to the first user and/or second user) (e.g., battery percentage, location, data and/or Wi-Fi connectivity, and/or system activity). In some embodiments, the content corresponding to the computer system is always displayed regardless of settings. In some embodiments, the content corresponding to the computer system is selected by the respective user to be displayed. In some embodiments, the content corresponding to the computer system is populated by the computer system based on a set of criteria. Displaying system information within a widget allows a computer system to continuously display information corresponding to the state of the computer system without the user interacting with the computer system, thereby reducing the number of inputs needed to perform an operation and providing feedback to a user.

In some embodiments, the first widget (e.g., 604, 618, 620, 626, and/or 632) is displayed at a first location (e.g., location of 604 at FIG. 6B). In some embodiments, a respective widget (e.g., 618 and/or 620 at FIG. 6B) (e.g., the widget that includes content corresponding to the first user and/or the second user) concurrently displayed with the first widget at least partially surrounds the first location (e.g., as discussed above at FIGS. 6A-6E) (and/or the first widget). In some embodiments, the first widget is displayed at a first prominence level (and/or corresponding to size, location, and/or depth) (e.g., displaying at a larger size, displaying in a central and/or more noticeable location, and/or displaying in front of other elements). In some embodiments, a respective widget (e.g., the widget that includes content corresponding to the first user and/or the second user) concurrently displayed with the first widget is displayed at a second prominence level that is less than the first prominence level (e.g., smaller, in a less central location, and/or displayed behind). Displaying a widget at a central prominent location and additional widgets at locations surrounding the centrally located widget allows a computer system to automatically display content based on relevance to a user without the user selecting the relevant content, thereby performing an operation when a set of conditions has been met without requiring further input and providing feedback to the user.

In some embodiments, in response to (and/or while) detecting the respective condition (e.g., as discussed above at FIG. 6A). In some embodiments, in accordance with the determination that detecting the respective condition does not include detecting presence of a user (e.g., as discussed above at FIGS. 6A-6E), the first widget is displayed at a respective (and/or a fixed, an initial, and/or an original) location (e.g., location of 604 at FIGS. 6A and/or 6D). In some embodiments, in accordance with the determination that detecting the respective condition does include detecting presence of a user, the first widget is displayed at the respective location (e.g., as discussed above at FIGS. 6A-6E) (e.g., displaying the first widget at a first location irrespective of detecting a user is present and/or a user is not present). In some embodiments, the respective location is fixed based on the respective user's settings. In some embodiments, the computer system sets the respective location based on criterion (device type, content type, and/or screen size). In some embodiments, the respective location is set based on default device settings. Displaying a widget at a consistent location regardless of detection of the presence of a user provides a user with a consistent viewing experience and allows a computer system to continuously display relevant information to potential users without requiring detection of the user's presence, thereby performing an operation when a set of conditions has been met without requiring further input and providing feedback to the user.

In some embodiments, the content corresponding to the second user (e.g., as discussed above at FIGS. 6A-6E) (and/or that is concurrently displayed with the first widget) is different from the content corresponding to the first user (e.g., as discussed above at FIGS. 6A-6E) (and/or that is concurrently displayed with the first widget). In some embodiments, the widget concurrently displayed with the first widget is the same for both users and the content is changed depending on the respective user. In some embodiments, the widget concurrently displayed with the first widget is different depending on the respective user. In some embodiments, the content corresponding to the second user includes personal information (e.g., name, bank account numbers, photos, images, and/or content captured from, belonging to, and/or associated with the second user) for the second user and not personal information for the first user. In some embodiments, the content corresponding to the second user includes personal information for the first user and not personal information for the second user. Displaying different content based on detection of different users allows a computer system to automatically transition between content corresponding to different users without requiring input from a user, thereby performing an operation when a set of conditions has been met without requiring further input.

In some embodiments, the content corresponding to the first user is content corresponding to a first application (e.g., as discussed above at FIGS. 6A-6E). In some embodiments, the content corresponding to the second user is content corresponding to a second application (e.g., as discussed above at FIGS. 6A-6E). In some embodiments, the first application and the second application are different applications. In some embodiments, the first application and the second application are the same application that displays different content corresponding to the respective user. Displaying different content for different user corresponding to different applications allows a computer system to automatically transition between content relevant to a user and allows the computer system to automatically transition between content from different applications based on relevance to the user, thereby performing an operation when a set of conditions has been met without requiring further input.

In some embodiments, while concurrently displaying the first widget (e.g., 604, 618, 620, 626, and/or 632) and the widget (e.g., 604, 618, 620, 626, and/or 632) that includes the content corresponding to the first user (e.g., as discussed above at FIGS. 6A-6C), the computer system detects an input (e.g., a verbal input (e.g., a verbal utterance, a sound, an acoustic request, an acoustic command, and/or an acoustic statement) and/or a non-verbal input (e.g., a swipe input, a hold-and-drag input, a gaze input, an air gesture, and/or a mouse click)) directed to (e.g., directed at, corresponding to, verbal input including an indication of, and/or located at) the widget that includes the content corresponding to the first user (or second user) (e.g., 634 at FIG. 6I). In some embodiments, in response to detecting the input directed to the widget that includes the content corresponding to the first user, the computer system displays a respective user interface (e.g., a menu, a content control, and/or additional content user interface) that corresponds to (of an application that is the source and/or includes) the content corresponding to the first user (e.g., 636 at FIG. 6J) (or second user) (and/or corresponding to an application that is associated with the content corresponding to the first user) (e.g., an application user interface from the application that the content is obtained from). Displaying an application user interface corresponding to a widget upon detection of an input directed to the widget provides a user the ability to interact with the application direction from the widget, thereby providing additional control operations without cluttering the user interface with additional displayed controls.

In some embodiments, the first widget includes content corresponding to a third application (e.g., as discussed above at FIGS. 6A-6C) (e.g., a clock application, calendar application, and/or third-party application). In some embodiments, while (and/or concurrently) displaying the first widget (e.g., 604, 618, 620, 626, and/or 632) (and/or the widget that includes the content corresponding to the first user), the computer system detects an input (e.g., a verbal input (e.g., a verbal utterance, a sound, an acoustic request, an acoustic command, and/or an acoustic statement) and/or a non-verbal input (e.g., a swipe input, a hold-and-drag input, a gaze input, an air gesture, and/or a mouse click)) directed to the first widget (e.g., 634 at FIG. 6I). In some embodiments, in response to detecting the input directed to the first widget, the computer system ceases displaying the content corresponding to the third application. In some embodiments, in response to detecting the input directed to the first widget, the computer system displays content corresponding to a fourth application (e.g., 636 at FIG. 6J) different from the third application. In some embodiments, the first widget includes content from system-based applications (e.g., battery life, time, and/or connectivity). In some embodiments, the first widget includes content from applications (a calendar application, weather application, and/or third-party content applications (e.g., photos, videos, and/or streaming applications)). Displaying content corresponding to a different application upon detecting an input directed to a widget provides a user with additional methods of viewing content corresponding to different applications without selecting the different applications individually, thereby providing additional control options without cluttering the user interface with additional displayed controls.

In some embodiments, the respective user interface (e.g., 602) includes a third widget (e.g., 604, 618, 620, 626, and/or 632) that is different from the widget that includes the content corresponding to the first user (e.g., as discussed above at FIGS. 6A-6C) (e.g., In some embodiments, the third widget is different from the widget that includes the content corresponding to the second user). In some embodiments, the difference between the third widget and the other widgets is the content contained within the respective widget. In some embodiments, the difference between the third widget and the other widget is the characteristics of the widget. In some embodiments, the third widget is displayed alongside the first widget. In some embodiments, any time the first widget is displayed, the third widget is displayed. In some embodiments, the third widget is displayed when the widget that includes content corresponding to a user is displayed. In some embodiments, the third widget includes additional content from the other widgets but is different from the content on the other widgets. Displaying multiple widgets corresponding to different users allows a computer system to automatically display relevant content for multiple users and provides relevant content for the multiple users concurrently, thereby performing an operation when a set of conditions has been met without requiring further input.

In some embodiments, in response to detecting the respective condition (e.g., as discussed above at FIGS. 6A-6E) and in accordance with the determination that detecting the respective condition includes detecting presence of the first user (and/or second user) (e.g., as discussed above at FIGS. 6A-6C), the computer system displays an animation (e.g., as discussed above at FIGS. 6A-6C) that includes: reducing the size of (e.g., shrinking and/or displaying) the first widget (e.g., 604, 618, 620, 626, and/or 632) (e.g., to a third size that is smaller than the first size; and increasing the size of (e.g., enlarging and/or displaying) the widget that includes content corresponding to the first user (e.g., 604, 618, 620, 626, and/or 632) (and/or second user) (e.g., to a fourth size that is larger than the second size (and/or the same as the first size) (and/or larger than the third size)). In some embodiments, the fourth size and first size are equivalent. In some embodiments, the third size and the second size are equivalent. In some embodiments, the sizes are proportional to the size of content contained within the widget. In some embodiments, the second size is between the first size and the third size. In some embodiments, the fourth size is greater than the first size. In some embodiments, the computer system concurrently displaying the first widget at a sixth size (e.g., relative to the respective user interface) (e.g., same and/or different from the third size) and the widget that includes content corresponding to the first user (and/or second user) at a seventh size (e.g., same and/or different from the fourth size) that is smaller than the first size. Displaying an animation changing the size of displayed content based on detection of the presence of a user provides a user with a visual representation of the change of content and allows a computer system to automatically change the prominence of relevant content, thereby performing an operation when a set of conditions has been met without requiring further input and providing feedback for the user.

In some embodiments, while concurrently displaying the first widget (e.g., 604, 618, 620, 626, and/or 632) and the widget that includes content corresponding to the first user (e.g., 604, 618, 620, 626, and/or 632) (and/or second user), the computer system detects the presence of the first user (and/or second user) is no longer detected (e.g., as discussed above at FIGS. 6A-6C). In some embodiments, in response to detecting the presence of the first user (and/or second user) that the presence of the first user is no longer detected, the computer system ceases displaying the widget that includes content corresponding to the first user (and/or second user). Ceasing displaying of widgets corresponding to a user upon no longer detecting the presence of the user allows the computer system to automatically transition between content for the detected user and generalized content, thereby performing an operation when a set of conditions has been met without requiring further input and increasing privacy.

In some embodiments, in response to detecting that the presence of the first user is no longer detected (e.g., as discussed above at FIGS. 6A-6C), the computer system increases the size of the first widget (e.g., 604, 618, 620, 626, and/or 632) (to a predetermined size). In some embodiments, the predetermined size is the available space not taken up by the widget that is no longer displayed. In some embodiments, the predetermined size is proportional to the size of the device. In some embodiments, the predetermined size is the size of the respective user interface. In some embodiments, increasing the size of the first widget includes displaying the first widget at a location that was previously occupied by the widget that includes content corresponding to the first user before the widget that includes content corresponding to the first user ceased to be displayed. Displaying a widget at increased prominence based on ceasing displaying additional widgets allows a computer system to automatically alter the prominence of the additional content corresponding to a user and generalized content, thereby performing an operation when a set of conditions has been met without requiring further input.

In some embodiments, ceasing displaying the widget that includes content corresponding to the first user (e.g., 604, 618, 620, 626, and/or 632) (and/or second user) includes reducing the size of the widget to before the widget that includes content corresponding to the first user ceases to be displayed (e.g., as discussed above at FIGS. 6A-6C). In some embodiments, the widget is reduced in size until not visible and the predetermined value is zero. In some embodiments, the predetermined value is greater than zero and the widget is no longer displayed while it is shrinking. Displaying additional widgets at a reduced size before ceasing to display the widgets provides a user a visual indication that the widgets will no longer be displayed, thereby providing improved visual feedback for the user.

In some embodiments, in response to detecting that the presence of the first user is no longer detected (e.g., as discussed above at FIGS. 6A-6C), the computer system reduces the brightness level of the respective user interface that includes the first widget to from a first brightness level to a second brightness level lower than the first brightness (e.g., as discussed above at FIGS. 6A-6C). In some embodiments, the opacity level is slightly reduced (e.g., dimming the screen level). In some embodiments, the opacity level is reduced a majority amount (e.g., reduced to less than 50%). In some embodiments, the opacity level is reduced to zero. In some embodiments, the computer system sets the predetermined value. In some embodiments, the redetermined value is based on settings. Reducing a brightness level of a user interface upon no longer detecting the presence of the user allows the computer system to automatically transition between actively displayed content and reduced content (e.g., reduced in amount of content and/or reduced in visibility of content), thereby performing an operation when a set of conditions has been met without requiring further input and increasing privacy.

In some embodiments, the content corresponding to the first user (and/or second user) includes (and/or current) health content (e.g., as discussed above at FIGS. 6A-6E). Displaying health content corresponding to a user allows a computer system to automatically transition between relevant health information for different users, thereby performing an operation when a set of conditions has been met without requiring further input.

In some embodiments, the content corresponding to the first user (and/or second user) includes fitness activity content (e.g., as discussed above at FIGS. 6A-6E). Displaying fitness content corresponding to a user allows a computer system to automatically transition between relevant fitness information for different users, thereby performing an operation when a set of conditions has been met without requiring further input.

In some embodiments, the content corresponding to the first user (and/or second user) includes event content (e.g., as discussed above at FIGS. 6A-6E) (e.g., calendar content (e.g., meetings, events, and/or appointments)). Displaying calendar content corresponding to a user allows a computer system to automatically transition between relevant calendar information for different users, thereby performing an operation when a set of conditions has been met without requiring further input.

In some embodiments, the content corresponding to the first user (and/or second user) includes communication content (e.g., as discussed above at FIGS. 6A-6E) (e.g., text messages, voice messages, voice calls, video calls, and/or radio content). Displaying communication content corresponding to a user allows a computer system to automatically transition between relevant communication information for different users, thereby performing an operation when a set of conditions has been met without requiring further input.

Note that details of the processes described above with respect to process 1000 (e.g., FIG. 10) are also applicable in an analogous manner to the methods described below/above. For example, process 1100 optionally includes one or more of the characteristics of the various methods described above with reference to process 1000. For example, the computer system can display a widget containing content at a size based on relevance using the techniques described in relation to process 1000 and display one or more widgets containing content based on presence of one or more users in an environment using the techniques described in relation to process 1100. For brevity, these details are not repeated below.

FIG. 11 is a flow diagram illustrating a method for displaying one or more widgets containing content based on the presence of one or more users in an environment using a computer system in accordance with some embodiments. Process 1100 is performed at a computer system (e.g., 100, 200, and/or 600). Some operations in process 1100 are, optionally, combined, the orders of some operations are, optionally, changed, and some operations are, optionally, omitted.

As described below, process 1100 provides an intuitive way for displaying one or more widgets containing content based on presence of one or more users in an environment. The method reduces the cognitive burden on a user for displaying one or more widgets containing content based on presence of one or more users in an environment, thereby creating a more efficient human-machine interface. For battery operated computing devices, enabling a user to display one or more widgets containing content based on presence of one or more users in an environment faster and more efficiently conserves power and increases the time between battery charges.

In some embodiments, process 1100 is performed at a computer system (e.g., 600) that is in communication with a display component (e.g., left portion of FIGS. 6A-6J) (e.g., a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

While operating with respect to a first context (e.g., as discussed above at FIGS. 6A-6F) (e.g., a context that is based on a particular person being detected, activity being detected, and/or time of day being detected) (and/or while the computer system is operating with respect to the first context), the computer system displays (1102), via the display component, a user interface (e.g., 602) that includes a first widget (e.g., 604, 618, 620, 626, and/or 632) (e.g., a widget that includes health content (e.g., for a user and/or a person that is in the field-of-view of at least one camera in communication with the computer system) (e.g., number of steps, blood pressure, cholesterol, workout times, activity state, and/or number of times a user stood per hour), time content (e.g., a current date/time), weather content, calendar content, and/or fitness content), wherein displaying the user interface while operating with respect to the first context includes: (1104) in accordance with a determination that the first widget (and/or content of the first widget) has a first amount of relevance in relation to (e.g., as described above in relation to process 700-process 1000 and/or has a user detected, location, activity detected, time of day, privacy level, and/or security level associated with and/or corresponding to and/or in relation to) (e.g., with respect to, in consideration of, and/or in relevance to) the first context (e.g., as discussed above at FIGS. 6A-6F), displaying, via the display component, the first widget at a first size (e.g., size of 604, 618, 620, 626, and/or 632 at FIGS. 6E-6H); and in accordance with (1106) a determination that the first widget has a second amount of relevance (e.g., as discussed above at FIGS. 6A-6F), different from the first amount of relevance, in relation to the first context, displaying, via the display component, the first widget at a second size different from the first size (e.g., size of 604, 618, 620, 626, and/or 632 at FIGS. 6E-6H). In some embodiments, the first widget does not have the second amount of relevance when the first widget has the first amount of relevance and/or vice-versa. Displaying content at differing sizes based on the content's relevance to a user allows a computer system to increase the viewability of relevant content by automatically altering the prominence of content based on its relevance, thereby performing an operation when a set of conditions has been met without requiring further input.

In some embodiments, the computer system is in communication with one or more input devices (e.g., as discussed above at FIGS. 6A-6C) (e.g., a camera, a depth sensor, a microphone, a heart monitor, a temperature sensor, and/or a touch-sensitive surface). In some embodiments, the computer system does not operate with respect to the first context in response to detecting, via the one or more input devices, an input (e.g., a tap input and/or a non-tap input (e.g., a verbal input, a swipe input, a hold-and-drag input, a gaze input, an air gesture, and/or a mouse click)) directed to the computer system (e.g., as discussed above at FIGS. 6A-6C) (e.g., an input by a user (e.g., a person, an animal, and/or an object)). In some embodiments, operating with respect to the first context is not based on input. In some embodiments, operating with respect to the first context is not based on input detected via the computer system. In some embodiments, operating with respect to the first context is not based on input directed to the computer system. In some embodiments, operating with respect to the first context is based on detecting, via the one or more input devices, an input (e.g., corresponding to a user) (e.g., detecting distance between the one or more input devices and/or the computer system to a user, detecting whether a user is a known or unknown user (e.g., the computer system operates with respect to the first context in response to detecting a known user and/or the computer system operates with respect to the first context in response to detecting an known user), and/or detecting that a user (e.g., detecting in an environment of the computer system and/or the one or more input devices) belongs to a group of users), a known user, an unknown user, an activity, a device characteristic (e.g., screen size, screen type, battery life, device type, and/or device version), and/or an environment characteristic (e.g., time of day, location within a defined setting (e.g., a user's living room in their house), and/or lighting). Detecting the context of an environment without requiring an input directed to a computer system by a user allows the computer system to alter displayed content without requiring the user to interact with the computer system, thereby performing an operation when a set of conditions has been met without requiring further input.

In some embodiments, before displaying the first widget (e.g., 604, 618, 620, 626, and/or 632) (and/or before displaying the user interface that includes the first widget), the computer system detects that the computer system is operating in the first context after transitioning from operating in a context different from the first context (e.g., as discussed above at FIGS. 6A-6H). In some embodiments, in response to detecting that the computer system is operating with respect to the first context (and/or in response to detecting that the computer system is transitioning from operating with respect to a second context, different from the first context, to operating with respect to the first context), the computer system displays, via the display component, the first widget (e.g., at the first size or the second size). In some embodiments, the computer system is already displaying the first widget and, in response to detecting that the computer system is operating with respect to the first context (and/or in response to detecting that the computer system is transitioning from operating with respect to a second context, different from the first context, to operating with respect to the first context), the computer system refreshes (e.g., updates display of) content included in the first widget. In some embodiments, the computer system detects a change in an environment but remains within the first context and continues displaying the first widget. In some embodiments, the computer system awakes to the first context and displays the first widget. Displaying a widget corresponding to the current context upon detecting the current context allows a computer system to automatically display different widgets based on the widget's relevance to the current context without a user selecting the widget to be displayed, thereby performing an operation when a set of conditions has been met without requiring further input.

In some embodiments, while displaying the first widget (e.g., 604, 618, 620, 626, and/or 632) at the first size (e.g., size of 604, 618, 620, 626, and/or 632 at FIGS. 6E-6H), the computer system detects a change in a current context from the first context to a third context different from the first context (e.g., as discussed above at FIGS. 6A-6H). In some embodiments, in response to detecting the change in the current context to the third context (and/or in accordance with a determination that the first widget has a third amount of relevance in relation to the third context) (and/or while operating with respect to the third context), the computer system displays, via the display component, the first widget at a third size (e.g., size of 604, 618, 620, 626, and/or 632 at FIGS. 6E-6H) (e.g., the second size and/or another size different from the first size and/or the second size) different from the first size. In some embodiments, in response to detecting the change in the current context to the third context and in accordance with a determination that the first widget has a fourth amount of relevance, different from the third amount of relevance, in relation to the third context, the computer system displays, via the display component, the first widget at a fourth size different from the third size. In some embodiments, while displaying the first widget at the second size, the computer system detects the change in a current context from the first context to the third context different from the first context. In some embodiments, in response to detecting the change in the current context to the third context while displaying the first widget at the second size, the computer system displays the first widget at a different size from the first size. Resizing content upon detection of a change in a current context of an environment allows a computer system to automatically transition between content based on the contents relevance to the current context without detecting an input directed to the relevant content by a user, thereby performing an operation when a set of conditions has been met without requiring further input.

In some embodiments, displaying the user interface while operating with respect to the first context (e.g., as discussed above at FIGS. 6A-6H) includes: while displaying the first widget at the first size (e.g., size of 604, 618, 620, 626, and/or 632 at FIGS. 6E-6H): in accordance with a determination that the first widget has the first amount of relevance in relation to the first context and that a second widget, different from the first widget, has a fifth amount of relevance (e.g., as discussed above at FIGS. 6A-6H), different from the first amount of relevance (and/or the second amount of relevance, the third amount of relevance, and/or the fourth amount of relevance), in relation to the first context, displaying, via the display component, the second widget at a fifth size (e.g., size of 604, 618, 620, 626, and/or 632 at FIGS. 6E-6H) different from the first size (and/or the second size, the third size, and/or the fourth size). In some embodiments, the fifth size corresponds to (e.g., is associated with, is based on, is derived from, and/or is related to) an amount of relevance of the second widget in relation to the first context (e.g., the second widget is displayed at a different size in accordance with a determination that the second widget has a different amount of relevance in relation to the first context). In some embodiments, a size of the second widget is proportional to the amount of relevance of the second widget in relation to the first context. In some embodiments, the size of the widget is changed linearly in relation to an amount of relevance of the second widget in relation to the first context. In some embodiments, the size of the widget is inversely related to an amount of relevance of the second widget in relation to the first context. In some embodiments, an amount of relevance of the second widget in relation to the first context is based on the first widget and/or one or more other widgets (e.g., of and/or displayed in the user interface) (e.g., all other widgets of the user interface). In some embodiments, an amount of relevance of the second widget in relation to the first context is defined in relation to one or more (and/or all) other widgets (e.g., of and/or displayed in the user interface). In some embodiments, an amount of relevance of the second widget in relation to the first context is defined based on the first widget and a connection of the second widget to the first context (and/or not based on another widget different from the first widget). In some embodiments, while displaying the first widget at the first size, in accordance with a determination that the first widget has the first amount of relevance in relation to the first context and that a second widget, different from the first widget, has a sixth amount of relevance in relation to the first context, displaying the second widget at the first size (and/or the second size). In some embodiments, the sixth amount of relevance is the same as the first amount of relevance. Displaying different widgets at different sizes based on the widget's relevance allows a computer system to emphasis a widget containing relevant content over a widget containing less relevant content without a user selecting the widget containing relevant content, thereby performing an operation when a set of conditions has been met without requiring further input.

In some embodiments, the computer system is in communication with one or more input devices (e.g., as discussed above at FIGS. 6A-6H) (e.g., a camera, a depth sensor, a microphone, a heart monitor, a temperature sensor, and/or a touch-sensitive surface). In some embodiments, displaying the user interface (e.g., 602) (e.g., while operating with respect to the first context) includes: in accordance with a determination that a first user (e.g., a person, an animal, an object, an identified user, and/or an unidentified user) is detected (e.g., 610, 612, 614, and/or 630), displaying, via the display component: the first widget (e.g., 604, 618, 620, 626, and/or 632) at a sixth size (e.g., size of 604, 618, 620, 626, and/or 632 at FIGS. 6E-6H); and a third widget (e.g., 604, 618, 620, 626, and/or 632) (e.g., a widget that includes health content (e.g., for a user that is in the field-of-view of at least one camera in communication with the computer system) (e.g., numbers of steps, blood pressure, cholesterol, workout times, activity state, and/or number of times a user stood per hour), time content (e.g., a current date/time), weather content, calendar content, and/or fitness content), different from the first widget, at a seventh size (e.g., size of 604, 618, 620, 626, and/or 632 at FIGS. 6E-6H) different from the sixth size; and in accordance with a determination that the first user is not detected via the one or more input devices displaying, via the display component: the first widget at an eighth size (e.g., size of 604, 618, 620, 626, and/or 632 at FIGS. 6E-6H) different from the sixth size (and/or the seventh size); and the third widget at a ninth size (e.g., size of 604, 618, 620, 626, and/or 632 at FIGS. 6E-6H) different from the seventh size (and/or the sixth size and/or the seventh size). In some embodiments, displaying the user interface (e.g., while operating with respect to the first context) includes, in accordance with a determination that a second user, different from the first user, is detected via the one or more input devices, displaying, via the display component: the first widget at a tenth size different from the eighth size and the sixth size (and/or the seventh size and/or the ninth size); and the third widget at a eleventh size different from the seventh size and the ninth size (and/or the sixth size, eighth size, and/or the tenth size). In some embodiments, the first widget at the sixth size, the eighth size, and/or the tenth size includes generalized content to be displayed to any known and/or unknown user. In some embodiments, the third widget at the seventh size, the ninth size, and/or the eleventh size includes generalized content. In some embodiments, the first widget at the sixth size, the eighth size, and/or the tenth size includes personalized content to be displayed to a particular user (e.g., the first user and/or the second user) when detected. In some embodiments, the third widget at the seventh size, the ninth size, and/or the eleventh size includes personalized content to be displayed to a particular user (e.g., the first user and/or the second user) when detected. In some embodiments, the first widget at the sixth size, the eighth size, and/or the tenth size includes personalized content to be displayed to a particular user (e.g., the first user and/or the second user) when detected. In some embodiments, the third widget at the seventh size, the ninth size, and/or the eleventh size includes personalized content to be displayed to a particular user (e.g., the first user and/or the second user) when detected. In some embodiments, the first widget at the sixth size, the eighth size, and/or the tenth size includes system content to be displayed to any user. In some embodiments, the third widget at the seventh size, the ninth size, and/or the eleventh size includes system content to be displayed to any user. In some embodiments, the first widget at the sixth size, the eighth size, and/or the tenth size includes tailored content corresponding, associated, and/or related to the first user and/or the second user. In some embodiments, the third widget at the seventh size, the ninth size, and/or the eleventh size includes tailored content corresponding, associated, and/or related to the first user and/or the second user. In some embodiments, the first widget at the sixth size, the eighth size, and/or the tenth size includes content that is set by the first user and/or the second user to be displayed. In some embodiments, the third widget at the seventh size, the ninth size, and/or the eleventh size includes content that is set by the first user and/or the second user to be displayed. Displaying different widgets at different sizes based on detection of a particular user allows a computer system to automatically resize widgets containing relevant content over widgets containing less relevant content corresponding to the particular user without the particular user selecting a widget, thereby performing an operation when a set of conditions has been met without requiring further input.

In some embodiments, (e.g., while operating with respect to the first context) displaying, via the display component, the user interface (e.g., 602) includes: in accordance with a determination that a current time value (e.g., the current time, a relevant time value, and/or a time indication) is a predetermined time value (e.g., as discussed above at FIGS. 6A-6H) (and/or a predetermined time range) (e.g., a specific time (e.g., 1 am, 5 pm, and/or 3:34 pm) and/or a range of time (e.g., 8 am-noon, noon-3 pm, and/or 3 pm-7:59 am)), displaying, via the display component: the first widget (e.g., 604, 618, 620, 626, and/or 632) at a tenth size (e.g., size of 604, 618, 620, 626, and/or 632 at FIGS. 6E-6H); and a fourth widget (e.g., 604, 618, 620, 626, and/or 632) (e.g., a widget that includes health content (e.g., for a user that is in the field-of-view of at least one camera in communication with the computer system) (e.g., numbers of steps, blood pressure, cholesterol, workout times, activity state, and/or number of times a user stood per hour), time content (e.g., a current date/time), weather content, calendar content, and/or fitness content) (and/or content of the fourth widget), different than the first widget, at an eleventh size (e.g., size of 604, 618, 620, 626, and/or 632 at FIGS. 6E-6H) different than the tenth size; and in accordance with a determination that the current time value is not the predetermined time value (and/or that the current time value is another predetermined time value different from the predetermined time value), displaying, via the display component: the first widget at a twelfth size (e.g., size of 604, 618, 620, 626, and/or 632 at FIGS. 6E-6H) different from the tenth size (and/or the eleventh size); and the fourth widget at a thirteenth (e.g., size of 604, 618, 620, 626, and/or 632 at FIGS. 6E-6H) size different from the eleventh size (and/or the twelfth size). In some embodiments, the predetermined time value is automatically set in relation to the time of day. In some embodiments, a user sets (e.g., the computer system detects input (e.g., corresponding to the user) corresponding to a request to set and, in response, the computer system sets) the predetermined time value according to a schedule (e.g., 8 am-noon, noon-5 pm, and/or 5 pm-7:59 am). In some embodiments, the current time value is obtained via and/or from another computer system (e.g., a connected personal device and/or a remote server) different, separate, and/or in communication with the computer system. In some embodiments, the tenth size, the eleventh size, the twelfth size, and/or the thirteenth size are determined by the computer system automatically. In some embodiments, the tenth size, the eleventh size, the twelfth size, and/or the thirteenth size are set by the computer system to maximize and/or minimize certain content (e.g., relative to other content). In some embodiments, the tenth size and/or the eleventh size are proportional to each other (e.g., the first widget takes space from the fourth widget as the first widget and/or the fourth widget takes space from the first widget). In some embodiments, the twelfth size and/or the thirteenth size are proportional to each other (e.g., the first widget takes space from the fourth widget as the first widget and/or the fourth widget takes space from the first widget). In some embodiments, the first and/or fourth widget swap sizes depending on the time of day. In some embodiments, the tenth size, the eleventh size, the twelfth size, and/or the thirteenth size are each different. Displaying different widgets at different sizes based on a current time value allows a computer system to automatically resize the different widgets corresponding to the different widgets relevance to the current time value without requiring a user select a widget, thereby performing an operation wen a set of conditions has been met without requiring further input.

In some embodiments, displaying the user interface includes: while displaying, via the display component, the first widget (e.g., 604, 618, 620, 626, and/or 632) at a fourteenth size (e.g., size of 604, 618, 620, 626, and/or 632 at FIGS. 6E-6H) (e.g., the first size and/or another size) while the computer system is operating in a respective context (e.g., as discussed above at FIGS. 6A-6F) (e.g., the first context and/or another context): in accordance with a determination that the respective context is a fourth context, displaying, via the display component, a fifth widget (e.g., 604, 618, 620, 626, and/or 632) (e.g., a widget that includes health content (e.g., for a user that is in the field-of-view of at least one camera in communication with the computer system) (e.g., numbers of steps, blood pressure, cholesterol, workout times, activity state, and/or number of times a user stood per hour), time content (e.g., a current date/time), weather content, calendar content, and/or fitness content) (and/or content of the fifth widget), different from the first widget, at a fifteenth size (e.g., size of 604, 618, 620, 626, and/or 632 at FIGS. 6E-6H) (e.g., different from the fourteenth size); and in accordance with a determination that the respective context is a fifth context different from the fourth context (e.g., as discussed above at FIGS. 6A-6F), displaying, via the display component, the fifth widget at a sixteenth size (e.g., size of 604, 618, 620, 626, and/or 632 at FIGS. 6E-6H) different from the fifteenth size. In some embodiments, the fifth widget is the first widget. In some embodiments, the fifth widget is different from the first widget. In some embodiments, the fifth widget is displayed concurrently with the first widget. In some embodiments, in response to detecting the change in the current context from the first context to the fourth context, the computer system displays the first widget at seventeenth. In some embodiments, seventeenth is different from the fifteenth size. In some embodiments, seventeenth is the fifteenth size. In some embodiments, the fifteenth size and/or sixteenth size are proportional to each other. In some embodiments, the fifteenth size, and/or sixteenth size are inversely proportional to each other (e.g., increasing the size of the third size decreases the size of the first size). In some embodiments, the respective amount of relevance in relation to the first context is the same as the first amount of relevance in relation to the first context. In some embodiments, the respective amount of relevance in relation to the first context is based on other characteristics than the first amount of relevance. In some embodiments, displaying the user interface while operating with respect to the first context includes displaying, via the display component, a fifth widget at a fifteenth size different from the first size. Displaying an additional widget at different sizes based on the additional widget's relevance to the current context allows a computer system to automatically resize multiple widgets based on the additional widgets relevance to the current context without a user's selection of a widget within the multiple widgets, thereby performing an operation when a set of conditions has been met without requiring further input.

In some embodiments, while the computer system is operating in the fourth context (e.g., as discussed above at FIGS. 6A-6F), the fifteenth size (e.g., size of 604, 618, 620, 626, and/or 632 at FIGS. 6E-6H) is smaller than (and/or greater than) fourteenth size (e.g., size of 604, 618, 620, 626, and/or 632 at FIGS. 6E-6H) (e.g., the fifth widget is smaller than the first widget in the fourth context). In some embodiments, while the computer system is operating in the fifth context, the sixteenth size is greater than (and/or smaller than) the fourteenth size (e.g., as discussed above at FIGS. 6A-6F) (e.g., the fifth widget is larger than the first widget in the fifth context). In some embodiments, the sixteenth size is greater than the fifteenth size. In some embodiments, the fifteenth size and the sixteenth size are the same. In some embodiments, the fifteenth size and the fourteenth size are proportional (e.g., the space left by the first widget at the fourteenth size is taken up by the fifth widget at the fifteenth size). In some embodiments, the sixteenth size and the fourteenth size are proportional (e.g., the space left by the fifth widget at the sixteenth size is taken up by the first widget at the fourteenth size). Displaying an additional widget at different sizes based on the current context allows a computer system to automatically resize the additional widget to correspond to the additional widget's relevance to the current context and in other contexts without requiring a user to select the different sizes, thereby performing an operation when a set of conditions has been met without requiring further input.

In some embodiments, displaying the user interface includes displaying a sixth widget (e.g., 604, 618, 620, 626, and/or 632) (e.g., a widget that includes health content (e.g., for a user that is in the field-of-view of at least one camera in communication with the computer system) (e.g., numbers of steps, blood pressure, cholesterol, workout times, activity state, and/or number of times a user stood per hour), time content (e.g., a current date/time), weather content, calendar content, and/or fitness content), different from the first widget (e.g., 604, 618, 620, 626, and/or 632), at a seventeenth size (e.g., size of 604, 618, 620, 626, and/or 632 at FIGS. 6E-6H) (and/or different from the first size and/or second size) (e.g., while operating in the first context and/or while operating in the second context). In some embodiments, while displaying, via the display component, the sixth widget at the seventeenth size, the computer system detects a change in current context from the first context to a fifth context different from the first context. In some embodiments, in response to detecting the change in the current context from the first context to the fifth context different from the first context, the computer system continues displaying, via the display component, the sixth widget at the seventeenth size. In some embodiments, while operating with respect to the fifth context, the computer system detects a change in the current context from the fifth context to the first context. In some embodiments, in response to detecting the change in current context from the fifth context to the first context, the computer system continues displaying, via the display component, the sixth widget at the seventeenth size. Displaying a widget at a consistent size irrespective of the current context allows a computer system to continuously display relevant content and controls for the content without making a determination about the current context and provides a user with a consistent viewing experience of relevant content, thereby increasing performance and providing improved visual feedback to the user.

In some embodiments, while operating with respect to the first context and while (and/or after) displaying the first widget (e.g., 604, 618, 620, 626, and/or 632) at the first size (e.g., size of 604, 618, 620, 626, and/or 632 at FIGS. 6E-6H), the computer system detects a change that causes the computer system to operate in a sixth context (and/or a change in current context from the first context to a sixth context) different from the first continuing context (e.g., as discussed above at FIGS. 6A-6H) (e.g., a difference in location, difference in environment characteristics (e.g., noise level, lighting level, and/or positioning), difference in displayed content, difference in device state (e.g., battery level, connectivity, and/or settings), and/or users detected (e.g., known and/or unknown individuals, users detected, and/or number of users and/or users detected)). In some embodiments, in response to detecting the change that causes the computer system to operate in the sixth context (and/or the change in current context from the first context to the sixth context) and in accordance with a determination that the first widget does not have the first amount of relevance in relation to the sixth context, the computer system displays, via the display component, the first widget at an eighteenth size different from the first size (e.g., size of 604, 618, 620, 626, and/or 632 at FIGS. 6E-6H) (and/or the second size) (and/or corresponding to (e.g., associated with, directed to, based on, assigned to, related to, and/or set by) an amount of relevance of the first widget to the sixth context). In some embodiments, in response to detecting the change in context to the sixth context (and/or the change in current context from the first context to the sixth context) and in accordance with a determination that the first widget has the first amount of relevance in relation to the sixth context, maintaining displaying (e.g., continuing to display) the first widget at the first size. Resizing a widget based on the current context not meeting a predefined criteria allows a computer system to automatically resize the widget to correspond to the widgets relevance to the current context that does not meet the predefined criteria without requiring a user to resize the widget, thereby performing an operation when a set of conditions has been met without requiring further input.

In some embodiments, in response to detecting the change in context to the sixth context (e.g., as discussed above at FIGS. 6A-6H) (and/or the change in current context from the first context to the sixth context) and in accordance with a determination that the first widget (e.g., 604, 618, 620, 626, and/or 632) has the first amount of relevance in relation to the sixth context, the computer system maintains displaying (e.g., continue to display) the first widget at the first size (e.g., size of 604, 618, 620, 626, and/or 632 at FIGS. 6E-6H). Forgoing resizing a widget upon detection of a new context that does meet a predefined criteria allows a computer system to continuously display the widget at a size corresponding to the context meeting the criteria and providing a user continued information corresponding to the context meeting the criteria, thereby performing an operation when a set of conditions has been met without requiring further input and providing improved visual feedback to the user.

In some embodiments, displaying the user interface includes displaying an eighth widget (e.g., 604, 618, 620, 626, and/or 632), different from the first widget (e.g., 604, 618, 620, 626, and/or 632), at a nineteenth size (e.g., size of 604, 618, 620, 626, and/or 632 at FIGS. 6E-6H) (and, in some embodiments, different from the eighteenth size) while operating with respect to the first context. In some embodiments, in response to detecting the change in context to the sixth context (e.g., as discussed above at FIGS. 6A-6H) (and/or the change in current context from the first context to the sixth context) and in accordance with a determination that the eighth widget does not have the first amount of relevance (or another amount of relevance) in relation to the sixth context (e.g., as discussed above at FIGS. 6A-6H), the computer system displays, via the display component, the eighth widget at a twentieth size (e.g., size of 604, 618, 620, 626, and/or 632 at FIGS. 6E-6H) different from the nineteenth size. In some embodiments, the nineteenth size and the first size are the same. In some embodiments, the twentieth size and the first size are the same. In some embodiments, the nineteenth size and the second size are the same. In some embodiments, the twentieth size and the second size are the same. In some embodiments, the nineteenth size is proportional to the first size. In some embodiments, the twentieth size is proportional to the first size. In some embodiments, the nineteenth size and/or twentieth size correspond to the relevance of the widget in respect to the sixth context. In some embodiments, in response to detecting the change in context to the sixth context (and/or the change in current context from the first context to the sixth context) and in accordance with a determination that the eighth widget has the first amount of relevance in relation to the sixth context, the computer system maintains displaying, via the display component, the eighth widget at the nineteenth size. Resizing another widget based on the current context not meeting a predefined criteria allows a computer system to automatically resize the widget to correspond to the widgets relevance to the current context that does not meet the predefined criteria without requiring a user to resize the widget, thereby performing an operation when a set of conditions has been met without requiring further input.

In some embodiments, in response to detecting the change in context to the sixth context (e.g., as discussed above at FIGS. 6A-6H) (and/or the change in current context from the first context to the sixth context) and in accordance with a determination that the eighth widget (e.g., 604, 618, 620, 626, and/or 632) does not have the first amount of relevance in relation to the sixth context, the computer system maintains displaying, via the display component, the eighth widget at the nineteenth size (e.g., size of 604, 618, 620, 626, and/or 632 at FIGS. 6E-6H). Forgoing resizing another widget upon detection of a new context that does meet a predefined criteria allows a computer system to continuously display the widget at a size corresponding to the context meeting the criteria and providing a user continued information corresponding to the context meeting the criteria, thereby performing an operation when a set of conditions has been met without requiring further input and providing improved visual feedback to the user.

In some embodiments, while displaying the first widget (e.g., 604, 618, 620, 626, and/or 632) at the first size (e.g., size of 604 at FIG. 6A), the first widget is displayed at a first location (e.g., location of 604 at FIGS. 6D-6F) (and/or a central location and/or a centroid of the widget). In some embodiments, while displaying the first widget at the second size (e.g., size of 604 at FIG. 6B) different from the first size, the first widget is displayed at the first location (and/or the central location). In some embodiments, the first location is automatically set. In some embodiments, the user defines the first location for the first widget to always be located at. In some embodiments, the first location is centrally located between the bounds of the user interface. In some embodiments, one or more widgets (e.g., the first widget and/or at least one widget different from the first widget) are displayed within a grid within the bounds of the user interface, changing size within the grid based on relevance (e.g., to a current context). Displaying a widget at the same location irrespective of size allows a computer system to consistently display predefined content and the controls for the content alongside additional content and provides a user with consistently displayed information about the state of the computer system, thereby providing additional control options without cluttering the user interface with additional displayed controls and providing improved visual feedback to the user.

Note that details of the processes described above with respect to process 1100 (e.g., FIG. 11) are also applicable in an analogous manner to the methods described below/above. For example, process 700 optionally includes one or more of the characteristics of the various methods described above with reference to process 1100. For example, the computer system can display content in a widget based on a user's distance using the techniques described in relation to process 700 and display one or more widgets containing content based on presence of one or more users in an environment using the techniques described in relation to process 1100. For brevity, these details are not repeated below.

FIGS. 12A-12C illustrate exemplary user interfaces for detecting a second computer system and then receiving content from the second computer system in accordance with some embodiments. The user interfaces in these figures are used to illustrate the processes described below, including the processes in FIG. 13.

FIG. 12A illustrates computer system 1200 and computer system 1208. As illustrated in FIG. 12A, computer system 1200 is a tablet and computer system 1208 is a smart phone. While computer system 1200 is depicted as a tablet, it should be recognized that this is merely an example and techniques described herein can work with other types of computer systems, such as a smart phone, a smart watch, a laptop, a personal gaming system, and/or a desktop computer. While computer system 1208 is depicted as a smart phone, it should be recognized that this is merely an example and techniques described herein can work with other types of computer systems, such as a tablet, a smart watch, a fitness tracking device, a laptop, a personal gaming system, and/or a desktop computer.

Computer system 1200 and computer system 1208 can perform media transference. In some embodiments, media transference includes the sending (e.g., transmitting, and/or broadcasting) of media from a second computer system (e.g., the sending computer system, computer system 1208) to a first computer system (e.g., the receiving computer system, computer system 1200) and/or the receiving of the sent media by the first computer system. In some embodiments, in response to receiving the sent media, computer system 1200 displays the media in a same and/or similar manner as it is displayed on computer system 1208. In some embodiments, computer system 1200 performs media transference in response to detecting another device within a captured image (e.g., a photo, a video, and/or a live feed). In some embodiments, computer system 1200 performs media transference in response to a determination that an intention to perform media transference is received (e.g., detected, determined, and/or indicated in a message). In some embodiments, receiving the intention to perform media transference includes determining whether a set of one or more criteria are satisfied, such as whether computer system 1200 is currently operating in a media sharing state, whether one or more programs, such as social media programs, are currently running on computer system 1200, and/or whether one or more settings are activated that cause computer system 1200 to perform media transfer when one or more computer systems are within a certain proximity to computer system 1200.

As illustrated in FIG. 12A, computer system 1200 displays camera application user interface 1202. Camera application user interface 1202 includes camera controls region 1204. Camera controls region 1204 includes shutter control 1206. Computer system 1200 initiates a process for capturing media (e.g., a photo) in response to detecting an input that corresponds to selection of shutter control 1206. Additionally, computer system 1200 displays a representation of a field of view as a live feed of the surrounding area as captured by one or more cameras of computer system 1200. In some embodiments, region 1204 includes one or more additional controls. For example, in FIG. 12A, region 1204 includes a timer control, live setting control, a view switch control, a flash control, an alignment control, an expansion control, and/or a view setting control.

As illustrated in FIG. 12A, computer system 1208 displays photo application user interface 1210. Computer system 1200 displays captured media 1214 (e.g., a photo of a triangle) within photo application user interface 1210.

FIG. 12B illustrates computer system 1200 and computer system 1208. As illustrated in FIG. 12B, computer system 1200 displays camera controls region 1204, shutter control 1206, and a representation of a field of view. Computer system 1208 displays photo application user interface 1210 and captured media 1214. As illustrated in FIG. 12B, computer system 1200 detects a representation of computer system 1208 within a field of view (e.g., of one or more cameras) of computer system 1200. In some embodiments, computer system 1208 notifies computer system 1200 that it is in the field of view of computer system 1200 (e.g., computer system 1208 communicates readiness if media transference is desired).

In some embodiments, computer system 1200 automatically captures an image. For example, as illustrated in FIG. 12B, computer system 1200 can automatically detect another device within the image. In response to detecting another device, computer system 1200 can initiate media transference based on the content of the captured image. In some embodiments, computer system 1200 automatically capturing an image is helpful as it allows computer system 1200 to automatically initiate media transference without any input from a user.

In some embodiments, computer system 1200 captures an image in response to detecting an input. In some embodiments, computer system 1200 receives the request to capture media via an input such as a touch input, a verbal input, an air gesture, and/or a physical touch directed to a hardware button and/or the display. In some embodiments, computer system 1200 can detect a request to capture media in response to receiving a verbal input that doesn't have an explicit indication. For example, user may say “Look how pretty the sunset is” and the device can interpret that statement to include an implicit request to capture media (such as a photo of the sunset). In another example, if computer system 1200 detects an input directed to shutter control 1206, in response, computer system 1200 can capture the image and initiate media transference based on the content of the captured image. In some embodiments, computer system 1200 capturing an image in response to a touch input is helpful as it allows a user to have greater control on when media transference occurs.

In some embodiments, computer system 1200 automatically connects with another device for media transference based on detecting the other device in the image. For example, at FIG. 12B, computer system 1200 detects computer system 1208 within the field of view. In response to detecting computer system 1208 within the field of view, computer system 1200 automatically connects with (e.g., communicates with and/or pairs with) computer system 1208 for media transference. In some embodiments, computer system 1200 can detect more than one other device in the image (e.g., more than one smartphone, smart watch, tablet, laptop, personal gaming system, desktop computer, and/or any combination of the computer systems listed). In some embodiments, in response to detecting more than one other device in the image, computer system 1200 can connect with one, some, and/or all of them. Notably, in the instance where computer system 1200 connects with multiple other devices, computer system 1200 will be connected with the other devices synchronously. In some embodiments, computer system 1200 acts as a hub for content delivery. For example, computer system 1200 can receive content as described herein and, in response, send the content to another device (e.g., as instructed by a user). In such an example, computer system 1200 can receive a request to add something identified in an environment to another device and/or storage. In some embodiments, computer system 1200 does not connect with one and/or some of the detected other devices based on proximity, orientation, and/or state (e.g., an active state or a sleep state).

In some embodiments, computer system 1200 connects with another device based on the orientation of the second device. For example, as illustrated in FIG. 12B, computer system 1200 detects that computer system 1208 has a forward-facing orientation (e.g., an orientation where computer system 1208 faces the display (e.g., the content) towards a user). In response to detecting this orientation, computer system 1200 makes a determination that media transference is desired. In some embodiments, computer system 1200 can connect with another device even if the other device does not have a forward-facing orientation (e.g., the content is not visible in the image) (e.g., the second device can be facing away, facing downwards, facing upwards, and/or facing at an angle). In some embodiments, computer system 1200 does not connect with another device if no other device is detected within the image and/or does not perform media transfer with a computer system if the computer system is in a particular orientation and/or is not in a particular orientation.

In some embodiments, computer system 1200 connects with another computer system for media transference by detecting a verbal request representing the request (e.g., via a user). For example, computer system 1200 detects a verbal request (e.g., “Send this photo” and/or “Transfer this video”) while detecting computer system 1208 within the field of view of computer system 1200. In some embodiments, if computer system 1200 does not detect a verbal input, computer system 1200 will not connect with another computer system for media transference. In some embodiments, a verbal input is helpful because it allows a user to have more freedom when initiating media transference. In some embodiments, in response to detecting a verbal request, computer system 1200 does not connect to another computer system for media transference. For example, computer system 1200 does not connect to another computer system in response to certain implicit verbal inputs that do not correspond to media transference (e.g., “What time is it?”, “What's the weather for today?”, “Hey virtual assistant . . . ”).

In some embodiments, computer system 1200 only connects to another computer system for media transference belonging to the same user account. For example, in response to capturing an image with another computer system in the image, computer system 1200 can determine that the other computer system belongs to the same user account as computer system 1200. In response to making this determination, computer system 1200 can connect with the other computer system for media transference.

At FIG. 12C, in response to receiving a request for media transference, computer system 1208 initiates media transference. As illustrated in FIG. 12C, media transference is completed between computer system 1200 and computer system 1208. In some embodiments, computer system 1200 automatically outputs received content. For example, as illustrated in FIG. 12C, in response to completing media transference, computer system 1200 ceases to display camera application user interface 1202 and displays photo application user interface 1218. Computer system 1200 displays captured media 1220 (e.g., a photo of a triangle) within photo application user interface 1218 (e.g., in the exact manner as photo application user interface 1210 and captured media 1214 as seen on computer system 1208). In some embodiments, computer system 1200 automatically outputting content is helpful as it allows the media transference process to be instantaneous. In some embodiments, computer system 1200 provides content received to a particular application corresponding to the content. For example, computer system 1200 can receive and/or send an image using techniques described herein, resulting in the image being provided to a photo viewing application rather than a messaging application.

In some embodiments, in response to successful media transference, computer system 1200 and/or computer system 1208 can output an indication. In some embodiments, the indication is visual, acoustic, and/or haptic. In some embodiments, in response to sending content, computer system 1208 can output an indication that content has been sent. For example, computer system 1208 can provide a voice output such as, “Your photo has been sent to John's tablet.” In some embodiments, in response to receiving content, computer system 1200 can output an indication that content has been received. For example, computer system 1200 can provide a voice output such as, “Photo received.”

In some embodiments, computer system 1200 outputs an indication that requests a user's permission before accepting transferred media. In some embodiments, in response to receiving the content, computer system 1200 can output an indication requesting permission to accept the content. For example, computer system 1200 can provide a voice output such as, “Photo received from Jane's smartphone. Would you like me to display it?” In some embodiments, an indication that requests permission requires a user's approval or denial (e.g., “Yes” or “No”). In some embodiments, once approval is given, media transference occurs.

In some embodiments, in response to receiving content, computer system 1200 can output content related to the received content. For example, if the content captured in the image is a URL, computer system 1200 can navigate to the URL and display the webpage corresponding to the URL when media transference is successful.

While the above discussion focuses on media transference, one or more scenarios are also images, where computer system 1200 can perform one or more motions in response to detecting a request to capture media, using one or more techniques described above. In some embodiments, a motion is a bow (e.g., a movement comprised of a first downward movement, followed by an upward movement). In some embodiments, a motion is a shake, a vibration, a spin, a nod, and/or a twirl.

In some embodiments, computer system 1200 performs a motion based on the type of requested media. In some embodiments, computer system 1200 performs the same motions when capturing different types of media. For example, computer system 1200 can perform a bow in response to detecting a request to capture a photo, a video, an animation, a gif, a recording, and/or a panoramic photo. In some embodiments, computer system 1200 performs different motions when capturing different types of media to provide a user with an indication of the different types of media. For example, computer system 1200 can perform a bow in response to detecting a request to capture a photo and/or perform a shake in response to detecting a request to capture a video. In some embodiments, a user being provided with the indication of the different types is helpful because the indication informs the user of the type of media that will be, is being, or has been captured. In some embodiments, computer system 1200 performs no motions when capturing different types of media. For example, computer system 1200 can perform a bow in response to detecting a request to capture a photo and/or perform a shake in response to detecting a request to capture a recording.

In some embodiments, computer system 1200 performs a motion relative to when the computer system captures media. In some embodiments, computer system 1200 performs the motion before and/or while capturing media to provide a user with an indication that the media is being and/or will be captured. In some embodiments, a user being provided with the indication that the media is being and/or will be captured is helpful because the indication informs the user that one or more images the user could be potentially interested in are captured in the media. In some embodiments, computer system 1200 performs the motion after capturing media to provide a user with an indication that the media has been captured. In some embodiments, a user being provided with the indication that the media has been captured is helpful because the indication provides feedback that the media has been successfully captured. In some embodiments, the motion can be performed before and after, where the motion is performed one or more times before and then reperformed one or more times after to provide a user with an indication that the media is being, will be, and/or is successfully captured. In some embodiments, a user being provided with the indication that the media is being, will be, and/or is successfully captured is helpful because the indication informs the user that the media is being and/or has been successfully captured.

In some embodiments, computer system 1200 performs a countdown relative to when the computer system detects a request to capture media. In some embodiments, a countdown is performed before computer system 1200 performs the motion to provide a user with an indication that computer system 1200 is about to capture media. In some embodiments, the countdown is comprised of numerically counting down (e.g., typically in the fashion of 10, 9, 8 until 0). In some embodiments, computer system 1200 can output different types of countdowns, such as a count up, an acoustic countdown, a visual countdown (e.g., computer system 1200 displays the countdown on the display), a circular progress indicator, a linear progress indicator, and/or a haptic countdown.

In some embodiments, computer system 1200 performs the same motion when another operation is performed, such as when the computer system “wakes up” (e.g., transitions from a lower power and/or processing mode to a higher power and/or processing mode). In some embodiments, computer system 1200 performs the same motion when computer system 1200 goes from a sleep mode to an active mode (e.g., from a low power mode to a high power mode) (e.g., from a low processing mode to a high processing mode) (e.g., a mode where the display has a low amount of brightness to a mode where the display has a higher amount of brightness) to provide a user with an indication that computer system 1200 is “waking up” (e.g., transition from inactive to active). In some embodiments, computer system 1200 performs the same motion when transitioning between applications, unlocking and/or locking the computer system, and/or when the computer system is “going to sleep.”

In some embodiments, computer system 1200 performs a number of motions in response to detecting the request to capture. In some embodiments, when capturing a photo-type media consisting of a group of people, the computer system can perform the motion once for the whole group as an indication that media is about to be captured. In some embodiments, when capturing a photo-type media consisting of a group of people, the computer system can perform the motion a number of times equal to the number of people in the photo as an indication that media is about to be captured. In some embodiments, the computer system performing the motion a number of times equal to the number of people in the photo is helpful because the indication informs the user (e.g., users) that the computer system has accurately counted and acknowledged the number of people in the photo. In some embodiments, when capturing a photo-type media consisting of a group of people, the computer system can perform the motion a number of times equal to the number of sections in the photo as an indication that media is about to be captured. For example, if a group posing for a photo has three sections (e.g., one on the left, middle and right), the computer system can bow three times. In some embodiments, the computer system performing the motion a number of times equal to the number of sections in the photo is helpful because the indication informs the user (e.g., users) that the computer system has accurately counted and acknowledged the number of sections in the photo. In some embodiments, the computer system performs the motion while facing each of a group of users (or sections) in the environment, such that the computer system performs the motion while facing one user (or section), moves to face another user (or section), performs the motion while facing the other user (or section), etc.

FIG. 13 is a flow diagram illustrating a method for detecting a second computer system in an image and then receiving content from the second computer system using a computer system in accordance with some embodiments. Method 1300 is performed at a computer system (e.g., 100, 200, 1200). Some operations in method 1300 are, optionally, combined, the orders of some operations are, optionally, changed, and some operations are, optionally, omitted.

As described below, method 1300 provides an intuitive way for detecting a second computer system in an image and then receiving content from the second computer system. The method reduces the cognitive burden on a user for detecting a second computer system in an image and then receiving content from the second computer system, thereby creating a more efficient human-machine interface. For battery operated computing devices, enabling a user to detect a second computer system in an image and then receive content from the second computer system faster and more efficiently conserves power and increases the time between battery charges.

In some embodiments, method 1300 is performed at a first computer system (e.g., 1200) that is in communication with a camera. In some embodiments, the first computer system is a watch, a phone, a tablet, a processor, a head-mounted display (HMD) device, and/or a personal computing device. In some embodiments, the computer system is in communication with one or more input devices (e.g., a camera, a depth sensor, and/or a microphone), a movement component (e.g., an actuator, a motor, an electronic arm, a lift, and/or a lever), and/or one or more output devices (e.g., a display component, an audio generation component, a speaker, a haptic output device, a display screen, a projector, and/or a touch-sensitive display).

The first computer system captures (1302), via the camera (e.g., 1200), an image of a physical environment (e.g., as described above with respect FIG. 12B).

In response to (1304) capturing the image of the physical environment, in accordance with a determination that a first set of one or more criteria is satisfied, wherein the first set of one or more criteria includes a criterion that is satisfied when (e.g., while, after, and/or because) a second computer system (e.g., 1208) is detected in the image, the first computer system sends (1306) (e.g., directly and/or indirectly), to the second computer system, a request for content (e.g., and/or one or more instructions including the request for content), wherein the second computer system is different from the first computer system (e.g., as described above with respect to FIGS. 12B-12C). In some embodiments, the second computer system is a watch, a phone, a tablet, a processor, a head-mounted display (HMD) device, and/or a personal computing device. In some embodiments, the first computer system is not in communication with the second computer system when the image is captured.

In response to (1304) capturing the image of the physical environment, in accordance with a determination that a second set of one or more criteria is satisfied, wherein the second set of one or more criteria includes a criterion that is satisfied when the second computer system is not detected in the image, the first computer system forgoes (1308) sending, to the second computer system (and another computer system and/or any other computer system), the request for content, wherein the second set of one or more criteria is different from the first set of one or more criteria (e.g., as described above with respect FIG. 12B). Sending to the second computer system that is different from the first computer system a request for content in accordance with a determination that a first set of one or more criteria is satisfied, wherein the first set of one or more criteria includes a criterion that is satisfied when a second computer system is detected in the image in response to capturing the image of the physical environment allows the first computer system to (1) enhance user engagement and (2) streamline communication from a device simply by satisfying the criterion of detecting the recipient device in the image of the physical environment, thereby reducing the number of inputs needed to perform an operation, providing additional control options without cluttering the user interface with additional displayed controls, and performing an operation when a set of conditions has been met without requiring further user input. Forgoing sending the request for content to the second computer system that is different from the first computer system the request for content in accordance with a determination that a second set of one or more criteria is satisfied, wherein the second set of one or more criteria includes a criterion that is satisfied when a second computer system is not detected in the image in response to capturing the image of the physical environment allows the first computer system to (1) reinforce security and (2) preserve privacy and (3) reduce errors when the criterion is satisfied of not detecting the recipient device in the image of the physical environment, thereby performing an operation when a set of conditions has been met without requiring further user input, and increasing security.

In some embodiments, in response to capturing the image of the physical environment (e.g., as described above with respect to FIG. 12B), in accordance with a determination that the first set of one or more criteria is satisfied, wherein the first set of one or more criteria includes the criterion that is satisfied when the second computer system (e.g., 1208) is detected in the image, the first computer system connects (e.g., pair and perform a handshake with) the first computer system (e.g., 1200) with the second computer system (e.g., as described above with respect to FIGS. 12B-12C). In some embodiments, the first computer system is in communication with the second computer system. In some embodiments, in accordance with a determination that the second set of one or more criteria is satisfied, wherein the second set of one or more criteria includes a criterion that is satisfied when the second computer system is not detected in the image, the first computer system does not connect (pair) with the second computer system. Connecting the first computer system with the second computer system in accordance with a determination that the first set of one or more criteria is satisfied, wherein the first set of one or more criteria includes the criterion that is satisfied when the second computer system is detected in the image allows the first computer system to automatically connect to (communicate with) a device by identifying the second computer system in the image, thereby reducing the number of inputs needed to perform an operation, providing additional control options without cluttering the user interface with additional displayed controls, and performing an operation when a set of conditions has been met without requiring further user input.

In some embodiments, in response to capturing the image of the physical environment (e.g., as described above with respect to FIG. 12B), in accordance with a determination that a third set of one or more criteria is satisfied, wherein the third set of one or more criteria includes a criterion that is satisfied when the second computer system is detected in the image, the first computer system forgoes sending, to the second computer system, the request for content, wherein the third set of one or more criteria is different from the first set of one or more criteria and the second set of one or more criteria (e.g., as described above with respect to FIG. 12B). In some embodiments, the second computer system is an unknown and/or unauthorized (e.g., unauthenticated) computer system. Not sending to the second computer system the request for content in accordance with a determination that a third set of one or more criteria is satisfied including when the second computer system is detected in the image allows the first computer system to reinforce security, preserve privacy, and reduce errors even if the device is detected in the image of the physical environment, thereby performing an operation when a set of conditions has been met without requiring further user input, and increasing security.

In some embodiments, the third set of one or more criteria includes a criterion that is satisfied in accordance with a determination that a request (e.g., verbal, speech, auditory, and/or voice) was not detected in conjunction with capturing the image of the physical environment (e.g., as described above with respect to FIG. 12B). In some embodiments, the third set of one or more criteria does not include a criterion (e.g., request for content) in the first set of one or more criteria. In some embodiments, the request is a verbal request. Not sending to the second computer system the request for content when a request was not detected in conjunction with capturing the image of the physical environment allows the first computer system to preserve privacy and reduce errors by sharing content with a device detected in the image of the physical environment only when a request for content was made, thereby performing an operation when a set of conditions has been met without requiring further user input, and increasing security.

In some embodiments, the third set of one or more criteria includes a criterion that is satisfied when the second computer system is in a first orientation and not in a second orientation, different from the first orientation in the image of the physical environment (e.g., as described above with respect to FIG. 12B). In some embodiments, in accordance with a determination that the second computer system is in the first orientation in the image of the physical environment, forgoing sending, to the second computer system, the request for content. In some embodiments, in accordance with a determination that the second computer system is in the second orientation in the image of the physical environment, sending, to the second computer system, the request for content. In some embodiments, the second computer system being in the second orientation is a criterion that is satisfied in the first set of one or more criteria. Not sending to the second computer system the request for content when the second computer system is in a first orientation and not in a second orientation allows the first computer system to reinforce security and preserve privacy by refraining from sending the request for content to a computer system that is not in a particular orientation, thereby performing an operation when a set of conditions has been met without requiring further user input, and increasing security.

In some embodiments, the first set of one or more criteria includes a criterion that is satisfied when a (e.g., verbal, speech, auditory, and/or voice) request is detected (e.g., as described above with respect to FIGS. 12B-12C). In some embodiments, the request is a required step to pair with the second computer system. In some embodiments, the request is detected via one or more input devices (e.g., microphone, headset, watch, phone, tablet and/or speaker). Sending to the second computer system the request for content when a request is detected allows the first computer system to reinforce security and preserve privacy by requiring a request before content is shared, thereby performing an operation when a set of conditions has been met without requiring further user input and increasing security.

In some embodiments, the first set of one or more criteria includes a criterion that is satisfied when the second computer system (e.g., 1208) is in a third orientation and not in a fourth orientation, different from the third orientation, in the image of the physical environment (e.g., as described above with respect to FIGS. 12B-12C). In some embodiments, in accordance with a determination that the second computer system is in the third orientation (e.g., the display component of the second computer system is facing a user, and/or is in landscape mode, and/or is in portrait mode) in the image of the physical environment, sending, to the second computer system, the request for content. In some embodiments, in accordance with a determination that the second computer system is in the fourth orientation (e.g., the display component of the second computer system is facing away from the user, and/or is in landscape mode, and/or is in portrait mode) in the image of the physical environment, forgoing sending, to the second computer system, the request for content. In some embodiments, the second computer system being in the third orientation is a criterion that is satisfied in the first set of one or more criteria. Sending to the second computer system the request for content when the second computer system is in a third orientation and not in a fourth orientation allows the first computer system to send the request to a correct computer system and/or one that is in a particular location orientation, thereby performing an operation when a set of conditions has been met without requiring further user input, and increasing security.

In some embodiments, after sending to the second computer system (e.g., 1208) the request for content (e.g., as described above with respect to FIGS. 12B-12C), the first computer system receives the content from the second computer system (e.g., 1208) (e.g., as described above with respect to FIGS. 12B-12C). In some embodiments, after sending to the second computer system the request for content, after receiving the content from the second computer system (e.g., 1208) (e.g., as described above with respect to FIG. 12C), the first computer system outputs an indication of the content (e.g., as described above with respect to FIG. 12C). In some embodiments, the indication of the content includes a portion of and/or information concerning the content. In some embodiments, the indication of the content does not include a portion of and/or information concerning the content. In some embodiments, the indication of the content includes a sound and/or voice notification. In some embodiments, the indication of content includes one or more visual cues (e.g., notification banner, pop up dialog, status bar icon, and/or screen wake up). In some embodiments, the indication of the content includes haptic feedback (e.g., vibration, buzzing, and/or shaking). Outputting an indication of the content after receiving the content from the second computer system allows the first computer system to enhance user engagement by explicitly signaling content transfer with an indication of the content, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, after sending to the second computer system (e.g., 1208) the request for content (e.g., as described above with respect to FIGS. 12B-12C), the first computer system receives the content from the second computer system (e.g., 1208) (e.g., as described above with respect to FIG. 12C). In some embodiments, after sending to the second computer system the request for content, after receiving the content from the second computer system, the first computer system outputs the content (e.g., as described above with respect to FIG. 12C). In some embodiments, outputting the content includes providing audio playback (e.g., podcast, music, voice note, and/or voicemail). In some embodiments, outputting the content includes providing multimedia playback (e.g., video streaming, multimedia messages, and/or audio messages). In some embodiments, outputting the content includes providing visual output (e.g., text, images, and/or flowcharts). Outputting the content after receiving the content from the second computer system allows the first computer system to enhance user engagement by automatically outputting the content that was shared on the receiving device, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, after sending to the second computer system (e.g., 1208) the request for content (e.g., as described above with respect to FIGS. 12B-12C), the first computer system receives another content corresponding to the content from the second computer system. In some embodiments, after sending to the second computer system the request for content, after receiving the other content corresponding to the content from the second computer system, the first computer system outputs the other content corresponding to the content (e.g., as described above with respect to FIG. 12C). In some embodiments, the first computer system outputs the content concurrently with the other content. In some embodiments, as a part of outputting the other content, the first computer system outputs a representation of the content. In some embodiments, the content is output in a first manner and the representation of content is output in a second manner different from the first manner (e.g., the content is displayed in a first application (e.g., video streaming application, email application, and/or a media application) and the representation of content is displayed in a second application (e.g., a widget, a minimized and/or amplified display of an application) different from the first application). In some embodiments, the content is output in a first manner and the representation of content is output in the first manner (e.g., the content is output with the same audio-visual characteristics and/or is ran on the same application in the second computer system and in the first computer system). In some embodiments, the content is not visible and/or displayed in the second computer system (e.g., outputting the other content includes transforming the content into a visual content). Outputting the other content corresponding to the content after receiving the other content from the second computer system allows the first computer system to enhance user engagement by also outputting relevant content associated with the shared content, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, the first computer system (e.g., 1200) captures the image of the physical environment without detecting a request to capture the image of the physical environment (e.g., as described in FIG. 12B). In some embodiments, the request to capture the image of the physical environment is not awaited and/or is not expected by the first computer system before capturing the image. In some embodiments, the image of the physical environment is captured automatically by the first computer system. In some embodiments, the first computer system captures one or more images of the physical environment during a period of time. Having the first computer system capture the image of the physical environment without detecting a request to capture the image of the physical environment allows the first computer system to automatically communicate with another computer system without an explicit request for content to trigger a process of device identification, thereby providing additional control options without cluttering the user interface with additional displayed controls, and performing an operation when a set of conditions has been met without requiring further user input.

In some embodiments, before capturing the image of the physical environment, the first computer system detects a request to capture the image of the physical environment, wherein the first computer system (e.g., 1208) captures the image of the physical environment in response to detecting the request to capture the image of the physical environment (e.g., as described above with respect to FIG. 12B). In some embodiments, the request to capture the image of the physical environment is an expected (e.g., required) step by the first computer system to capture the image of the physical environment.

In some embodiments, the content was not visible when (while, before, and/or after) capturing the image of the physical environment and when the determination was made that a criterion in the first set of one or more criteria was satisfied (e.g., as described above with respect to FIGS. 12B-12C). In some embodiments, the content is running in the foreground of an application. In some embodiments, the content is running in the background of an application. In some embodiments, the content is not running in an application. In some embodiments, the display component (e.g., front, user facing side, graphical display) of the second computer system is not visible in the image. Sending to the second computer system the request for content that is not visible in the captured image that detected the second computer system allows the first computer system to streamline data sharing by providing the ability to receive content that is not necessarily in the field of view of the first computer system, thereby providing additional control options without cluttering the user interface with additional displayed controls, and performing an operation when a set of conditions has been met without requiring further user input.

In some embodiments, the content was visible when (while, before, and/or after) capturing the image of the physical environment and when the determination was made that a criterion in the first set of one or more criteria was satisfied (e.g., as described above with respect to FIGS. 12B-12C). In some embodiments, content and/or a portion of the content is displayed in the second computer system and is captured in the image of the physical environment. In some embodiments, the first computer system determines that the visible content and/or portion of the content concerns the request of content. Having the content be visible when capturing the image of the physical environment and when the determination was made that the first set of one or more criteria was satisfied allows the first computer system to streamline data sharing and preserve privacy by providing the ability to receive content that is visible on the sending device, thereby providing additional control options without cluttering the user interface with additional displayed controls, and performing an operation when a set of conditions has been met without requiring further user input.

In some embodiments, after sending to the second computer system (e.g., 1208) the request for content, the first computer system receives the content (e.g., as described above with respect to FIG. 12C). In some embodiments, after sending, to the second computer system, the request for content, while the content is being transferred (e.g., is sent, is being sent, is about to be sent, or is received), the first computer system outputs an indication that the content in being transferred (e.g., as described above with respect to FIGS. 12B-12C). In some embodiments, the indication represents a notification of a progress in the sending of content. In some embodiments, the indication represents a notification of the initiation and/or start of the sending of content. In some embodiments, the indication includes a portion of and/or information concerning the content. In some embodiments, the indication does not include a portion of and/or information concerning the content. In some embodiments, the indication includes a sound and/or voice notification. In some embodiments, the indication of content includes one or more visual cues (e.g., notification banner, pop up dialog, status bar icon, and/or screen wake up). In some embodiments, the indication of the content includes haptic feedback (e.g., vibration, buzzing, and/or shaking). Outputting an indication that the content is being transferred allows the first computer system to enhance user experience by informing a user of the progress of content transfer with an indication, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, after sending to the second computer system (e.g., 1208) the request for content, the first computer system causes the second computer system to output an indication that the content is transferred (e.g., as described above with respect to FIG. 12C) (e.g., is sent, is being sent, or is about to be sent). In some embodiments, the indication represents a notification of a completion of the transfer (sending) of content. In some embodiments, the indication includes a portion of and/or information concerning the content. In some embodiments, the indication does not include a portion of and/or information concerning the content. In some embodiments, the indication includes a sound and/or voice notification. In some embodiments, the indication of content includes one or more visual cues (e.g., notification banner, pop up dialog, status bar icon, and/or screen wake up). In some embodiments, the indication of the content includes haptic feedback (e.g., vibration, buzzing, and/or shaking). Causing the second computer system to output an indication that the content is transferred after sending to the second computer system the request for content allows the first computer system to enhance user experience by informing a user of the completion of content transfer with an indication, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, in response to capturing the image of the physical environment (e.g., as described above with respect to FIG. 12B), in accordance with a determination that the first set of one or more criteria is satisfied, wherein the first set of one or more criteria includes a criterion that is satisfied when a third computer system (e.g., the second computer system, and/or another computer system that is different from the second computer system), is detected in the image of the physical environment, the first computer system sends, to the third computer system, the request for content (e.g., as described above with respect to FIGS. 12A-12C). Sending to the third computer system the request for content when a third computer system is detected in the image of the physical environment allows the first computer system to streamline communication by supporting content transfer from multiple devices, thereby reducing the number of inputs needed to perform an operation, providing additional control options without cluttering the user interface with additional displayed controls, and performing an operation when a set of conditions has been met without requiring further user input.

In some embodiments, in response to capturing the image of the physical environment (e.g., as described above with respect to FIG. 12B), in accordance with a determination that a fourth computer system, different from the first computer system (e.g., 1200) and the second computer system, is detected in the image of the physical environment and that a first set of one or more conditions is satisfied, the first computer system sends, to the fourth computer system, the request for content (e.g., as described above with respect to FIGS. 12B-12C). In some embodiments, in response to capturing the image of the physical environment, in accordance with a determination that a fifth computer system, different from the first computer system (e.g., 1200) and the second computer system (e.g., 1208), is detected in the image of the physical environment and that the first set of one or more conditions is not satisfied, the first computer system forgoes sending, to the fifth computer system, the request for content (e.g., as described above with respect to FIG. 12B). In some embodiments, in accordance with a determination that the second computer system is detected in the image of the physical environment and that the first set of one or more conditions is satisfied, sending, to the second computer system, the request for content. In some embodiments, in accordance with a determination that the second computer system is detected in the image of the physical environment and that the first set of one or more conditions is not satisfied, forgoing sending, to the second computer system, the request for content. In some embodiments, the first set of one or more conditions includes an orientation. In some embodiments, the fourth computer system is in a third orientation (e.g., facing a user) in the image of the physical environment and the fifth computer system is in a fourth orientation (e.g., facing away from the user) in the image of the physical environment. In some embodiments, the fourth computer system is in the third orientation in the image of the physical environment and is displaying transferrable content (e.g., public data) and the fifth computer system is in the third orientation in the image of the physical environment and is displaying non-transferable content (e.g., private user data). In some embodiments, the fourth computer system is associated with an identifiable request (e.g., a name and/or identifier of a user of the fourth computer system) and the fifth computer system is not associated with an identifiable request. Sending to a fourth computer system the request for content in accordance with a determination that the fourth computer system that is different from the first computer system and the second computer system is detected in the image of the physical environment and that a first set of one or more conditions is satisfied and not sending to the fifth computer system the request for content in accordance with a determination that the fifth computer system that is different from the first computer system and the second computer system is detected in the image of the physical environment and that a first set of one or more conditions is not satisfied allows the first computer system to streamline communication from a device while reinforcing security and privacy by selectively transferring content from a device that meets a particular set of conditions, thereby performing an operation when a set of conditions has been met without requiring further user input, and increasing security.

In some embodiments, the request for content is a request for a first type of content. In some embodiments, in accordance with a determination that the fourth computer system is outputting the first type of content, the first computer system sends, to the fourth computer system, the request for content. In some embodiments, in accordance with a determination that the fourth computer system is outputting a second type of content, different from the first type of content, the first computer system forgoes sending, to the fourth computer system, the request for content (e.g., as described above with respect to FIG. 12B). In some embodiments, the first type of content includes content running on a first type of application and not running on a second type of application. In some embodiments, the request for the first type of content is a request for a first set of one or more data that is different from a second set of one or more data. Sending to the fourth computer system the request for content in accordance with a determination that the fourth computer system is outputting the first type of content and forgoing sending to the fourth computer system the request for content in accordance with a determination that the fourth computer system is outputting a second type of content that is different from the first type of content allows the first computer system to streamline communication from a device while maintaining security and privacy by only transferring content that is relevant to a user's request, thereby performing an operation when a set of conditions has been met without requiring further user input, and increasing security.

In some embodiments, the first set of one or more criteria includes a criterion that is satisfied when the first computer system (e.g., 1200) is associated with a user account. In some embodiments, the second computer system (e.g., 1208) is associated with (e.g., belonging to, registered with, denoted by, identified by, subsets a group that includes) the user account. In some embodiments, the first computer system and the second computer system are authorized for accessing the content. Having the first set of one or more criteria include a criterion that is satisfied when the first computer system is associated with a user account allows the first computer system to reinforce security and preserve privacy by selectively allowing transfer of content from a device belonging to (e.g., owned by, identified with, authenticated with) the same user, thereby performing an operation when a set of conditions has been met without requiring further user input, and increasing security.

In some embodiments, the first set of one or more criteria includes a criterion that is satisfied when an input was detected from a user. In some embodiments, the input approves (e.g., grants, allows, triggers) the transfer of the content to the first computer system (e.g., 1200) (e.g., as described above with respect to FIGS. 12B-12C). In some embodiments, the request for content includes the input from the user. In some embodiments, the input is detected while (before or after) the request for content is sent to the second computer system. Having the first set of one or more criteria include a criterion that is satisfied when an input was detected from a user, where the input approves the transfer of content allows the first computer system to reinforce security and preserve privacy by requiring explicit permission from a user to initiate the transfer of content, thereby performing an operation when a set of conditions has been met without requiring further user input, and increasing security.

Note that details of the processes described above with respect to method 1300 (e.g., FIG. 13) are also applicable in an analogous manner to the methods described below/above. For example, process 1400 optionally includes one or more of the characteristics of the various methods described above with reference to method 1300. For example, the detection of the computer system in method 1300 can be from the captured media of method 1400. For brevity, these details are not repeated below.

FIG. 14 is a flow diagram illustrating a method for moving a computer system and then capturing media content using a computer system in accordance with some embodiments. Method 1400 is performed at a computer system (e.g., 100, 200, 1200). Some operations in method 1400 are, optionally, combined, the orders of some operations are, optionally, changed, and some operations are, optionally, omitted.

As described below, method 1400 provides an intuitive way for moving a computer system and then capturing media content. The method reduces the cognitive burden on a user for moving a computer system and then capturing media content, thereby creating a more efficient human-machine interface. For battery operated computing devices, enabling a user to move a computer system and then capture media content faster and more efficiently conserves power and increases the time between battery charges.

In some embodiments, method 1400 is performed at a computer system (e.g., 1200) that is in communication with a camera (e.g., a telephoto camera, a wide-angle camera, and/or an ultra-wide-angle camera) and a movement component (e.g., an actuator, a movable base, a rotatable component, and/or a rotatable base). In some embodiments, the computer system is in communication with a display component (e.g., a display screen, a projector, and/or a touch-sensitive display). In some embodiments, the computer system is in communication with one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device.

The computer system receives (1402) a first request to capture media (e.g., a verbal request to capture media, a pressing of a shutter button and/or controls, and/or an air gesture, such as an air tap and/or air pinch gesture).

In response to (1404) receiving the first request, the computer system performs (1406), via the movement component, a first set of one or more movements that includes moving (e.g., bowing, bending, rotating, and/or tilting), via the movement component, a portion (e.g., a display component, a display, a center of a display, another portion of the display, a hardware button, a camera, and/or a portion (e.g., center portion and/or another portion) of a field-of-view of the camera) of the computer system in a first direction before (e.g., immediately before and without capturing the media between and/or while moving in the first direction and moving in the opposite direction) moving in a direction opposite of the first direction (e.g., performing the first set of one or more movements includes moving the portion of the computer system in the first direction and, after (e.g., immediately after and without capturing the media between and/or while moving in the first direction and moving in the opposite direction) moving in the first direction, moving in the direction opposite of the first direction) (e.g., and, in some embodiments, without moving a shutter of a camera and/or performing the first set of one or more movements does not include moving a camera component, such as a shutter button and/or camera cover between a position that would be considered opened and a position that would be considered closed or vice-versa).

In response to (1404) receiving the first request, the computer system initiates (1408) capture of media after performing the first set of one or more movements (e.g., as described above with respect to FIG. 12B) (and, in some embodiments, capturing the media after performing the first set of one or more movements in response to receiving the first request).

After performing the first set of one or more movements and initiating capture of media, the computer system receives (1410) a second request to capture media.

In response to (1412) receiving the second request to capture media, the computer system performs (1414) (e.g., bows, bends, rotates, and/or tilts) the first set of one or more movements.

In response to (1412) receiving the second request to capture media, the computer system initiates (1416) capture of media after performing the first set of one or more movements (e.g., as described above with respect to FIG. 12B). Performing the first set of one or more movements in response to receiving the second request to capture media allows the computer system to provide feedback concerning the operational state of the computer system (e.g., that the computer system has initiated capture of media) and provides the user with control over the computer regarding the ability to identify whether an input to initiate capture of media was successful, thereby providing improved visual feedback to the user, reducing the number of inputs needed to perform an operation, providing additional control options without cluttering the user interface with additional displayed controls, and increasing security.

In some embodiments, the first set of one or more movements includes a bow. Performing a bow in response to receiving the second request to capture media allows the computer system to provide feedback concerning the operational state of the computer system (e.g., that the computer system has initiated capture of media) and provides the user with control over the computer regarding the ability to identify whether an input to initiate capture of media was successful, thereby providing improved visual feedback to the user, reducing the number of inputs needed to perform an operation, providing additional control options without cluttering the user interface with additional displayed controls, and increasing security.

In some embodiments, the first direction is a downward direction (e.g., toward and/or in the direction of a floor, the ground, and/or a sidewalk). Performing a movement in a downward direction in response to receiving the second request to capture media allows the computer system to provide feedback concerning the operational state of the computer system (e.g., that the computer system has initiated capture of media) and provides the user with control over the computer regarding the ability to identify whether an input to initiate capture of media was successful, thereby providing improved visual feedback to the user, reducing the number of inputs needed to perform an operation, providing additional control options without cluttering the user interface with additional displayed controls, and increasing security.

In some embodiments, the direction opposite of the first direction is an upward direction (e.g., toward and/or in the direction of a ceiling and/or a roof). In some embodiments, the upward direction is different from the downward direction. Performing a movement the direction opposite of the first direction in an upward direction in response to receiving the second request to capture media allows the computer system to provide feedback concerning the operational state of the computer system (e.g., that the computer system has initiated capture of media), provides the user with control over the computer regarding the ability to identify whether an input to initiate capture of media was successful, and allows the computer system to return to an original position to take the photo, thereby providing improved visual feedback to the user, reducing the number of inputs needed to perform an operation, providing additional control options without cluttering the user interface with additional displayed controls, and increasing security.

In some embodiments, the computer system (e.g., 1200) is in communication with one or more output devices. In some embodiments, in response to receiving the first request, the computer system outputs, via the one or more output devices, an indication of time remaining (e.g., a countdown and/or a shot clock) before capture of media is initiated. Outputting, before capture of the media is initiated, an indication of time remaining in response to receiving the second request to capture media allows the computer system to provide feedback concerning the operational state of the computer system (e.g., that the computer system has initiated capture of media), thereby providing improved visual feedback to the user and reducing the number of inputs needed to perform an operation.

In some embodiments, in response to receiving the first request, the computer system performs the first set of one or more movements before initiating capture of media. In some embodiments, the computer system performs the first set of one or more movements after and before initiating capture of media. Performing the first set of one or more movements before initiating capture of media in response to receiving the first request allows the computer system to provide feedback that the computer system will be initiating capture of media, thereby providing improved visual feedback to the user, reducing the number of inputs needed to perform an operation, and increasing security.

In some embodiments, in response to receiving the first request, the computer system performs the first set of one or more movements after capturing the media. Performing the first set of one or more movements before initiating capture of media in response to receiving the first request allows the computer system to provide feedback that the computer system has initiated capture of media, thereby providing improved visual feedback to the user, reducing the number of inputs needed to perform an operation, and increasing security.

In some embodiments, in response to receiving the first request, the computer system performs the first set of one or more movements while capturing the media. Performing the first set of one or more movements before initiating capture of media in response to receiving the first request allows the computer system to provide feedback that the computer system is capturing media, thereby providing improved visual feedback to the user, reducing the number of inputs needed to perform an operation, and increasing security.

In some embodiments, before receiving a request to capture media and while operating in a first state, the computer system detects a request to transition the computer system from operating in the first state to operating in a second state (e.g., via a verbal input (e.g., a verbal input, an audible request, an audible command, and/or an audible statement) and/or a non-verbal input (e.g., a swipe input, a hold-and-drag input, a gaze input, an air gesture, and/or a mouse click)), wherein the computer system (e.g., 1200) uses more resources when operating in the second state (e.g., an awake state, an active state, and/or an alert state) than the computer system uses when operating in the first state (e.g., a sleep state, a hibernate state, a low battery management state, and/or an inactive state). In some embodiments, in response to detecting the request to transition the computer system (e.g., 1200) from operating in the first state to operating in the second state, the computer system performs the first set of one or more movements. Performing the first set of one or more movements in response to detecting the request to transition the computer system from operating in the first state to operating in the second state allows the computer system to provide feedback concerning the operational state of the computer system (e.g., that the computer system is waking up) and provides the user with control over the computer regarding the ability to identify whether an input to wake the computer system and/or transition the computer system between states was successful, thereby providing improved visual feedback to the user, reducing the number of inputs needed to perform an operation, providing additional control options without cluttering the user interface with additional displayed controls, and increasing security.

In some embodiments, after performing the first set of one or more movements and initiating capture of media (e.g., as described in FIG. 12B) (e.g., as described above with respect to FIG. 12B), the computer system receives a third request (e.g., via a verbal input (e.g., a verbal input, an audible request, an audible command, and/or an audible statement) and/or a non-verbal input (e.g., a swipe input, a hold-and-drag input, a gaze input, an air gesture, and/or a mouse click)) to capture media. In some embodiments, in response to receiving the third request to capture media, in accordance with a determination that the third request is a request to capture a first type of media (e.g., photo, video, panoramic photo, animated image capture (e.g., where the computer system takes a series of images (and, in some embodiments, before and after input is detected to capture the media))), the computer system performs the first set of one or more movements. In some embodiments, in response to receiving the third request to capture media, in accordance with a determination that the third request is a request to capture a second type of media (e.g., photo, video, panoramic photo, animated image capture (e.g., where the computer system takes a series of images (and, in some embodiments, before and after input is detected to capture the media))), different from the first type of media, the computer system performs the first set of one or more movements. Performing the first set of one or more movements in response to the request to capture different types of media allows the computer system to perform a consistent action to provide feedback that the computer system is capturing media, thereby providing improved visual feedback to the user, reducing the number of inputs needed to perform an operation, providing additional control options without cluttering the user interface with additional displayed controls, and increasing security.

In some embodiments, after performing the first set of one or more movements and initiating capture of media (e.g., as described in FIG. 12B), the computer system receives a fourth request (e.g., via a verbal input (e.g., a verbal input, an audible request, an audible command, and/or an audible statement) and/or a non-verbal input (e.g., a swipe input, a hold-and-drag input, a gaze input, an air gesture, and/or a mouse click)) to capture media. In some embodiments, in response to receiving the fourth request to capture media, in accordance with a determination that the fourth request is a request to capture a third type of media (e.g., photo, video, panoramic photo, animated image capture (e.g., where the computer system takes a series of images (and, in some embodiments, before and after input is detected to capture the media))), the computer system performs the first set of one or more movements. In some embodiments, in response to receiving the fourth request to capture media, in accordance with a determination that the fourth request is a request to capture a fourth type of media (e.g., photo, video, panoramic photo, animated image capture (e.g., where the computer system takes a series of images (and, in some embodiments, before and after input is detected to capture the media))), different from the third type of media, the computer system performs a second set of one or more movements different from the first set of one or more movements (e.g., without performing the first set of one or more movements and/or without performing any movement included in the first set of one or more movements). In some embodiments, performing the first set of one or more movements does not include moving (e.g., bowing, bending, rotating, tilting), via the movement component, in a first direction before moving in a direction opposite of the first direction. Performing different sets of one or more movements in response to the request to capture different types of media allows the computer system to perform a different action to provide feedback that the computer system is capturing a particular type of media, thereby providing improved visual feedback to the user, reducing the number of inputs needed to perform an operation, providing additional control options without cluttering the user interface with additional displayed controls, and increasing security.

In some embodiments, after performing the first set of one or more movements and initiating capture of media (e.g., as described in FIG. 12B), the computer system receives a fifth request (e.g., via a verbal input (e.g., a verbal input, an audible request, an audible command, and/or an audible statement) and/or a non-verbal input (e.g., a swipe input, a hold-and-drag input, a gaze input, an air gesture, and/or a mouse click)) to capture media. In some embodiments, in response to receiving the fifth request to capture media, in accordance with a determination that the fifth request is a request to capture a fifth type of media (e.g., photo, video, panoramic photo, animated image capture (e.g., where the computer system takes a series of images (and, in some embodiments, before and after input is detected to capture the media))), the computer system performs the first set of one or more movements. In some embodiments, in response to receiving the fifth request to capture media, in accordance with a determination that the fourth request is a request to capture a sixth type of media, different from the fifth type of media, the computer system forgoes performing the first set of one or more movements.

Note that details of the processes described above with respect to method 1400 (e.g., FIG. 14) are also applicable in an analogous manner to the methods described below/above. For example, method 1300 optionally includes one or more of the characteristics of the various methods described above with reference to method 1400. For example, the movement of method 1400 can occur before capturing the image of method 1300. For brevity, these details are not repeated below.

FIGS. 15A-15C illustrate exemplary user interface for adjusting size of displayed content based on a computer system's level of confidence in the content in accordance with some embodiments. The user interfaces in these figures are used to illustrate the processes described below, including the processes in FIG. 16.

FIGS. 15A-15C illustrates computer system 1500 displaying different user interfaces as a smart phone. It should be recognized that computer system 1500 can be other types of computer systems, such as a tablet, a smart watch, a laptop, a communal device, a smart speaker, an accessory, a personal gaming system, a desktop computer, a fitness tracking device, and/or a head-mounted display (HMD) device. In some embodiments, computer system 1500 includes and/or is in communication with one or more sensors (e.g., one or more cameras, more or more LiDAR detectors, one or more motion sensors, one or more infrared sensors, and/or one or more microphones). In some embodiments, computer system 1500 includes and/or is in communication with one or more output devices (e.g., a display screen, a projector, a touch-sensitive display, and/a speaker). In some embodiments, computer system 1500 includes and/or is in communication with one or more movement components (e.g., an actuator, a moveable base, a rotatable component, and/or a rotatable base). In some embodiments, computer system 1500 includes one or more components and/or features described above in relation to computer system 100 and/or electronic device 200.

FIGS. 15A-15C illustrates a scenario where computer system 1500 changes display of an avatar to indicate that computer system 1500 understands input from a user. In some embodiments, understanding input includes computer system 1500 knowing whether it should perform or not perform one or more operations in response to detecting an input and/or a portion of an input. In some embodiments, understanding input includes computer system 1500 knowing what particular operation(s) to perform in response to detecting an input and/or a portion of an input. In some embodiments, computer system 1500 does not understand an input because the input is detected while other inputs are detected and detection of one or more of the inputs concurrently confuses computer system 1500 on which operations should be performed. In some embodiments, computer system 1500 does not understand an input because the input is provided while background noise and/or another type of noise is being output in the environment, such as providing a verbal input at a noisy baseball game. In some embodiments, computer system 1500 does not understand an input because the input itself is confusing, such as the input being muffled, the user not providing an air gesture in a usual manner, etc. In some embodiments, a response user interface object (e.g., response indicator 1506 in FIG. 15B) can be displayed at a larger size to indicate that the computer system 1500 understands the input and at a smaller size to indicate that the computer system does not understand the input. Size is just an example characteristic of the response user interface object that may indicate that the computer system's level of understanding. Other visual or audio cues may be given to the user to signify whether the system understands.

As illustrated in FIG. 15A, computer system 1500 displays user interface 1502, which includes avatar 1504. In some embodiments, avatar 1504 represents a digital and/or system assistant. In some embodiments, computer system 1500 updates avatar 1504 to indicate to a user that computer system 1500 is interacting with one or more users in the environment. For example, computer system 1500 can update avatar 1504, such that avatar 1504 appears to be looking at, looking away from, talking to, nodding at, and/or motioning to one or more users in the environment. In FIG. 15A, avatar 1504 is a face having one or more human characteristics. In some embodiments, avatar 1504 has a different appearance (e.g., different colors (e.g., sets of colors, flesh tones, reds, oranges, yellows, greens, blues, and/or purples), textures (e.g., skin, hair, fur, scales, plastic, glass, feathers, and/or wood), accessories (e.g., hat, glasses, monocle, wand, book, collar, bow, wings, halo, and/or crown), and/or face types (e.g., human, animal, anthropomorphized object, alien, non-descript face, fantasy creature, and/or a collection of objects that resemble a face)). At FIG. 15A, computer system 1500 detects verbal input 1505a (e.g., “I want to plan a vacay.”).

As illustrated in FIG. 15B, in response to detecting verbal input 1505a, computer system 1500 shrinks avatar 1504 and displays response indicator 1506 (e.g., “Vacation?”). Here, computer system 1500 shrinks avatar 1504 because computer system 1500 does not understand verbal input 1505a. At FIG. 15B, the word “vacay” is confusing computer system 1500, and computer system 1500 is attempting to clarify verbal input 1505a by displaying response indicator 1506. At FIG. 15B, computer system 1500 detects verbal input 1505b (e.g., “Yeah, maybe a beach one.”).

As illustrated in FIG. 15C, in response to detecting verbal input 1505b, computer system 1500 enlarges avatar 1504 and enlarges response indicator 1506 to indicate that computer system 1500 understands verbal input 1505b. Additionally, as a part of updating response indicator 1506, computer system 1500 displays first content item 1508 (e.g., “Hawaii”). This user interface object, which may be part of a separate application, can prompt a conversation about a vacation in Hawaii. The computer system 1500 may also display a second content item 1510 (e.g., “Florida.”). This user interface object, which may be part of a separate application, can prompt a conversation about a vacation in Florida.

As illustrated in FIG. 15C, computer system 1500 displays avatar 1504 underneath first content item 1508 and second content item 1510. In some embodiments, computer system 1500 does not increase the size of one or more user interface objects to indicate that computer system 1500 understands received input. However, in other embodiments, computer system 1500 zooms in a displayed user interface to indicate that computer system 1500 understands an input. This system behavior may increase the size of most or all user interface objects that computer system 1500 is currently displaying. In some embodiments, in response to not understanding an input, computer system 1500 can maintain the size of a user interface object (e.g., computer system 1500 will not increase and/or decrease the size of a user interface object).

FIG. 16 is a flow diagram illustrating a method for adjusting size of displayed content based on a computer system's level of confidence in the content using a computer system in accordance with some embodiments. Method 1600 is performed at a computer system (e.g., 100, 200, and/or 1500). Some operations in method 1600 are, optionally, combined, the orders of some operations are, optionally, changed, and some operations are, optionally, omitted.

As described below, method 1600 provides an intuitive way for adjusting size of displayed content based on a computer system's level of confidence in the content. The method reduces the cognitive burden on a user for adjusting size of displayed content based on a computer system's level of confidence in the content, thereby creating a more efficient human-machine interface. For battery operated computing devices, enabling a user to adjust the size of displayed content based on a computer system's level of confidence in the content faster and more efficiently conserves power and increases the time between battery charges.

In some embodiments, method 1600 is performed at a computer system (e.g., 1500) that is in communication with a display component (e.g., a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movement component (e.g., an actuator (e.g., a pneumatic actuator, a hydraulic actuator and/or an electric actuator), a movable base, a rotatable component, and/or a rotatable base).

While displaying, via the display component, a first user interface object (e.g., text, a symbol, a button, a selectable user interface object, an image, a video, media, a chart, a drawing a representation of a face, and/or an avatar), the computer system detects (1602), via the one or more input devices, an input (e.g., one or more words and/or sounds) (e.g., first input) corresponding to subject matter (e.g., first subject matter) (e.g., a topic, theme, content, idea, and/or field) (e.g., as described above with respect to FIGS. 15A-15B).

In response to (1604) detecting the input corresponding to the subject matter, in accordance with a determination that a respective portion (e.g., a subset and/or the entirety) of the input is associated with a level of confidence corresponding to the input (and/or corresponding to the subject matter) that is below a threshold (e.g., 0-100, 0%-100%, and/or 0.01-1 level of confidence) (e.g., 30 on a 0-100 scale, 2 on a 0-5 scale, 40% on a 0%-100% scale, “medium” level of confidence in a scale of “low” to “high”, True in Binary confidence, and/or 0.01-1 level of confidence) (and/or below a first threshold), the computer system forgoes (1606) increasing the size of the first user interface object (e.g., as described above with respect to FIGS. 15A-15B).

In response to (1604) detecting the input corresponding to the subject matter, in accordance with a determination that the respective portion of the input is associated with a level of confidence corresponding to the input (and/or corresponding to the subject matter) that is above the threshold (and/or above a second threshold that is higher than the first threshold), the computer system increases (1608) the size of the first user interface object (e.g., as described above with respect to FIGS. 15B-15C). In some embodiments, the computer system continues to update display of the first user interface object, irrespective of whether the level of confidence corresponds to the input is above/below the threshold (e.g., changing one or more color characteristics (e.g., hue, saturation, tone, and/or brightness), using lighting effects, using visual effects (e.g., Computer Generated Imagery (CGI) and/or practical effects), using animated text, and/or using animations and/or transitions). In some embodiments, the computer system ceases to update the first user interface object in accordance with a determination that the respective portion of the input is associated with the level of confidence corresponding to the input that is below the threshold. In some embodiments, ceasing to update the first user interface object includes a transition and/or animation. In some embodiments, the computer system continues to update the first user interface object in accordance with a determination that the respective portion of the input is associated with the level of confidence corresponding to the input that is below the threshold. In some embodiments, instead of and/or in addition to increasing the size of the first user interface object to communicate that the system understands the input, the computer system can increase the emphasis of the first user interface object by making the first user interface object more visible (e.g., increasing the amount of highlighting (e.g., creating a halo effect), bolding, using drop shadow and/or border, changing the color (e.g., darkening and/or lighting, increasing saturation and/or contrast), using dead space to isolate the object to make it appear more important, and/or decreasing the amount of transparency). In some embodiments, instead of and/or in addition to increasing the size of the first user interface object to communicate that the system understands the input, the computer system can increase the emphasis of the first user interface object by deemphasizing the background of the first user interface object (e.g., blurring, changing the color (e.g., darkening and/or lighting, decreasing saturation and/or contrast), decluttering (e.g., removing other user interface objects in the background), and/or using a contrasting color from the first user interface object). Increasing the size of the first user interface object in accordance with a determination that the respective portion of the input is associated with a level of confidence corresponding to the input that is above the threshold allows the computer system to increase user engagement and improve accessibility by visually signaling that the computer system has detected and/or understands the input, thereby providing improved visual feedback to the user, reducing the number of inputs needed to perform an operation, providing additional control options without cluttering the user interface with additional displayed controls, and performing an operation when a set of conditions has been met without requiring further user input. Not increasing the size of the first user interface object in accordance with a determination that a respective portion of the input is associated with a level of confidence corresponding to the input that is below a threshold allows the computer system to enhance user experience by maintaining the consistency of the first user interface object and ensuring uninterrupted user engagement when feedback concerning the input cannot be readily determined with above a threshold amount of certainty, thereby providing improved visual feedback to the user, reducing the number of inputs needed to perform an operation, and performing an operation when a set of conditions has been met without requiring further user input.

In some embodiments, the input is an audible (e.g., verbal, speech, auditory, and/or voice) input (e.g., 1505a or 1505b). In some embodiments, audible input includes spoken words and/or linguistic details, such as content and logical structure of a verbal communication. In some embodiments, the verbal input is detected via the one or more input devices, such as a microphone. Increasing the size of the first user interface object in accordance with a determination that the respective portion of the audible input is associated with a level of confidence corresponding to the input that is above the threshold allows the computer system to increase user engagement and improve accessibility by visually signaling that the computer system has detected and/or understands the audio input, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, in response to detecting the input corresponding to the subject matter, in accordance with a determination that the respective portion of the input is associated with the level of confidence corresponding to the input that is below the threshold, the computer system decreases the size of the first user interface object (e.g., as described above with respect to FIGS. 15A-15C). In some embodiments, after displaying the first user interface object at a first size; in response to detecting the input corresponding to the subject matter and in accordance with a determination that the respective portion of the input is associated with the level of confidence corresponding to the input that is below the threshold, the computer system displays the first user interface object at a second size smaller than the first size. Decreasing the size of the first user interface object in accordance with a determination that the respective portion of the input is associated with the level of confidence corresponding to the input that is below the threshold allows the computer system to enhance user engagement and optimize its output for clarity by signaling its lack of understanding of the user's input, thereby providing improved visual feedback to the user and performing an operation when a set of conditions has been met without requiring further user input.

In some embodiments, the first user interface object is displayed at a first size. In some embodiments, in response to detecting the input corresponding to the subject matter, in accordance with a determination that the respective portion of the input is associated with the level of confidence corresponding to the input that is below the threshold, the computer system continues displaying the first user interface object (e.g., system avatar, image, video, control (button), text, chart, drawing, object and/or representation of a face, etc.) at the first size (e.g., as described above with respect to FIGS. 15A-15C). In some embodiments, in accordance with a determination that the respective portion of the input is associated with the level of confidence corresponding to the input that is below the threshold, the computer system does not increase the size of the first user interface object and does not decrease the size of the first user interface object. Continuing displaying the first user interface object at the first size in accordance with a determination that the respective portion of the input is associated with the level of confidence corresponding to the input that is below the threshold allows the computer system to enhance user experience by maintaining the consistency of the first user interface object and ensuring uninterrupted user engagement when feedback concerning the input cannot be readily determined with above a threshold amount of certainty, thereby providing improved visual feedback to the user, reducing the number of inputs needed to perform an operation, and performing an operation when a set of conditions has been met without requiring further user input.

In some embodiments, a second user interface object, different from the first user interface object, is displayed at a third size before detecting the input corresponding to the user. In some embodiments, in response to detecting the input corresponding to the subject matter, in accordance with a determination that the respective portion of the input is associated with the level of confidence corresponding to the input that is above the threshold, the computer system increases a size of the second user interface object from a fourth size that is greater than the third size (e.g., as described above with respect to FIGS. 15A-15C). In some embodiments, in accordance with a determination that the respective portion of the input is associated with the level of confidence corresponding to the input that is above the threshold, the computer system displays the second user interface object at the fourth size. In some embodiments, in accordance with a determination that the respective portion of the input is associated with the level of confidence corresponding to the input that is above the threshold, the computer system concurrently increases the size of the first user interface object and the second user interface object. In some embodiments, in accordance with a determination that the respective portion of the input is associated with the level of confidence corresponding to the input that is below the threshold, the computer system does not increase the size of the second user interface object and/or decreases the size of the user interface object. Increasing a size of the second user interface object from a fourth size that is greater than the third size in accordance with a determination that the respective portion of the input is associated with the level of confidence corresponding to the input that is above the threshold allows the computer system to increase user engagement and improve accessibility by visually signaling that the computer system has detected and/or understands the input, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, a third user interface object, different from the first user interface object, is displayed at a fifth size. In some embodiments, in response to detecting the input corresponding to the subject matter, in accordance with a determination that the respective portion of the input is associated with the level of confidence corresponding to the input that is above the threshold, the computer system continues displaying the third user interface object at the fifth size (e.g., as described above with respect to FIGS. 15A-15C). In some embodiments, in accordance with a determination that the respective portion of the input is associated with the level of confidence corresponding to the input that is below the threshold, the computer system continues to display the third user interface object at the fifth size. Continuing displaying the third user interface object at the fifth size in accordance with a determination that the respective portion of the input is associated with the level of confidence corresponding to the input that is above the threshold allows the computer system to provide a stable user experience by preserving consistency of one or more other user interface objects, thereby providing improved visual feedback to the user, and performing an operation when a set of conditions has been met without requiring further user input.

In some embodiments, the input is a first input. In some embodiments, the computer system detects a second input (e.g., one or more words and/or sounds) (e.g., different from the input or the same as the input) corresponding to the subject matter. In some embodiments, in response to detecting the second input corresponding to the subject matter, in accordance with a determination that the respective portion (e.g., a subset and/or the entirety) of the second input is associated with the level of confidence corresponding to the input (and/or corresponding to the subject matter) that is above the threshold (e.g., 0-100, 0%-100%, and/or 0.01-1 level of confidence) (and/or below a first threshold), the computer system forgoes increasing the size of the first user interface object (e.g., as described above with respect to FIGS. 15A-15B). In some embodiments, in response to detecting the second input corresponding to the subject matter, in accordance with a determination that the respective portion (e.g., a subset and/or the entirety) of the second input is associated with the level of confidence corresponding to the input (and/or corresponding to the subject matter) that is below the threshold (e.g., 0-100, 0%-100%, and/or 0.01-1 level of confidence) (and/or below a first threshold), the computer system forgoes increasing the size of the first user interface object (e.g., as described above with respect to FIGS. 15B-15C). Not increasing the size of the first user interface object in accordance with a determination that the respective portion of the second input is associated with the level of confidence corresponding to the input that is above the threshold and forgoing increasing the size of the first user interface object when a determination is made that the respective portion of the second input is associated with the level of confidence corresponding to the input that is below the threshold allows the computer system to ensure a consistent user experience with regards to certain types of inputs regardless as to whether or not the computer system understands an input of one of the certain types of inputs, thereby providing improved visual feedback to the user and performing an operation when a set of conditions has been met without requiring further user input.

In some embodiments, while displaying, via the display component, a fourth interface object (e.g., text, a symbol, a button, a selectable user interface object, an image, a video, media, a chart, a drawing a representation of a face, and/or an avatar) (e.g., concurrently while displayed the first user interface object), the computer system detects, via the one or more input devices, a third input (e.g., one or more words and/or sounds) (e.g., different from the input or the same as the input) corresponding to second subject matter (e.g., a topic, a theme, a content, a idea, and/or a field) (e.g., different from or the same as the subject matter). In some embodiments, in response to detecting the third input corresponding to the second subject matter, in accordance with a determination that the third input corresponds to (e.g., is about, concerns, and/or causes to be displayed) the fourth user interface object and a respective portion of the third input is associated with a level of confidence corresponding to the portion of the third input that is above a second threshold (e.g., the same as the threshold or different from the threshold), the computer system increases the size of the fourth user interface object (e.g., as described above with respect to FIGS. 15A-15C). In some embodiments, in response to detecting the third input corresponding to the second subject matter, in accordance with a determination that the third input does not correspond to the fourth user interface object and the respective portion of the third input is associated with the level of confidence corresponding to the portion of the third input that is above the second threshold, the computer system forgoes increasing the size of the fourth user interface object (e.g., as described above with respect to FIGS. 15A-15C). In some embodiments, in accordance with a determination that the third input corresponds to the fourth user interface object and that the respective portion of the third input is associated with a level of confidence corresponding to the portion of the third input that is below the second threshold, the computer system does not increase the size of the fourth user interface object. In some embodiments, in accordance with a determination that the third input does not correspond to the fourth user interface object and that the respective portion of the third input is associated with the level of confidence corresponding to the portion of the third input that is below the second threshold, the computer system does not increase the size of the fourth user interface object. In some embodiments, in accordance with a determination that the third input does not correspond to the fourth user interface object and the respective portion of the third input is associated with the level of confidence corresponding to the portion of the third input that is above the second threshold, the computer system increases the size of a user interface object (e.g., to which the third input corresponds) different from the fourth user interface object. Increasing or not increasing the size of the fourth user interface object based on whether or not the third input corresponds to the fourth user interface object (e.g., even though the respective portion of the third input is associated with a level of confidence corresponding to the portion of the third input that is above a second threshold) allows the computer system to only increase the size of the user interface object that is pertinent to the detected input when the computer system understands and/or detects the input, thereby providing improved visual feedback to the user, reducing the number of inputs needed to perform an operation, and performing an operation when a set of conditions has been met without requiring further user input.

In some embodiments, the computer system (e.g., 1500) is in communication with a movement component. In some embodiments, in response to detecting the input corresponding to the subject matter, in accordance with a determination that the respective portion of the input is associated with a level of confidence corresponding to the input (and/or corresponding to the subject matter) that is above the threshold (and/or above a second threshold that is higher than the first threshold), the computer system moves, via the movement component (e.g., an actuator (e.g., a pneumatic actuator, a hydraulic actuator and/or an electric actuator), a movable base, a rotatable component, and/or a rotatable base), a portion (e.g., a physical portion, a portion of a display component, a center of a display and/or another portion of a display, and/or a hardware component (e.g., a hardware button and/or a rotatable input mechanism)) of the computer system (e.g., 1500) (e.g., as described above with respect to FIGS. 15A-15C). In some embodiments, in accordance with a determination that a respective portion (e.g., a subset and/or the entirety) of the input is associated with the level of confidence corresponding to the input (and/or corresponding to the subject matter) that is below the threshold (e.g., 0-100, 0%-100%, and/or 0.01-1 level of confidence) (e.g., 30 on a 0-100 scale, 2 on a 0-5 scale, 40% on a 0%-100% scale, “medium” level of confidence in a scale of “low” to “high”, True in Binary confidence, and/or 0.01-1 level of confidence) (and/or below a first threshold), the computer system does not move via the movement component and/or does not move the portion of the computer system via the movement component.

Note that details of the processes described above with respect to method 1600 (e.g., FIG. 16) are also applicable in an analogous manner to the methods described below/above. For example, method 1800 optionally includes one or more of the characteristics of the various methods described above with reference to method 1600. For example, the computer system can a notify a user of a level of confidence in displayed content using the techniques described in relation to method 1600 and also draw attention to incoming content using the techniques described in relation to method 1800. For brevity, these details are not repeated below.

FIGS. 17A-17E illustrate exemplary user interface for moving a part of a computer system in a direction based on a position of output content in accordance with some embodiments. The user interfaces in these figures are used to illustrate the processes described below, including the processes in FIG. 18.

In particular, FIGS. 17A-17E illustrate an exemplary scenario, where computer system 1500 introduces content. In some embodiments, computer system 1500 moves in a direction of the incoming content to provide a cue to a user to bring their attention to the location of the incoming content. In some embodiments, computer system 1500 moving in the direction of new content aids the user in noticing the new content in different situations, such as when a user interface of computer system 1500 is crowded with different user interface objects (e.g., photos, text, and/or applications). In some embodiments, computer system 1500 moving in the direction of incoming content aids the user in gaining a better view of the display of computer system 1500, such as when the user is at a disadvantage in their position relative to the display of computer system 1500 and cannot clearly see what computer system 1500 is displaying. In some embodiments, computer system 1500 moving in the direction of new content (or in another direction away from new content) signifies to the user that new content is being displayed and causes the attention of the user to be drawn to the location that the new content is being introduced.

The left side of FIG. 17A illustrates computer system 1500 displaying user interface 1702. At FIG. 17A, computer system 1500 is displaying content 1706 on the right side of user interface 1702, and at the bottom of user interface 1702, computer system 1500 is displaying user interface object 1708. As illustrated in FIG. 17A, user interface object 1708 is an avatar that resembles a portion of a person (e.g., a face in this example). However, in some embodiments, user interface object 1708 is displayed differently, such as with a different shape, not representing a portion of a person, and/or representing a sound wave. At FIG. 17A, user interface object 1708 also represents a digital and/or smart assistant and gives a user a visual indication that computer system 1500 is interacting with the user.

As illustrated in FIGS. 17A-17E, in response to introducing content, computer system 1500 changes the appearance of (e.g., moves a portion of) user interface object 1708 in a manner such that user interface object 1708 appears to look in the direction of the new incoming content. The right side of FIG. 17A illustrates a top-down view of environment 1704, where computer system 1500 is in environment 1704. The direction of the arrow coming from computer system 1500 represents the direction that a portion of computer system 1500 is facing. In some embodiments, the portion of the computer system is a portion of a display (e.g., a central portion of a display) of computer system 1500 and/or a hardware component, such as a button and/or rotatable input mechanism fixed to computer system 1500. Throughout FIGS. 17A-17E, reference to computer system 1500 facing something, such as a direction and/or a user, should be understood as at least a specific portion of the computer system 1500 facing it. As illustrated in FIG. 17A, computer system 1500 is facing forward. Computer system 1500 facing forward will further be referred to as the original position of computer system 1500.

In some embodiments, computer system 1500 outputs content. For example, as illustrated in FIG. 17A and described above, computer system 1500 outputs content 1706, where content 1706 is visual content that computer system 1500 displays. In some embodiments, computer system 1500 outputs audio content via one or more speakers in addition to or in lieu of outputting content 1706. In some embodiments, the audio content is spatial audio. For example, computer system 1500 can output the audio content, such that the audio content is virtually sourced from a particular location in the environment. In this embodiment, spatial audio content creates a perception that the audio content is being generated from the virtually sourced location.

In some embodiments, computer system 1500 outputs haptic content via one or more haptic output devices in addition to or in lieu of outputting content 1706. In some embodiments, the haptic content can be output and/or introduced at one side of the computer system, such as the right side and/or left side, without being introduced at another side of the computer system. In some embodiments, in response to detecting that audio content and/or haptic content is being introduced closer to a particular side of computer system 1500, computer system 1500 moves, using one or more techniques described herein with respect to moving when visual content is introduced.

In some embodiments, computer system 1500 moves in response to detecting that new content will be and/or is being introduced and/or output. As illustrated in FIG. 17B, in response to introducing content 1710, computer system 1500 rotates clockwise and user interface object 1708 is changed, such that user interface object 1708 appears to be looking in the direction of content 1710. In some embodiments, computer system 1500 can move in different ways. In some embodiments, computer system 1500 can tilt (e.g., 0-270 degrees) if content 1710 is coming from the top or bottom of user interface 1702, can rotate clockwise or counterclockwise (e.g., 0-360 degrees) if content 1710 is coming from the sides of user interface 1702, and/or move right, left, up, down, and/or any combination thereof. In some embodiments, computer system 1500 can rotate and tilt simultaneously if content is coming from a corner of user interface 1702. In some embodiments, the speed at which computer system 1500 moves can depend on the size of content 1710. In some embodiments, if content 1710 is large, computer system 1500 moves further clockwise than it would if content 1710 was small. In some embodiments, the speed at which content 1710 moves and/or is introduced impacts the rate of speed at which computer system 1500 rotates. In some embodiments, if content 1710 moves and/or is introduced at a faster pace, computer system 1500 can move more slowly to accommodate the user in seeing the content more clearly than if computer system 1500 moved at a slower pace. In some embodiments, if content 1710 moves and/or is introduced at a faster pace, computer system 1500 can move faster to indicate to the user that the content is being introduced quicker than if computer system 1500 moved at a slower pace.

In some embodiments, computer system 1500 outputs content with respect to moving differently. In some embodiments, computer system actively changes content 1710 as it appears on user interface 1702 as computer system 1500 rotates clockwise. For example, as computer system 1500 is rotating, content 1710 can appear to fade in when coming in and/or fade out when leaving. In some embodiments, computer system 1500 displays content 1710 fully before rotating clockwise. In some embodiments, computer system 1500 displays content 1710 after rotating. In some embodiments, if computer system 1500 introduces content 1710 on the left, computer system 1500 rotates clockwise, and after computer system 1500 has returned to the original position as illustrated in FIG. 17A, computer system 1500 displays content 1710 on user interface 1702. In some embodiments, computer system 1500 changes content 1710 after rotating to indicate incoming content 1710.

In some embodiments, computer system 1500 changes one or more characteristics of the content as the content is being introduced, such as the color, font, and/or appearance of content 1710 and/or the intensity, duration, pitch, tone, generation location, and/or tempo of audio and/or haptic content. In some embodiments, if content 1710 is blue as it is moving onto user interface 1702, computer system 1500 can change content 1710 to be red after computer system 1500 has returned to the original position. In some embodiments, computer system 1500 changing the color, font, and/or appearance of content can apply to new incoming content or existing content.

As illustrated in FIG. 17C, computer system 1500 has completed a clockwise rotation to indicate new content 1710 and has returned to its original position described in relation to FIG. 17A. While content 1706 is not displayed at FIG. 17C, computer system 1500 can continue to display content 1706 simultaneously with content 1710 in FIG. 17C, in some embodiments. At FIG. 17C, computer system 1500 begins introducing incoming content 1712 on the right side of user interface 1702.

In some embodiments, computer system 1500 moves in a different direction (e.g., as compared to the direction of movement illustrated in FIG. 17B). For example, as illustrated in FIG. 17D, computer system 1500 moves counterclockwise based on the direction of incoming content 1712. Note that FIG. 17B illustrates computer system 1500 moving in a clockwise direction as content 1710 was being introduced from the left of user interface 1702 and FIG. 17D illustrates computer system 1500 moving in a counterclockwise direction as content 1712 is being introduced from the right of user interface 1702. Thus, computer system 1500 moves differently when content is introduced differently (e.g., from different sides and/or locations of a user interface).

At FIG. 17E, computer system 1500 has completed a counterclockwise rotation to indicate new content 1710 and has returned to its original position. FIG. 17E illustrates computer system 1500 displaying content 1712 on the right side of user interface 1702 and user interface object 1708 is displayed, such that user interface object 1708 appears to be looking in a forward direction. While the above discussed computer system 1500 moving when introducing new content, it should be understood that, in some embodiments, computer system 1500 does not move when introducing some types of new content. In some embodiments, computer system 1500 does not move in response to introducing content 1712 if computer system 1500 determines that content 1712 is of a certain category. In some embodiments, computer system 1500 does not move when content is private, content is being introduced from a particular location (e.g., content is being introduced from the middle of the display and/or from an edge rather than a corner of a display), and/or content is a particular type of media. For example, in some embodiments, computer system 1500 does not move when introducing some types of video media and/or gaming media, where the user could have a distorted view of the video content due to two concurrent movements (e.g., the content coming in and the movement of computer system 1500) and/or in situations where motion sickness is more likely to occur.

FIG. 18 is a flow diagram illustrating a method for moving a part of a computer system in a direction based on a position of output content using a computer system in accordance with some embodiments. Method 1800 is performed at a computer system (e.g., 100, 200, and/or 1500). Some operations in method 1800 are, optionally, combined, the orders of some operations are, optionally, changed, and some operations are, optionally, omitted.

As described below, method 1800 provides an intuitive way for moving a part of a computer system in a direction based on a position of output content. The method reduces the cognitive burden on a user for moving a part of a computer system in a direction based on a position of output content, thereby creating a more efficient human-machine interface. For battery operated computing devices, enabling a user to move a part of computer system in a direction based on a position of output content faster and more efficiently conserves power and increases the time between battery charges.

In some embodiments, method 1800 is performed at a computer system (e.g., 1500) that is in communication with a movement component (e.g., an actuator, a motor, an electronic arm, a lift, and/or a lever) and one or more output devices (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

In conjunction with (e.g., while, before, in response to, and/or after) outputting (e.g., displaying, via a display component, the content; issuing, via one or more haptic output devices, haptic content; and/or providing, via one or more speakers, audio output), via the one or more output devices, a first portion of content, the computer system detects (1802) that a second portion of content corresponds to (e.g., will be output at, is initially starting to be output at, and/or is being output at) a respective location (e.g., a spatial audio location, a location at which sound is perceived, and/or a location on the display) (and, in some embodiments, before displaying the second portion of content) (e.g., as described above with respect to FIGS. 17A-17B).

In conjunction with (1804) (e.g., while, before, in response to, and/or after) detecting that the second portion of content corresponds to the respective location, in accordance with a determination that the respective location is a first location, the computer system moves (1806) (e.g., tilts, rotates, moves laterally, moves horizontally, and/or moves vertically, and/or a combination thereof), via the movement component, a portion (e.g., a physical portion, a portion of a display component, a center of a display and/or another portion of a display, and/or a hardware component (e.g., a hardware button and/or a rotatable input mechanism)) of the computer system (e.g., 1500) in a first direction (e.g., left, right, up, down, clockwise, counterclockwise, and/or any combination thereof) (e.g., as described above with respect to FIGS. 17A-17B).

In conjunction with (1804) detecting that the second portion of content corresponds to the respective location, in accordance with a determination that the respective location is a second location different from the first location, the computer system moves (1808), via the movement component, the portion of the computer system (e.g., 1500) in a second direction different from the first direction (e.g., as described above with respect to FIGS. 17C-17D) (e.g., without moving the portion of the computer system in the first direction). Moving in a particular direction based on the second portion of content corresponding to a certain location allows the computer system to intelligently move to provide feedback about where the second portion of content will be or is output, thereby providing improved visual feedback to the user, reducing the number of inputs (e.g., gaze inputs) needed to perform an operation, and performing an operation when a set of conditions has been met without requiring further user input.

In some embodiments, in conjunction with (e.g., while, before, in response to, and/or after) detecting that the second portion of content corresponds to the respective location and in accordance with a determination that the respective location is the first location, the computer system outputs, via the one or more output devices, the second portion of content (e.g., displays, via a display component, one or more user interface objects and/or indications, provides output via a speaker, and/or provides, via one or more haptic output devices, haptic output) (e.g., at the respective location, such as the first location) while (and/or before) moving, via the movement component, the portion of the computer system (e.g., 1500) in the first direction (e.g., without moving in the second direction) (e.g., as described above with respect to FIGS. 17A-17E). In some embodiments, in response to detecting that the second portion of content corresponds to the respective location and in accordance with a determination that the respective location is the first location, the computer system does not output the second portion of content while moving in the second direction. In some embodiments, in conjunction with (e.g., while, before, in response to, and/or after) detecting that the second portion of content corresponds to the respective location and in accordance with a determination that the respective location is the second location, the computer system outputs, via the one or more output devices, the second portion of content (e.g., displays, via a display component, one or more user interface objects and/or indications, provides output via a speaker, and/or provides, via one or more haptic output devices, haptic output) (e.g., at the respective location, such as the second location) while (and/or before) moving, via the movement component, the portion of the computer system (e.g., 1500) in the second direction (e.g., as described above with respect to FIGS. 17A-17E) (e.g., without moving in the first direction). In some embodiments, in response to detecting that the second portion of content corresponds to the respective location and in accordance with a determination that the respective location is the second location, the computer system does not output the second portion of content while moving in the first direction. Outputting the second portion of content at a certain location while moving in a particular direction allows the computer system to intelligently move to provide feedback about where the second portion of content is being output, thereby providing improved visual feedback to the user, reducing the number of inputs (e.g., gaze inputs) needed to perform an operation, and performing an operation when a set of conditions has been met without requiring further user input.

In some embodiments, in conjunction with (e.g., while, before, in response to, and/or after) detecting that the second portion of content corresponds to the respective location and in accordance with a determination that the respective location is the first location, the computer system outputs, via the one or more output devices, the second portion of content (e.g., at the respective location, such as the first location) after moving, via the movement component, the portion of the computer system (e.g., 1500) in the first direction (e.g., displays, via a display component, one or more user interface objects and/or indications, provides output via a speaker, and/or provides, via one or more haptic output devices, haptic output) (and/or in response to not moving and/or not moving in the first direction) (e.g., as described above with respect to FIGS. 17A-17E). In some embodiments, in conjunction with (e.g., while, before, in response to, and/or after) detecting that the second portion of content corresponds to the respective location and in accordance with a determination that the respective location is the second location, the computer system outputs, via the one or more output devices, the second portion of content (e.g., at the respective location, such as the second location and/or another location) after moving, via the movement component, the portion of the computer system (e.g., 1500) in the second direction (e.g., as described above with respect to FIGS. 17A-17E) (e.g., displays, via a display component, one or more user interface objects and/or indications, provides output via a speaker, and/or provides, via one or more haptic output devices, haptic output) (and/or in response to not moving and/or not moving in the second direction). Outputting the second portion of content at a certain location while moving in a particular direction allows the computer system to intelligently move to provide feedback about where the second portion of content has been output, thereby providing improved visual feedback to the user, reducing the number of inputs (e.g., gaze inputs) needed to perform an operation, and performing an operation when a set of conditions has been met without requiring further user input.

In some embodiments, in conjunction with (e.g., while, before, in response to, and/or after) detecting that the second portion of content corresponds to the respective location and in accordance with a determination that the respective location is the first location, the computer system transitions from outputting, via the one or more output devices, the first portion of content to outputting the second portion of content (e.g., at the respective location, such as the first location) while (and/or before) moving, via the movement component, the portion of the computer system (e.g., 1500) in the first direction (e.g., without moving in the second direction) (e.g., as described above with respect to FIGS. 17A-17E). In some embodiments, in conjunction with (e.g., while, before, in response to, and/or after) detecting that the second portion of content corresponds to the respective location and in accordance with a determination that the respective location is the second location, the computer system transitions from outputting, via the one or more output devices, the first portion of content to outputting the second portion of content (e.g., at the respective location, such as the second location) while (and/or before) moving, via the movement component, the portion of the computer system (e.g., 1500) in the second direction (e.g., without moving in the first direction) (e.g., as described above with respect to FIGS. 17A-17E). In some embodiments, transitioning from outputting, via the one or more output devices, the first portion of content to outputting the second portion of content includes fading the first portion of content to display the second portion of content, replacing the first portion of content with the second portion of content (e.g., replacing at the same location), and/or changing the first portion of content to the second portion of content. Transitioning from outputting the first portion of content to outputting the second portion of content while moving the computer system in a particular direction allows the computer system to change the display of content while moving, which allows the computer system to intelligently provide feedback concerning the location of content that is being changed, thereby providing improved visual feedback to the user, reducing the number of inputs (e.g., gaze inputs) needed to perform an operation, and performing an operation when a set of conditions has been met without requiring further user input.

In some embodiments, in conjunction with (e.g., while, before, in response to, and/or after) detecting that the second portion of content corresponds to the respective location and in accordance with a determination that the respective location is the first location, the computer system transitions from outputting, via the one or more output devices, the first portion of content to outputting the second portion of content (e.g., at the respective location, such as the first location) after moving, via the movement component, the portion of the computer system (e.g., 1500) in the first direction (e.g., without moving in the second direction) (and/or in response to not moving and/or not moving in the first direction) (e.g., as described above with respect to FIGS. 17A-17E). In some embodiments, in conjunction with (e.g., while, before, in response to, and/or after) detecting that the second portion of content corresponds to the respective location and in accordance with a determination that the respective location is the second location, the computer system transitions from outputting, via the one or more output devices, the first portion of content to outputting the second portion of content (e.g., at the respective location, such as the second location) after moving, via the movement component, the portion of the computer system (e.g., 1500) in the second direction (e.g., as described above with respect to FIGS. 17A-17E) (e.g., without moving in the first direction) (and/or in response to not moving and/or not moving in the second direction). In some embodiments, transitioning from outputting, via the one or more output devices, the first portion of content to outputting the second portion of content includes fading the first portion of content to display the second portion of content, replacing the first portion of content with the second portion of content (e.g., replacing at the same location), and/or changing the first portion of content to the second portion of content. Transitioning from outputting the first portion of content to outputting the second portion of content after moving the computer system in a particular direction allows the computer system to change the display of content while moving, which allows the computer system to intelligently provide feedback concerning the location of content that has been changed, thereby providing improved visual feedback to the user, reducing the number of inputs (e.g., gaze inputs) needed to perform an operation, and performing an operation when a set of conditions has been met without requiring further user input.

In some embodiments, before detecting that the second portion of content corresponds to the respective location (and/or before the second portion of content is output), the computer system (e.g., 1500) is at a first position. In some embodiments, the portion of the computer system (e.g., 1500) moves from the first position to a second position corresponding to (e.g., where the portion of the computer system is directed at, pointing at, and/or in front of) the first location when the computer system moves in the first direction (e.g., as described above with respect to FIGS. 17A-17E). In some embodiments, the portion of the computer system (e.g., 1500) moves from the second position to a third position corresponding to the second location when the computer system moves in the second direction (e.g., as described above with respect to FIGS. 17A-17E). In some embodiments, the first location is located on a first side of a user interface that is closer to the first direction than the second direction. In some embodiments, the second location is located on a second side of the user interface that is closer to the second direction than the first direction. Moving in direction of the second portion of content in conjunction with detecting that the second portion of content corresponding to a particular location allows the computer system to intelligently move to provide feedback about where the second portion of content will be or is output, thereby providing improved visual feedback to the user, reducing the number of inputs (e.g., gaze inputs) needed to perform an operation, and performing an operation when a set of conditions has been met without requiring further user input.

In some embodiments, in conjunction with (e.g., while, before, in response to, and/or after) detecting that the second portion of content corresponds to the respective location and in accordance with a determination that the respective location is the first location, the computer system outputs, via the one or more output devices, the first portion of content moving in a third direction (e.g., across and/or on top of a user interface including the first portion of content) while moving, via the movement component, the portion of the computer system (e.g., 1500) in the first direction (e.g., as described above with respect to FIGS. 17A-17E). In some embodiments, the first direction is different from (e.g., opposite of and/or includes at least one direction component (e.g., x, y, and/or z component) that is in a different direction and/or the same as) the third direction. In some embodiments, in conjunction with (e.g., while, before, in response to, and/or after) detecting that the second portion of content corresponds to the respective location and in accordance with a determination that the respective location is the second location, the computer system outputs, via the one or more output devices, the first portion of content moving in the fourth direction (e.g., across and/or on top of the user interface including the first portion of content) while moving, via the movement component, the portion of the computer system (e.g., 1500) in the second direction (e.g., as described above with respect to FIGS. 17A-17E). In some embodiments, the fourth direction is different from (e.g., opposite of and/or includes at least one direction component (e.g., x, y, and/or z component) that is in a different direction and/or the same as) the second direction. In some embodiments, the third direction is different from the fourth direction. Moving the portion of the computer system along with moving the first portion of content allows the computer system to intelligently move to provide feedback about where the second portion of content will be or is output and further allows the computer system to provide a smoother transition to consume the second content by moving the portion of the computer system according to the movement of the portion of the content, thereby providing improved visual feedback to the user, reducing the number of inputs (e.g., gaze inputs) needed to perform an operation, and performing an operation when a set of conditions has been met without requiring further user input.

In some embodiments, outputting, via the one or more output devices, the first portion of content (and/or the second portion of content) includes displaying a visual representation of content (e.g., as described above with respect to FIGS. 17A-17E) (e.g., a user interface object, an icon, text, a symbol, an image, a video, and/or a series of images). Displaying a visual representation of content at a certain location while moving in a particular direction allows the computer system to intelligently move to provide feedback about where the second portion of content is being displayed, thereby providing improved visual feedback to the user, reducing the number of inputs (e.g., gaze inputs) needed to perform an operation, and performing an operation when a set of conditions has been met without requiring further user input.

In some embodiments, the respective location is a first respective location. In some embodiments, in conjunction with (e.g., while, before, in response to, and/or after) detecting that the second portion of content corresponds to the respective location, the computer system outputs, via the one or more output devices, the second portion of content. In some embodiments, in conjunction with outputting, via the one or more output devices, the second portion of content and after moving, via the movement component, the portion of the computer system (e.g., 1500) in the first direction, the computer system detects that a third portion of content, different from the first portion of content and the second portion of content, corresponds to a second respective location different from the first respective location (e.g., as described above with respect to FIGS. 17A-17E) (and, in some embodiments, before outputting the third portion of content). In some embodiments, in in conjunction with (e.g., while, before, in response to, and/or after) detecting that the second respective location corresponds to a fourth location, different from the first location, the computer system moves, via the movement component, the portion of the computer system (e.g., 1500) in a fifth direction, different from the first direction (e.g., as described above with respect to FIGS. 17A-17E). In some embodiments, the fifth direction is different from the second direction. In some embodiments, the fifth direction is the same as the second direction. In some embodiments, the fourth location is different from the second location. In some embodiments, the fourth location is the same as the second location. In some embodiments, in response to (and/or after) detecting that the second respective location corresponds to the fourth location and after and/or while moving the fifth direction, the computer system outputs (e.g., displays and/or provides audio and/or haptic output corresponding to the third portion of content) the third portion of content.

In some embodiments, the respective location is a third respective location. In some embodiments, in conjunction with (e.g., while, before, in response to, and/or after) detecting that the second portion of content corresponds to the third respective location, the computer system outputs, via the one or more output devices, the second portion of content. In some embodiments, in conjunction with outputting, via the one or more output devices, the second portion of content and after moving, via the movement component, the portion of the computer system (e.g., 1500) in the first direction, the computer system detects that a fourth portion of content, different from the first portion of content and the second portion of content, corresponds to a fourth respective location different from the third respective location (and, in some embodiments, before outputting the fourth portion of content) (e.g., as described above with respect to FIGS. 17A-17E). In some embodiments, in conjunction with (e.g., while, before, in response to, and/or after) detecting that the fourth respective location corresponds to the fourth respective location, different from the first location, the computer system forgoes moving, via the movement component, the portion of the computer system (e.g., as described above with respect to FIGS. 17A-17E) (e.g., 1500) (e.g., in a sixth direction, different from the first direction) (e.g., because the fourth portion of content is a certain type of content). In some embodiments, the sixth direction is different from the second direction. In some embodiments, the sixth direction is the same as the second direction. In some embodiments, the fifth location is different from the second location. In some embodiments, the fifth location is the same as the second location. In some embodiments, in response to detecting that the fourth respective location corresponds to the fifth location and after and/or while moving the portion of the computer system in the sixth direction, the computer system outputs (e.g., displays and/or provides audio and/or haptic output corresponding to the fourth portion of content) the fourth portion of content. Not moving in conjunction with detecting that the fourth respective location corresponds to the fourth respective location allows the computer system to not move in certain situations when content is introduced, such as for particular types of content, which allows the computer system to be stable when introducing certain content (e.g., versus moving with other particular types of content), thereby providing improved visual feedback to the user, reducing the number of inputs (e.g., gaze inputs) needed to perform an operation, and performing an operation when a set of conditions has been met without requiring further user input.

Note that details of the processes described above with respect to method 1800 (e.g., FIG. 18) are also applicable in an analogous manner to the methods described below/above. For example, method 1600 optionally includes one or more of the characteristics of the various methods described above with reference to method 1800. For example, the computer system can a notify a user of a level of confidence in displayed content using the techniques described in relation to method 1600 and also draw attention to incoming content using the techniques described in relation to method 1800. For brevity, these details are not repeated below.

The description above has been described with reference to specific examples for the purpose of explanation. Such specific examples can be in the form of textual description above and/or in the accompanying drawings. However, such examples should not be interpreted as being exhaustive or limiting to the disclosure (e.g., limiting to the explicit manners described herein). Many modifications and variations are possible in view of the above teachings by one of ordinary skill in the art without departing from the scope of the present disclosure.

Aspects of the technology described above can include gathering and/or using data from various sources. Such data can include demographic data, telephone numbers, email addresses, location and/or location-related data, home addresses, work addresses, and/or any other identifying information. In some scenarios, such data can include personal information that is usable to uniquely identify a specific person. Such data can be used to improve interactions that a device has with its environment (e.g., interactions with users). The use of such data can require one or more entities handling such data. These entities can be involved in collecting, processing, disclosing, transferring, storing, or other functions that support the technologies described herein. The present disclosure expects that (e.g., does not preclude) that all use of such data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such data, and such collection and/or use should only be for legitimate and reasonable uses. Further, such data should not be shared, disclosed, sold, and/or provided for uses other than legitimate and/or reasonable uses. Various scenarios can arise in which such data is not available, such as when a user selects not to share such data. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of such data can benefit a user by improving the operation of the device, the present disclosure contemplates that embodiments of the present technology can be used without such data. For example, operations of the device can use other data (e.g., instead of and/or in place of such data). Other techniques include making inferences based on other data or a minimal amount of such data. The use of such data can be utilized for the benefit of users of the device. For example, such data can be used to improve interactions that the device engages in with the user. Other benefits from the use for such data are also possible and within the scope of the present disclosure.

What is claimed is:

1. A method, comprising:
at a computer system that is in communication with one or more input devices, and a display component:
detecting, via the one or more input devices, a first user in a physical environment; and
while detecting the first user in the physical environment:
in accordance with a determination that a first set of one or more criteria is satisfied, wherein the first set of one or more criteria includes a criterion that is satisfied when a second user is not detected in a first area of the physical environment, displaying, via the display component, first content; and
in accordance with a determination that a second set of one or more criteria is satisfied, wherein the second set of one or more criteria includes a criterion that is satisfied when the second user is detected in the first area of the physical environment, displaying, via the display component, second content different from the first content.

2. The method of claim 1, wherein the second user is an unidentified user.

3. The method of claim 1, wherein:
while detecting the first user in the physical environment:
in accordance with a determination that a third set of one or more criteria is satisfied, wherein the third set of one or more criteria includes a criterion that is satisfied when a third user, different from the first user and the second user, is detected in the first area of the physical environment, displaying, via the display component, third content different from the first content and the second content.

4. The method of claim 1, wherein:
while detecting the first user in the physical environment:
in accordance with the determination that the first set of one or more criteria is satisfied, wherein the first set of one or more criteria includes a criterion that is satisfied when the first user is detected to belong to a first group, the first content is fifth content; and
in accordance with the determination that the first set of one or more criteria is satisfied, wherein the first set of one or more criteria includes a criterion that is satisfied when the first user is detected to not belong to the first group, that the first content does not include the fifth content.

5. The method of claim 1, wherein:
while detecting the first user in the physical environment:
in accordance with a determination that a fourth set of one or more criteria is satisfied, wherein the fourth set of one or more criteria includes a criterion that is satisfied when a fourth user is not detected in a first area of the physical environment and a criterion that is satisfied when the first user is detected in a second area of the physical environment, displaying, via the display component, sixth content; and
in accordance with a determination that a fifth set of one or more criteria is satisfied, wherein the fifth set of one or more criteria includes a criterion that is satisfied when the fourth user is detected in the first area of the physical environment and a criterion that is satisfied when the first user is detected in the second area of the physical environment, displaying, via the display component, seventh content different from the sixth content.

6. The method of claim 1, wherein the first content includes a first widget.

7. The method of claim 6, wherein the second content includes a second widget.

8. The method of claim 7, wherein the second widget is the same as the first widget.

9. The method of claim 7, wherein the second widget is a different type of widget than the first widget.

10. The method of claim 1, wherein the second content includes a third widget.

11. The method of claim 1, wherein the first content includes content that corresponds to the first user.

12. The method of claim 1, wherein the second content includes content that does not correspond to the first user.

13. The method of claim 1, wherein the first content includes eighth content, and wherein the second content includes the eighth content.

14. A non-transitory computer-readable storage medium storing one or more programs configured to be executed by one or more processors of a computer system that is in communication with one or more input devices, and a display component, the one or more programs including instructions for:
detecting, via the one or more input devices, a first user in a physical environment; and
while detecting the first user in the physical environment:
in accordance with a determination that a first set of one or more criteria is satisfied, wherein the first set of one or more criteria includes a criterion that is satisfied when a second user is not detected in a first area of the physical environment, displaying, via the display component, first content; and
in accordance with a determination that a second set of one or more criteria is satisfied, wherein the second set of one or more criteria includes a criterion that is satisfied when the second user is detected in the first area of the physical environment, displaying, via the display component, second content different from the first content.

15. A computer system that is in communication with one or more input devices, and a display component, comprising:
one or more processors; and
memory storing one or more programs configured to be executed by the one or more processors, the one or more programs including instructions for:
detecting, via the one or more input devices, a first user in a physical environment; and
while detecting the first user in the physical environment:
in accordance with a determination that a first set of one or more criteria is satisfied, wherein the first set of one or more criteria includes a criterion that is satisfied when a second user is not detected in a first area of the physical environment, displaying, via the display component, first content; and
in accordance with a determination that a second set of one or more criteria is satisfied, wherein the second set of one or more criteria includes a criterion that is satisfied when the second user is detected in the first area of the physical environment, displaying, via the display component, second content different from the first content.
